(19) United States
(12) Patent Application Publication
(10) Pub. No.: US 2005/0014910 A1
(43) Pub. Date: Jan. 20, 2005

(54) Toughened vinyl ester resins

(76) Inventors: Carole A. Lepilleur, Akron, OH (US); David R. Egan, Stow, OH (US); Carl D. Weber, Copley, OH (US)

Correspondence Address: NOVEON IP HOLDINGS CORP., 9911 BRECKSVILLE ROAD, CLEVELAND, OH, 44141-3247, US

(21) Appl. No.: 10/782,363

(22) Filed: Feb. 19, 2004

Related U.S. Application Data
(63) Continuation-in-part of application No. 10/219,403, filed on Aug. 15, 2002.
Application No. 10/219,403 is a continuation-in-part of application No. 09/505,749, filed on Feb. 16, 2000, now Pat. No. 6,596,899.
(63) Continuation-in-part of application No. 10/681,679, filed on Oct. 8, 2003.
Application No. 10/681,679 is a continuation-in-part of application No. 10/278,335, filed on Oct. 23, 2002.
Application No. 10/278,335 is a continuation-in-part of application No. 09/505,749, filed on Feb. 16, 2000, now Pat. No. 6,596,899.

(51) Int. Cl. C08K 5/41

(52) U.S. Cl. 525/524

(57) ABSTRACT

A vinyl ester resin is derived from the reaction of an unsaturated acid with an epoxy terminated polymer made from a dithio or a trithio initiator, and optionally from an epoxy resin. The vinyl ester resin can be blended with a miscible toughener and a diluent to provide a time stable system and subsequently crosslink to provide a composition with improved toughening properties.

### CROSS REFERENCE

This patent application is a continuation-in-part application based on U.S. application Ser. No. 10/219,403 filed Aug. 15, 2002 for S,S′-BIS-(α,α′-Disubstituted-α″-Acetic Acid)-Trithiocarbonates and Polymers Thereof For Toughening Thermosetting Resins, which is a continuation-in-part application based on U.S. application Ser. No. 09/505,749 filed Feb. 16, 2000 for S,S′-Bis-(α,α′-Disubstituted-α″-Acetic Acid)-Trithiocarbonates And Derivatives As Initiator—Chain Transfer Agent—Terminator For Controlled Radical Polymerizations And The Process For Making The Same. This application is also a continuation-in-part application based on U.S. application Ser. No. 10/681,679 filed Oct. 8, 2003, for S-(α,α′-Disubstituted-α″-Acetic Acid) Substituted Dithiocarbonate Derivatives for Controlled Radical Polymerizations, Process and Polymers Made Therefrom, which is a continuation-in-part application based on U.S. application Ser. No. 10/278,335, filed Oct. 23, 2002 for S-(α,α′-Disubstituted-α″-Acetic Acid) Substituted Dithiocarbonate Derivatives for Controlled Radical Polymerizations, Process and Polymers Made Therefrom which is in turn is a continuation-in-part based on U.S. application Ser. No. 09/505,749 filed Feb. 16, 2000, now U.S. Pat. No. 6,596,899 issued Jul. 22, 2003, for S,S′-Bis-(α,α′-Disubstituted-α″-Acetic Acid)-Trithiocarbonates And Derivatives As Initiator—Chain Transfer Agent—Terminator For Controlled Radical Polymerizations And The Process For Making The Same.

### FIELD OF THE INVENTION

The present invention relates to vinyl ester resins which can be crosslinked in the presence of a liquid diluent comonomer and a miscible toughener. Since the blend of the toughener and the vinyl ester resin are compatible before cure, the composition has good stability, and is thus storable for extended periods of time, and when subsequently crosslinked has good toughened properties.

### BACKGROUND OF THE INVENTION

Tougheners and the use thereof as additives in various polymers are known and generally result in improved properties such as impact resistance.

U.S. Pat. No. 3,892,819 relates to vinyl ester resins having impact resistance can be obtained by a process wherein a polyepoxide is reacted with an unsaturated monocarboxylic acid and a liquid carboxy terminated polydiene rubber. The combined acid equivalents of said unsaturated acid and polydiene rubber ranges from about 0.8 to 1.2 equivalents per epoxide equivalent. At least about 80% of the acid equivalents comprises the unsaturated acid and the balance between 0.01% and 20% comprises the polydiene rubber, provided that the polydiene rubber content of the resin is at least about 4 weight percent.

U.S. Pat. No. 5,198,510 to Siebert and Guiley relates to producing a modified vinyl ester resin composition having improved fracture energy toughness while retaining other properties including thermomechanical properties, by admixing and miscibilizing a reactive liquid polymer additive with a vinyl ester resin already having a reactive liquid polymer reacted into the resin backbone.

U.S. Pat. No. 5,312,956 to Bertsch relates to a non-functional liquid rubber prepared by the solution polymerization of vinyl monomers. The polymer may be a homopolymer or a copolymer. As a copolymer the preferred monomers are a conjugated diene and a vinyl substituted nitrile such as acrylonitrile or methacrylonitrile. A non-functional initiator is employed that is either an azo initiator or a peroxide initiator.

### SUMMARY OF THE INVENTION

The present invention relates to preparation of uncured vinyl ester resins and to thermoset vinyl ester resin compositions thereof containing tougheners therein. The vinyl ester resins are derived from the reaction of an unsaturated acid, and a blend of an epoxy resin and an epoxidized terminated polymer such as a polyacrylate containing a dithio or trithio initiator therein. The thermoset vinyl ester resins are derived from crosslinking the vinyl ester resins in the presence of a diluent, tougheners derived from a trithio or dithio initiator, and a free radical catalyst such as a peroxide. An advantage of the present invention is that the vinyl ester resin and the toughener are miscible so that a stable composition is formed and when cured, i.e. crosslinked, has equivalent or better mechanical properties than that of the vinyl ester resin per se. In contrast, vinyl ester resins made by either reacting an unsaturated acid with an epoxy resin, or by reacting a carboxylated butadiene-acrylonitrile copolymer reacted with an epoxy, are immiscible with tougheners such as epoxy terminated copolymers of butadiene-acrylonitrile and thus are generally not stable unless immediately crosslinked.

### DETAILED DESCRIPTION OF THE INVENTION

Preparation of CTP and ETP such as CTA and ETA.

The preparation of carboxyl terminated polymers and epoxidized terminated polymers, respectively CTP and ETP, of acrylate polymers, respectively CTA and ETA made from dithio and trithio initiators is described below. The following description as well as other descriptions with regard to the preparation and use of CTP and CTA derived from trithio initiators is set forth in U.S. Pat. No. 6,596,899, and U.S. Ser. No. 10/219,403 filed Aug. 15, 2002, whereas the CTP and CTA derived from dithio initiators as set forth in U.S. patent application Ser. No. 10/278,335 filed Oct. 23, 2002, and U.S. patent application Ser. No. 10/681,679 filed Oct. 8, 2003, are all hereby fully incorporated by reference.

### Preparation of Trithio Initiators

Trithiocarbonate and derivatives prepared by the processes disclosed later herein generally can be described by the formula: 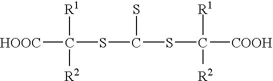
wherein R¹ and R², independently, can be the same or different, and can be linear or branched alkyls having from 1 to about 6 carbon atoms, or a C₁ to about C₆ alkyl having one or more substituents, or one or more aryls or a substituted aryl group having 1 to 6 substituents on the aryl ring, where the one or more substituents, independently, comprise an alkyl having from 1 to 6 carbon atoms; or an aryl; or a halogen such as fluorine or chlorine; or a cyano group; or an ether having a total of from 2 to about 20 carbon atoms such as methoxy, or hexanoxy; or a nitro; or combinations thereof. Examples of such compounds include s,s′-bis-2-methyl-2-propanoic acid-trithiocarbonate and s,s′-bis-(2-phenyl-2-propanoic acid)-trithiocarbonate. R¹ and R² can also form or be a part of a cyclic ring having from 5 to about 12 total carbon atoms. R¹ and R² are preferably, independently, methyl or phenyl groups.

The abbreviated reaction formula for the formation of the s,s′-bis-(α,α′-disubstituted-α″-acetic acid)-trithiocarbonates of the present invention can be generally written as follows:

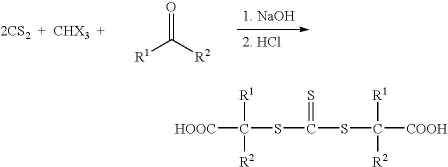

The process utilized to form the s,s′-bis-(α,α′-disubstituted-α″-acetic acid)-trithiocarbonate compounds of the present invention is generally a multi-step process and includes combining the carbon disulfide and a base whereby an intermediate trithio structure is formed, see I, II, III, and IV. Ketone can serve as solvent for the carbon disulfide/base reaction and thus can be added in the first step of the reaction. In the second step of the reaction, the haloform, or haloform and ketone, or a α-trihalomethyl-α-alkanol are added to the trithio intermediate mixture and reacted in the presence of additional base, see V, VI, and VII. The formed reaction product, see IX, is subsequently acidified, thus completing the reaction and forming the above described s,s′-bis-(α,α′-disubstituted-α″-acetic acid)-trithiocarbonate compound, see X.

The reaction is carried out at a temperature sufficient to complete the interaction of the reactants so as to produce the s,s′-bis-(α,α′-disubstituted-α″-acetic acid)-trithiocarbonate compound in a desired time. The reaction can be carried out at any temperature within a wide range from about the freezing point of the reaction mass to about the reflux temperature of the solvent. The reaction temperature is generally from about minus 15° C. to about 80° C., desirably from about 0° C. to about 50° C., and preferably from about 15° C. to about 35° C., with room temperature being preferred. The reaction can be performed at atmospheric pressure. The reaction time depends upon several factors, with the temperature being most influential. The reaction is generally complete within 20 hours and preferably within 10 hours.

A phase transfer catalyst is preferably utilized if a solvent is used in the reaction. Examples of solvents are set forth herein below. The ketone utilized in the reaction may double as a solvent, and therefore no catalyst usually is needed. The amount of phase transfer catalyst, when utilized in the present invention, is generally from about 0.1 mole percent to about 10 mole percent, desirably from about 0.5 mole percent to about 5 mole percent and preferably from about 2 mole percent to about 4 mole percent per mole of carbon disulfide. The phase transfer catalysts can be polyether, and/or an onium salt including a quaternary or tertiary organic compound of a group VA or VIA element of the Periodic Table and salts thereof. Most preferred are quaternary amines, and salts thereof.

The “Onium salt” catalyst, more particularly refer to tertiary or quaternary amines and salts, generally used in the phase transfer catalysis of heterogeneous reaction in immiscible liquids. The general requirement for the onium salt chosen is that it be soluble in both the organic and aqueous phases, when these two liquid phases are present, and usually a little more soluble in the organic phase than the aqueous phase. The reaction will also proceed with a phase transfer catalyst when there is only a single organic liquid phase present, but such a reaction is less preferable than one in which both aqueous and organic liquid phases are present. A wide variety of onium salts is effective in this ketoform synthesis.

The onium salts include the well-known salts, tertiary amines and quaternary compounds of group VA elements of the Periodic Table, and some Group VIA elements such as are disclosed in the U.S. Pat. No. 3,992,432 and in a review in Angewandte Chemie, International Edition in English, 16 493-558 (August 1977). Discussed therein are various anion transfer reactions where the phase transfer catalyst exchanges its original ion for other ions in the aqueous phase, making it possible to carry our chemistry there with the transported anion, including OH-ions.

The onium salts used in this synthesis include one or more groups having the formula (RₙY)⁺X⁻, wherein Y is either a pentavalent ion derived from an element of Group VA, or a tetravalent ion derived from an element of Group VIA; R is an organic moiety of the salt molecule bonded to Y by four covalent linkages when Y is pentavalent, and three covalent linkages when Y is tetravalent; X⁻ is an anion which will dissociate from the cation (RₙY)⁺ in an aqueous environment. The group (RₙY)⁺X⁻ may be repeated as in the case of dibasic quaternary salts having two pentavalent Group VA ions substituted in the manner described.

The preferred onium salts for use in the invention have the formula
(R^{A}R^{B}R^{C}R^{D}Y⁺)X⁻
wherein Y is N or P, and R¹-R⁴ are monovalent hydrocarbon radicals preferably selected from the group consisting of alkyl, alkenyl, aryl, alkaryl, aralkyl, and cycloalkyl moieties or radicals, optionally substituted with suitable heteroatom-containing functional groups. The onium salts are generally selected to be less preferentially less soluble in the less polar of the two distinct liquid phases. Any of the salts disclosed in the U.S. Pat. No. 3,992,432 will be found effective, but most preferred are those in which the total number of carbon atoms in R^{A}, R^{B},R^{C}, and R^{D} cumulatively range from about 13 to about 57, and preferably range from about 16 to about 30. Most preferred onium salts have Y═N, and hydrocarbon radicals where R^{A} is CH₃, and R^{B}, R^{C}, and R^{D} are each selected from the group consisting of n-C₂H₅, n-C₄H₅; n-C₅H₁₁; mixed C₅H₁₇; n-C₁₂H₂₅; n-C₁₈H₃₇; mixed C₈-C₁₀ alkyl; and the like. However, R^{A} may also be selected from C₂H₅, n-C₃H₇ and n-C₄H₉ benzyl.

Various counterions may be used, including Cl⁻, Br⁻, I⁻, NO₃⁻, SO₄⁻², HSO₄⁻ and CH₂CO₂⁻. Most preferred is Cl⁻.

The tertiary amines or triamines useful as phase transfer catalysts in this synthesis include the alkyl amines and the aryldialkylamines, exemplified by tributylamine and phenyldibutylamine respectively, which are commonly available, wherein each alkyl may have from 1 to about 16 carbon atoms.

The polyethers useful as catalysts in this synthesis include cyclic polyethers such as the crown ethers, disclosed in Agenwandte Chemie, supra, and acyclic polyethers having the formula
R—O—R^{E}
wherein R and R^{E} are, independently, alkyls having from 1 to about 16 carbon atoms, or alkyl containing substituted functional groups such as hydroxy, sulfur, amine, ether, etc. Most preferred acyclic polyethers have the formula
R—(OCH₂CH₂), OR″
wherein
R is an alkyl having from 1 to about 16 carbon atoms
R″ is an alkyl having from 1 to about 16 carbon atoms, or H, and
r is an integer in the range from 0 to about 300.
   Most preferred are commonly available polyethers such as: tetraethylene glycol dimethyl ether; polyethylene oxide (mol wt. About 5000); poly(ethylene glycol methyl ether); 1,2-dimethoxyethane; diethyl ether, and the like.

Polyether catalysts are especially desirable in this ketoform synthesis because they are directive so as to produce a preponderance of the desired symmetrically substituted isomer, in a reaction which is remarkably free of undesirable byproducts, which reaction proceeds with a relatively mild exotherm so that the reaction is controllable.

The organic solvent can be any solvent in which the reactants are soluble and include hydrohalomethylenes, particularly hydrochloromethylenes, sulfolane, dibutyl ether, dimethyl sulfone, diisopropyl ether, di-n-propyl ether, 1,4-dioxane, tetrahydrofuran, benzene, toluene, hexane, carbon tetrachloride, heptane, mineral spirits and the like. Most preferred solvents are heptanes and mineral spirits. Solvent is generally utilized in an amount generally from about 10 to about 500 percent and preferably from about 50 percent to about 200 percent based on the total weight of the reactants.

Insofar as the reactive components are concerned, any of various ketones having the general formula: 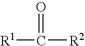
can be employed in the synthesis, wherein R¹ and R² are described herein above. As carbon disulfide is the controlling agent in the reaction, the ketone is generally used in an amount from about 110 mole percent to about 2,000 mole percent per mole of carbon disulfide. When the ketone is used as a solvent, it is generally utilized in an amount of from about 150 mole percent to about 300 mole percent, and preferably from about 180 mole percent to about 250 mole percent per mole of carbon disulfide.

The alkali bases suitable for use in the synthesis of the present invention include, but are not limited to, sodium hydroxide and potassium hydroxide. The base is utilized in an amount generally from about 5 times to about 15 times the number of moles of carbon disulfide and preferably from about 6 to about 10 times the number of moles of carbon disulfide utilized in the reaction.

The acids used in the acidification step include, but are not limited to, hydrochloric acid, sulfuric acid, phosphoric acid, etc. The acids are utilized in amounts suitable to make the aqueous solution acidic.

The haloform of the present invention has the general formula CHX₃ wherein X is, independently, chlorine or bromine. The amount of haloform used in the present invention is generally from about 110 mole percent to about 2000 mole percent, desirably from about 150 mole percent to about 300 mole percent, and preferably 180 mole percent to about 250 mole percent per mole of carbon disulfide. Examples of haloforms include, but are not limited to, chloroform and bromoform, and chloroform is the preferred haloform of the present invention.

Alternatively, instead of adding both a haloform and a ketone, to the reaction mixture, an α-trihalomethyl-α-alkanol can be substituted therefore. The amount of α-trihalomethyl-α-alkanol utilized in the reaction generally is from about 110 mole percent to about 2000 mole percent, desirably is from about 150 mole percent to about 300 mole percent, and preferably is from about 180 mole percent to about 250 mole percent per mole of carbon disulfide. The general formula of the α-trihalomethyl-α-alkanol is generally represented as follows: 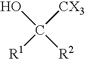
wherein X, R¹ and R² are defined above.

While not wishing to be limited to any particular mechanism, it is believed that the specific mechanism for the reaction process is as follows:

Initially, the carbon disulfide and sodium hydroxide are reacted.

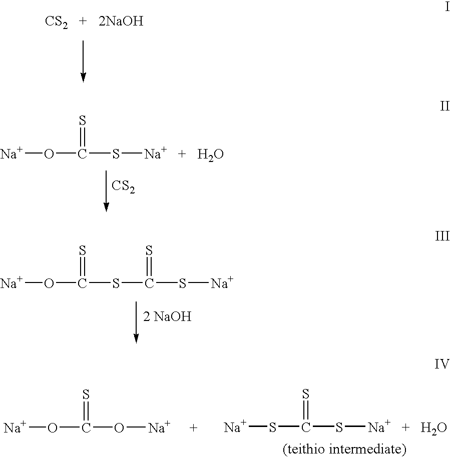

In the subsequent step of the reaction, the chloroform is reacted with the ketone as follows:

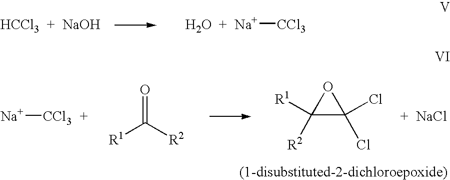

Then, the following is reacted:

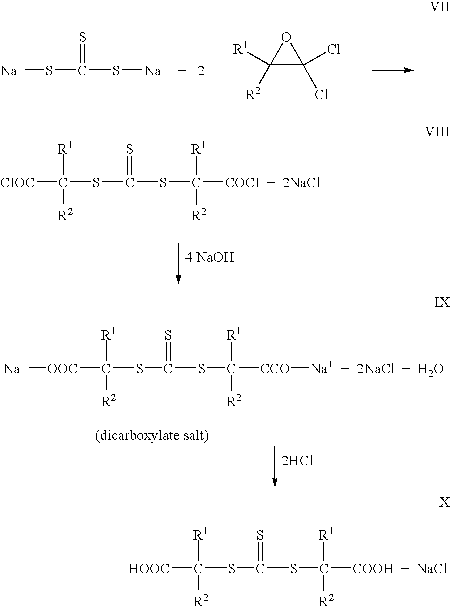

The overall reaction is as follows:

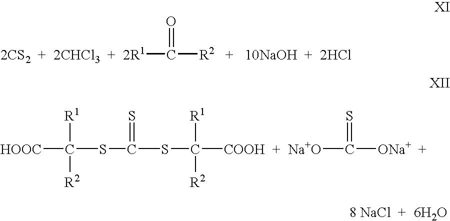

Use of the s,s′-bis-(α,α′-Disubstituted-α″-acetic Acid)-trithiocarbonate

The s,s′-bis-(α,α-disubstituted-α″-acetic acid)-trithiocarbonate compounds produced by the present invention can generally be classified as inifertors, meaning that they act as both a chain transfer agent and an initiator. The use of other types of inifertors for block copolymers was discussed by Yagei and Schnabel in Progress in Polymer Science 15, 551 (1990) and is hereby fully incorporated by reference.

Thus, the compounds of the present invention can be utilized as initiators to initiate or start the polymerization of a monomer. They can also act as a chain transfer agent, which interrupts and terminates the growth of a polymer chain by formation of a new radical which can act as a nucleus for forming a new polymer chain. The compounds can also be utilized as terminators in that when most of initiating radicals and monomers are consumed, the compounds are incorporated in the polymers as a dormant species. Desirably though, another compound, such as those listed herein below, is often used as an initiator in the free radical polymerization process as described herein below, and the s,s′-bis-(α,α′-disubstituted-α″-acetic acid)-trithiocarbonate compounds of the present invention will act as a chain-transfer agent.

The s,s′-bis-(α,α′-disubstituted-α″-acetic acid)-trithiocarbonate compounds of the present invention can also be used as chain transfer agents in a free radical polymerization process to provide polymerizations which have living characteristics and polymers of controlled molecular weight and low polydispersity, as well as for forming telechelic polymers.

A living polymerization is a chain polymerization which proceeds in the absence of termination and chain transfer. The following experimental criteria can be utilized to diagnose a living polymerization.
1. Polymerization proceeds until all monomer has been consumed. Further addition of monomer results in continued polymerization.
2. The number average molecular weight, Mₙ (or Xₙ, the number average degree of polymerization), is a linear function of conversion.
3. The number of polymer molecules (and active centres) is constant and independent of conversion.
4. The molecular weight can be controlled by the stoichiometry of the reaction.
5. Narrow molecular weight distribution polymers are produced.
6. Chain-end functionalized polymers can be prepared in quantitative yields.
7. In radical polymerization, the number of active end groups should be 2, one for each end.

Besides those mentioned above, other criteria can also help to determine the living character of polymerization. For radical living polymerization, one is the ability of the polymer isolated from the first step of polymerization to be used as a macroinitiator for the second step of a polymerization in which block copolymers or grafted polymers are ultimately formed. To confirm the formation of block copolymers, measurements of molecular weights and a determination of the structure of the blocks are employed. For structure measurements, the examination of NMR or IR signals for the segments where individual blocks are linked together and a determination of the end groups are both very important. In radical polymerization, only some of the criteria for living polymerizations are actually fulfilled. Due to their ability to undergo further polymerization, these types of polymers can also be called ‘reactive polymers’. A more detailed description of living polymerization can be found in “Living Free-Radical Block Copolymerization Using Thio-Inifertors”, by Anton Sebenik, Progress in Polymer Science, vol. 23, p. 876, 1998.

The living polymerization processes can be used to produce polymers of narrow molecular weight distribution containing one or more monomers sequences whose length and composition are controlled by the stoichiometery of the reaction and degree of conversion. Homopolymers, random copolymers or block polymers can be produced with a high degree of control and with low polydispersity. Low polydispersity polymers are those with polydispersities that are significantly less than those produced by conventional free radical polymerization. In conventional free radical polymerization, polydispersities (polydispersity is defined as the ratio of the weight average to the number average molecular weight M_{w}/Mₙ) of the polymers formed are typically greater than 2.0. Polydispersities obtained by utilizing the s,s′-bis-(α,α′-disubstituted-α″-acetic acid)-trithiocarbonate compounds and derivatives thereof of the present invention are preferably 1.75 or 1.5, or less, often 1.3 or less, and, with appropriate choice of the chain transfer agent and the reaction conditions, can be 1.25 or less.

When the s,s′-bis-(α,α′-disubstituted-α″-acetic acid)-trithiocarbonates compounds are utilized only as chain-transfer agents, the polymerization can be initiated with other initiators at lower temperature while yielding polymers with similarly controlled fashion.

### Living Polymerization

Free radical polymerizations utilizing the s,s′-bis-(α,α′-disubstituted-α″acetic acid)-trithiocarbonate compounds as both initiators and chain transfer agents generally form telechelic polymers. When an initiator other than the s,s′-bis-(α,α′-disubstituted-α″-acetic acid)-trithiocarbonate compound is also utilized, a polymer having a single functional end group is formed in proportion to the amount of said other initiator to this s,s′-bis-(α,α′-disubstituted-α″-acetic acid)-trithiocarbonate compound utilized.

The free radical living polymerization process of the invention can be applied to any monomers or monomer combinations which can be free-radically polymerized. Such monomers include one or more conjugated diene monomers or one or more and vinyl containing monomers such as acrylate or methacrylate esters, vinyl substituted aromatics such as styrene, acrylonitrile, or combinations thereof.

The diene monomers have a total of from 4 to 12 carbon atoms and examples include, but are not limited to, 1,3-butadine, isoprene, 1,3-pentadiene, 2,3-dimethyl-1-3-butadeine, 2-methyl-1,3-pentadiene, 2,3-dimethyl-1,3-pentadiene, 2-phenyl-1,3-butadiene, and 4,5-diethyl-1,3-octadiene, and combinations thereof.

The vinyl containing monomers have the following structure: 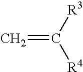
where R³ comprises hydrogen, halogen, C₁ to C₄ alkyl, or substituted C₁-C₄ alkyl wherein the substituents, independently, comprise one or more hydroxy, alkoxy, aryloxy(OR⁵), carboxy, acyloxy, aroyloxy(O₂CR⁵), alkoxy-carbonyl(CO₂R⁵), or aryloxy-carbonyl; and R⁴ comprises hydrogen, R⁵, CO₂H, CO₂R⁵, COR⁵, CN, CONH₂, CONHR⁵, O₂CR⁵, OR⁵, or halogen. R⁵ comprises C₁ to C₁₈ alkyl, substituted C₁-C₁₈ alkyl, C₂-C₁₈ alkenyl, aryl, heterocyclyl, aralkyl, or alkaryl, wherein the substituents independently comprise one or more epoxy, hydroxy, alkoxy, acyl, acyloxy, carboxy, (and salts), sulfonic acid (and salts), alkoxy- or aryloxy-carbonyl, sicyanato, cyano, silyl, halo and dialkylamino. Optionally, the monomers comprise maleic anhydride, N-alkylmaleimide, N-arylmaleimide, dialkyl fumarate and cyclopolymerizable monomers. Monomers CH₂═CR³R⁴ as used herein include C₁-C₈ acrylates and methacrylates, acrylate and methacrylate esters, acrylic and methacrylic acid, styrene, α methyl styrene, C₁-C₁₂ alkyl styrenes with substitute groups both either on the chain or on the ring, acrylamide, methacrylamide, and methacrylonitrile, mixtures of these monomers, and mixtures of these monomers with other monomers. As one skilled in the art would recognize, the choice of comonomers is determined by their steric and electronic properties. The factors which determine copolymerizability of various monomers are well documented in the art. For example, see: Greenley, R. Z., in Polymer Handbook, 3^{rd} Edition (Brandup, J., and Immergut, E. H. Eds.) Wiley: New York, 1989 pII/53.

Specific monomers or comonomers include the following: methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methylstyrene. methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile. styrene, functional methacrylates, acrylates and styrenes selected from glycidyl methacrylate, 2-hydroxyethyl, methacryliate, hydroxypropyl methacrylate (all isomers), hydroxybutyl methacrylate (all isomers), N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide, N,N-dimethylacrylamide, N-tertbutylmethacrylamide, N-n-butylmethacrylamide, N-methylolmethacrylamide, N-ethylotmethacrylamide. N-tert-butylacrylamide. N-n-butylacrylamide, N-methylolacrylamide, N-ethylolacrylamide, vinyl benzoic acid (all isomers), dethylaminostyrene (all isomers), alpha-methylvinyl benzoic acid (all isomers), dethylamino alpha-methylstyrene (all isomers). p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxy, silylpropyl methacrylate, diisopropoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl amiate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, butadiene, isoprene, chloroprene, ethylene, and propylene, and combinations thereof.

Preferred monomers are C₁-C₁₈ acrylates, C₁-C₁₈ methacrylates, vinyl substituted aromatics containing a total of from 8 to about 12 carbon atoms such as styrene, conjugated dienes containing from 4 to about 12 carbon atoms such as butadiene, or isoprene; as well as acrylonitrile. Considering the methacrylates and more desirably the acrylates, the ester portion is an aliphatic, aromatic, or combination thereof containing from 1 to about 18 carbon atoms, desirably as an alkyl containing from 1 to about 8 carbon atoms with 2 to about 4 carbon atoms such as ethyl or butyl being especially preferred for forming carboxyl terminated polyacrylates for subsequent use as a toughener for epoxy resins. The same will be more fully discussed herein below.

As noted above, in order to initiate the free radical polymerization process, it is often desirable to utilize an initiator as a source for initiating free radicals. Generally, the source of initiating radicals can be any suitable method of generating free radicals such as the thermally induced homolytic scission of a suitable compound(s) (thermal initiators such as peroxides, peroxyesters, or azo compounds), the spontaneous generation from monomer (e.g., styrene), redox initiating systems, photochemical initiating systems or high energy radiation such as electron beam, X- or gamma-radiation. The initiating system is chosen such that under the reaction conditions there is no substantial adverse interaction of the initiator or the initiating radicals with the transfer agent under the conditions of the experiment. The initiator should also have the requisite solubility in the reaction medium or monomer mixture. The s,s′-bis-(α,α′-disubstituted-α″-acetic acid)-trithiocarbonate compounds of the invention can serve as an initiator, but the reaction must be run at a higher temperature. Therefore, optionally it is desirable to utilize an initiator other than the s,s′-bis-(α,α′-disubstituted-α″-acetic acid)-trithiocarbonates compounds of the present invention.

Thermal initiators are chosen to have an appropriate half-life at the temperature of polymerization. These initiators can include one or more of the following compounds:

2,2′-azobis(isobutyronitrile)(AIBN), 2,2′-azobis(2-cyano-2-butane), dimethyl 2,2′-azobisdimethylisobutyrate, 4,4′-azobis(4-cyanopentanoic acid), 1,1′-azobis(cyclohexanecarbanitrile), 2-(t-butylazo)-2-cyanopropane, 2,2′-azobis[2-methyl-N-(1,1)-bis(hydoxymethyl)-2-hydroxyethyl]propionamide, 2,2′-azobis[2-methyl-N-hydroxyethyl)]-propionamide, 2,2′-azobis(N,N′-dimethyleneisobutyramidine) dihydrochloride, 2,2′-azobis(2-amidinopropane)dihydrochloride, 2,2′-azobis(N,N′-dimethyleneisobutyramine), 2,2′-azobis(2-methyl-N-[1,1-bis(hydroxymethyl)-2-hydroxyethyl]propionamide), 2,2′-azobis(2-methyl-N-[1,1-bis(hydroxymethyl) ethyl]propionamide), 2,2′-azobis[2-methyl-N-(2-hydroxyethyl) propionamide], 2,2′-azobis(isobutyramide) dehydrate, 2,2′-azobis(2,2,4-trimethylpentane), 2,2′-azobis(2-methylpropane), t-butyl peroxyacetate, t-butyl peroxybenzoate, t-butyl peroxyoctoate, t-butylperoxyneodecanoate, t-butylperoxy isobutyrate, t-amyl peroxypivalate, t-butyl peroxypivalate, di-isopropyl peroxydicarbonate, dicyclohexyl peroxydicarbonate, dicumyl peroxide, dibenzoyl peroxide, dilauroylperoxide, potassium peroxydisulfate, ammonium peroxydisulfate, di-t-butyl hyponitrite, dicumyl hyponitrite.

Another difunctional initiator is a bis-azocyano acid having the formula 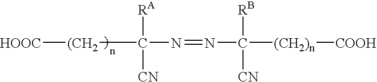
wherein R^{A} and R^{B}, independently, is an alkyl group of 1-3 carbon atoms, and n, independently, is an integer from 0 to 6. The preferred acids include azodicyanobutyric acid and azodicyanovaleric acid (ADVA), with ADVA being the most preferred. The preparation of these materials is known and disclosed in U.S. Pat. Nos. 3,285,949 and 2,520,338, which are incorporated herein by reference.

Photochemical initiator systems are chosen to have the requisite solubility in the reaction medium or monomer mixture and have an appropriate quantum yield for radical production under the conditions of the polymerization. Examples include benzoin derivatives, benzophenone, acyl phosphine oxides, and photo-redox systems production under the conditions of the polymerization; these initiating systems can include combinations of the following oxidants and reductants:
oxidants: potassium peroxydisulfate, hydrogen peroxide, t-butyl hydroperoxide reductants: iron (11), titanium (111), potassium thiosulfite, potassium bisulfite.

Other suitable initiating systems are described in recent texts. See, for example, Moad and Solomon “The Chemistry of Free Radical Polymerization”. Pergamon, London. 1995. pp 53-95.

The preferred initiators of the present invention are 2,2′-azobis(isobutyronitrile)(AIBN), or 4,4′-azobis(4-cyanopentanoic acid), or 2,2′-azobis(2-cyano-2-butane), or 1,1′-azobis(cyclohexanecarbanitrile), or azodicyanobutyric acid or azodicyanovaleric acid (ADVA).

The amount of initiators utilized in the polymerization process can vary widely as generally from about 0.001 percent to about 99 percent, and desirably from about 0.01 percent to about 50 or 75 percent based on the total moles of chain transfer agent utilized. Preferably small amounts are utilized from about 0.1 percent to about 5, 10, 15, 20, or 25 mole percent based on the total moles of said s,s′-bis-(α,α′-disubstituted-α″-acetic acid)-trithiocarbonate compounds. In order to form polymers which are predominately telechelic, initiators other than the s,s′-bis-(α,α′-disubstituted-α″-acetic acid)-trithiocarbonate compounds are utilized in lesser amounts, such as from about 0.001 percent to about 5 percent, desirably from about 0.01 percent to about 4.5 percent, and preferably from about 0.1 percent to about 3 percent based on the molar equivalent to the total moles of chain transfer agent utilized.

Optionally, as noted above, solvents may be utilized in the free radical polymerization process. Examples of such solvents include, but are not limited to, C₆-C₁₂ alkanes, toluene, chlorobenzene, acetone, t-butyl alcohol, and dimethylformamide. The amount of solvent utilized in the present invention polymerization process is generally from about 10 percent to about 500 percent the weight of the monomer, and preferably from about 50 percent to about 200 percent the weight of the monomer utilized in the polymerization.

As stated above, it is preferable to utilize the s,s′-bis-(α,α′-disubstituted-α″-acetic acid)-trithiocarbonate compounds of the invention as chain transfer agents in the free radical polymerization process. The amount of chain transfer agent (CTA) utilized depends on the desired molecular weight of the polymer to be formed and can be calculated as known by one skilled in the art. A formula for calculating the amount of chain transfer agent is as follows:

$$Mn of polymer = ( \frac{Weight of monomer \times molecular weight CTA}{Weight of CTA} ) + molecular weight of CTA$$

While not wishing to be limited to any particular mechanism, it is believed that the mechanism of the free radical living polymerization process is as follows when using a vinyl monomer:

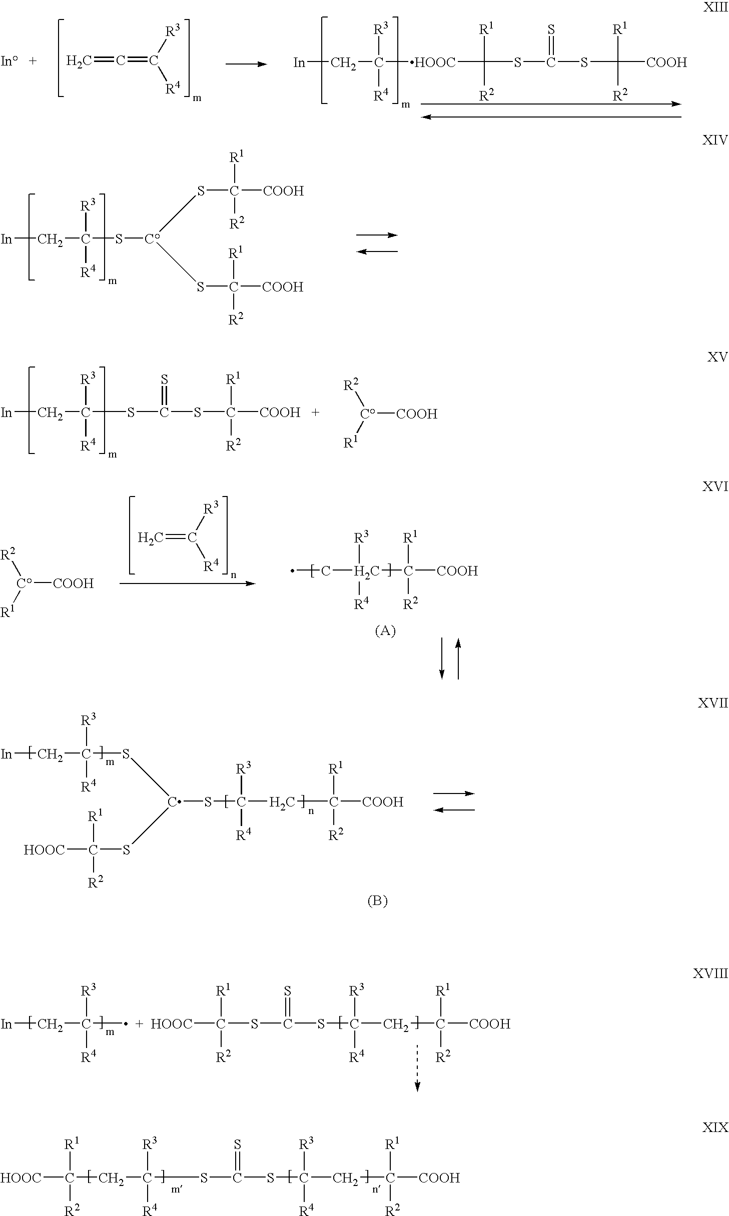

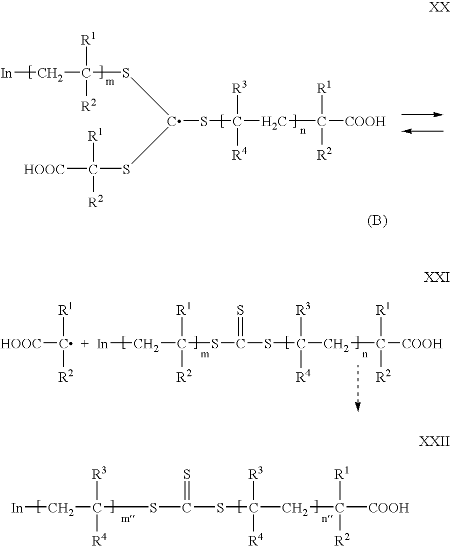

As can be seen from the above mechanism, polymers having two different structures, see XIX and XXII, can be formed. The resulting polymers are either telechelic polymers (formed by the trithiocarbonate compounds of the present invention) with identical functional groups at the ends of the chain, or a polymer having a single functional end group and also an initiator terminated chain (formed by using a conventional initiator such as AIBN). Such polymers are referred to as CTP, that is carboxyl terminated polymers and when the polymer is an acrylate they are referred to as a CTA, that is a carboxyl terminated acrylate. As stated above, the ratios between the resulting polymers can be controlled to give desired results and generally depends on the amount of initiator utilized. Obviously, if the initiator is the only s,s′-bis-(α,α′-disubstituted-α″-acetic acid)-trithiocarbonate compound of the present invention, the resulting polymers are always telechelic. The greater the amount of the other initiator utilized, proportionally decreases the amount of telechelic polymers formed. Generally, the amount of the repeat group m, m′, m″, n, n′, or n″, is generally from about 1 to about 10,000, desirably from about 5 to about 500 or 1,000, and preferably from about 7, or about 10 to about 20, or about 30, or about 50, or about 1 50, or about 200. Inasmuch as one or more vinyl monomers and/or one or more diene monomers can be utilized, it is to be understood that repeat groups of the polymers of the present invention are generally indicated by formulas XIX and XXII and can be the same or different. That is, random copolymers, terpolymers, etc., can be formed within either of the two repeat groups noted, as well as block copolymers which can be formed by initially adding one monomer and then subsequently adding a different monomer (e.g. an internal block copolymer).

### Formation of Polymers Using TTC

The polymers formed by the present invention can be generally represented by the following formula: 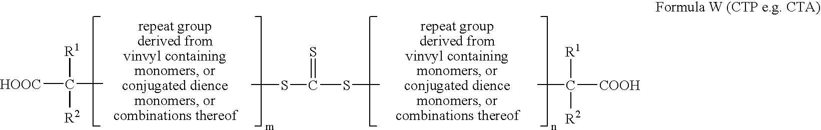
wherein such monomers are described herein above. Of course, the above formula can contain an initiator end group thereon as in XXII.

The reaction conditions are chosen as known to one skilled in the art so that the temperature utilized will generate a radical in a controlled fashion, wherein the temperature is generally from about room temperature to about 200° C. The reaction can be run at temperatures lower than room temperature, but it is impractical to do so. The temperature often depends on the initiator chosen for the reaction, for example, when AIBN is utilized, the temperature generally is from about 40° C. to about 80° C., when azodicyanovaleric acid (ADVA) is utilized, the temperature generally is from about 50° C. to about 90° C., when di-t-butylperoxide is utilized, the temperature generally is from about 110° C. to about 160° C., when s,s′-bis-(α,α′-disubstituted-α″-acetic acid) is utilized, the temperature is generally from about 80° C. to about 200° C.

The low polydispersity polymers prepared as stated above by the free radical polymerization can contain reactive end groups from the monomers which are able to undergo further chemical transformation or reaction such as being joined with another polymer chain, such as to form block copolymers for example. Therefore, any of the above listed monomers, i.e. conjugated dienes or vinyl containing monomers, can be utilized to form block copolymers utilizing the s,s′-bis-(α,α-distributed-α″-acetic acid)-trithiocarbonate compounds as chain transfer agent. Alternatively, the substituents may be non-reactive such as alkoxy, alkyl, or aryl. Reactive groups should be chosen such that there is no adverse reaction with the chain transfer agents under the conditions of the experiment.

The process of this invention can be carried out in emulsion, solution or suspension in either a batch, semi-batch, continuous, or feed mode. Otherwise-conventional procedures can be used to produce narrow polydispersity polymers. For lowest polydispersity polymers, the chain transfer agent is added before polymerization is commenced. For example, when carried out in batch mode in solution, the reactor is typically charged with chain transfer agent and monomer or medium plus monomer. The desired amount of initiator is then added to the mixture and the mixture is heated for a time which is dictated by the desired conversion and molecular weight. Polymers with broad, yet controlled, polydispersity or with multimodal molecular weight distribution can be produced by controlled addition of the chain transfer agent over the course of the polymerization process.

In the case of emulsion or suspension polymerization the medium will often be predominately water and the conventional stabilizers, dispersants and other additives can be present. For solution polymerization, the reaction medium can be chosen from a wide range of media to suit the monomer(s) being used.

As already stated, the use of feed polymerization conditions allows the use of chain transfer agents with lower transfer constants and allows the synthesis of block polymers that are not readily achieved using batch polymerization processes. If the polymerization is carried out as a feed system the reaction can be carried out as follows in an inert atmosphere such as nitrogen or argon. The reactor is charged with the chosen medium, the chain transfer agent and optionally a portion of the monomer(s). The remaining monomer(s) is placed into a separate vessel. Initiator is dissolved or suspended in the reaction medium in another separate vessel. The medium in the reactor is heated and stirred while the monomer+medium and initiator+medium are introduced over time, for example by a syringe pump or other pumping device. The rate and duration of feed is determined largely by the quantity of solution the desired monomer/chain transfer agent/initiator ratio and the rate of the polymerization. When the feed is complete, heating can be continued for an additional period.

Following completion of the polymerization, the polymer can be isolated by stripping off the medium and unreacted monomer(s) or by precipitation with a non-solvent. Alternatively, the polymer solution/emulsion can be used as such, if appropriate to its application.

The invention has wide applicability in the field of free radical polymerization and can be used to produce polymers and compositions for coatings, including clear coats and base coat finishes for paints for automobiles and other vehicles or maintenance finished for a wide variety of substrates. Such coatings can further include pigments, durability agents, corrosion and oxidation inhibitors, rheology control agents, metallic flakes and other additives. Block and star, and branched polymers can be used as compatibilizers, thermoplastic elastomers, dispersing agents or rheology control agents. Additional applications for polymers of the invention are in the fields of imaging, electronics (e.g., photoresists), engineering plastics, adhesives, sealants, and polymers in general.

As can be seen in the above shown polymerization mechanism, the s,s′-bis-(α,α′-disubstituted-α″-acetic acid)-trithiocarbonate compound can be utilized to create telechelic polymers.

The reaction conditions for the reactive functional acid end groups of the telechelic polymers or s,s′-bis-(α,α′-disubstituted-α″-acetic acid)-trithiocarbonate compounds of the present invention are generally the same as those for forming the above noted free radical polymers. The acid in the monomeric or in the polymeric form can be transformed to its derivatives in the conventional manner. For example, the ester can be made by refluxing the acid in alcohol with an acid catalyst with removal of water. Amides can be formed by heating the acid with an amine with the removal of water. 2-hydroxy-ethyl ester can be formed by directly reacting the acid with an epoxide with or without a catalyst such as triphenylphosphine or an acid like toluene-sulfonic acid. As seen by the examples below, any of the above noted monomers such as the one or more diene monomers or one or more vinyl containing monomers, can be utilized to form the telechelic monomers from the bis-(α,α′-distributed-α″-acetic acid)-trithiocarbonate compounds of the present invention. Any of the above noted components, such as solvent, etc., can be utilized in the herein above stated amounts.

The acid groups of the s,s′-bis-(α,α′-disubstituted-α″-acetic acid)-trithiocarbonate compound can be converted to other functional groups either before or after polymerization. Even if the s,s′-bis-(α,α′-disubstituted-α″-acetic acid)-trithiocarbonate compounds have functional end groups which have been converted from the acid end groups before polymerization, the monomers added during polymerization still add to the chain between the sulfur-tertiary carbon as shown in the mechanisms above as well as below at XXIII and XXIV. The carboxylic end groups of the s,s′-bis-(α,α′-disubstituted-α″-acetic acid)-trithiocarbonate compounds or the polymerized s,s′-bis-(α,α′-disubstituted-α″-acetic acid)-trithiocarbonate compounds can be converted or changed into other functional end groups such as esters, thioesters, amides, beta mercapto esters, beta hydroxy esters, or beta amino esters. Examples of these functional end groups are shown below.

An example reaction forming a telechelic polymer (e.g. CTP such as CTA) from the s,s′-bis-(α,α′-disubstituted-α″-acetic acid)-trithiocarbonate compounds of the invention when using a vinyl monomer as noted above, is as follows:

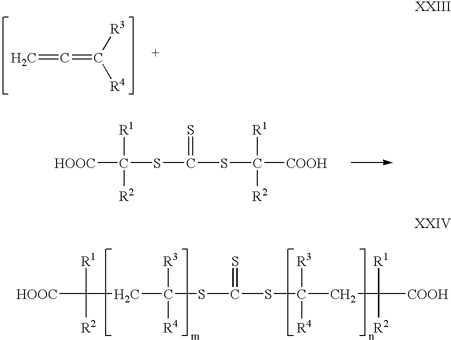

Of course, it is to be understood as indicated above, that the repeat units m and n can be derived either from conjugated diene monomers, or the indicated vinyl monomers, or combinations thereof, as generally set forth in Formula W.

Subsequently, other functional end groups can be derived from the acid groups of the s,s′-bis-(α,α′-disubstituted-α″-acetic acid)-trithiocarbonate compound and can generally be represented by the formula: 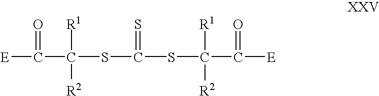
where E is set forth below. For example, 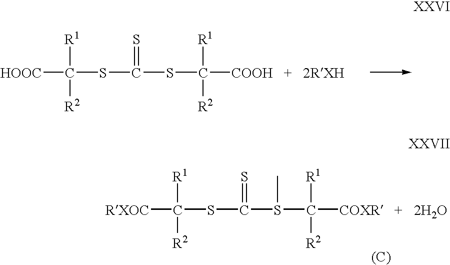
wherein E is XR′, that is R′, independently, comprises H, C₁-C₁₈ alkyls which can be optionally substituted with one or more halogen, hydroxyl, or alkoxy, C₁-C₁₈ hydroxyalkyls, and C₁-C₁₈ aminoalkyls and X comprises oxygen, sulfur, NH, or NR′.

The following is still another example of functional end groups which can be derived from the acid: 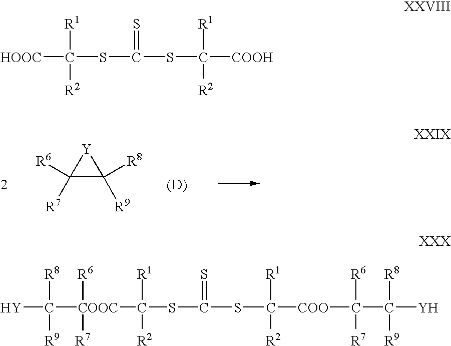
wherein E is 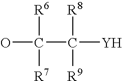
that is, where R⁶ through R⁹, independently comprise H, C₁-C₁₈ alkyls, aryl groups or substituted aryl groups having from 1 to 6 substituents on the ring, such as halogen, hydroxyl, or alkoxy, C₁-C₁₈ hydroxyalkyls, C₁-C₁₈ aminoalkyls, C₁-C₁₈ mercapto alkyls, and the like. Y can comprise oxygen, sulfur, NH, or NR⁶ to R⁹.

A further example of still other functional end groups which can be derived from the acid groups of the s,s′-bis-(α,α′-disubstituted-α″-acetic acid)-trithiocarbonate compounds is as follows: 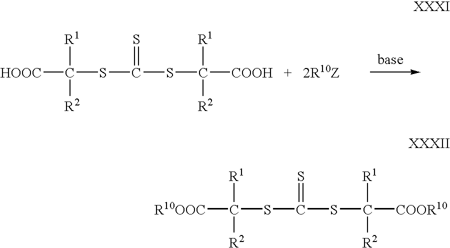
wherein E is OR¹⁰, that is where Z can comprise a leaving group, such as a halide or alkylsulfonate or aryl sulfonate. R¹⁰ can comprise C₁-C₁₈, a alkyl or substituted alkyl wherein said substituent is halogen, hydroxyl, or alkoxy, C₁-C₁₈ hydroxyalkyl or C₁-C₁₈ amino alkyl and the like.

Preparation of the above shown methylesters of s,s′-bis-(2-methyl-2-propanoic acid)-trithiocarbonate is as follows: s,s′-bis-(2-methyl-2-propanoic acid) trithiocarbonate (R¹,R²═CH³) (2.82 g, 0.01 mole), Sodium carbonate powders (3.18 g, 0.03 mole) and 15 ml dimethyl formamide were stirred under nitrogen at 40° C. while a solution of methyliodide (3.41 g, 0.024 mole) in 2 ml dimethylformamide was added dropwise over 10 minutes. The reaction was stirred at 40-50° C. for 2 hours, poured into 25 ml H₂O and extracted 3 times with a total of 200 ml. ether. The etherate solution was dried over magnesium sulfate and concentrated. The yellow solid was further purified by recrystallization from hexanes. Infrared and H′NMR showed the above desired product.

An example of an already formed telechelic polymer, made from a vinyl monomer, undergoing conversion of the acid end group is as follows: 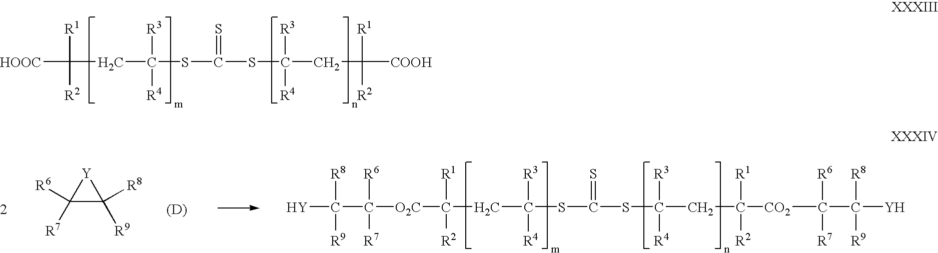
where m and n are as set forth above.

When in the immediate above formulation Y is an oxygen the resulting polymer of Formula XXXIV is an ETP, that is an epoxidized terminated polymer and when the m and/or n repeat group is an acrylate, an epoxidized terminated acrylate, ETA. Preparation of the same is set forth in U.S. patent application Ser. No. 10/219,403, filed Aug. 15, 2002.

The above structure (XXXIV) was formed by reaction of epoxide with s,s′-bis-(2-methyl-2-propanoic acid)-trithiocarbonate (I)(R¹,R²═CH₃, 0.01 mole) of the present invention and Epon® Resin 828 now owned by (Resolution Performance Products, reaction product of bisphenol A and epichlorohydrin, 80-85% diglycidyl ethers of bisphenol A) (70 g) and triphenyl phosphine (0.12 g) were heated to 95° C. under nitrogen. The reaction was monitored for the disappearance of the carboxylic acid by titration. It was found the reaction was essentially complete in 1.5 hours. The product structure can be further confirmed by mass spectroscopy. This aspect of the invention will be discussed in further detail herein below, especially with regard to toughened epoxy resins.

Another aspect of present invention further relates to forming the following compounds: 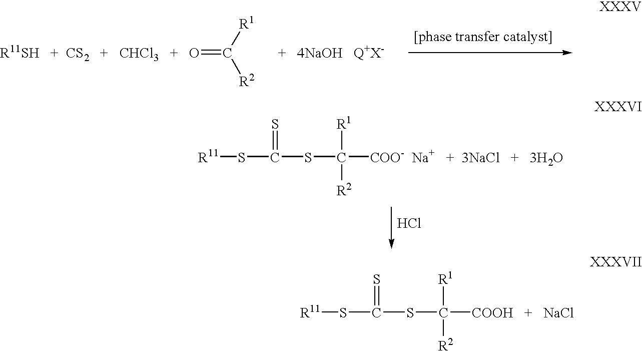
wherein R¹¹ comprises a benzyl group, C₁-C₁₈ alkyl, or substituted alkyl such as halogen, hydroxyl, or alkoxy, C₁-C₁₈ hydroxyalkyl, carboxylalkyl, or carboalkoxyalkyl. Q⁺\overline{X} is a phase transfer catalyst such as tetrabutylammoniumhydrogensulfate, or ctadecyltrimethylammoniumchloride (Aliquot 336).

The resulting compound is an s-substituted alkyl-s′-(α,α′-disubstituted-α″-acetic acid)-trithiocarbonate. R¹¹ is an alkyl having from 1-18 carbon atoms, aralkyl, hydroxyalkyl, cyanoalkyl, aminoalkyl, carboxylalkyl, or carboalkoxyalkyl, mercaptoalkyl, etc. R¹ and R² are as stated herein above.

When s-substituted alkyl-s′-(α,α′-disubstituted-α″-acetic acid)-trithiocarbonate is employed either as an inifertor, or as a chain-transfer agent, unless R¹¹ is carboxyl alkyl, only one end of the polymer has a carboxyl function, i.e. it is no longer a telechelic polymer.

While various polymers have been set forth herein above, it is to be understood that any of the carboxyl terminated polymers, such as W, or the E terminated polymers, and the like, can be reacted with one or more monomers and/or one or more polymers know to the art and to the literature to yield various resulting block polymers which are derived from the same monomer or from two or more different monomers. For example, each acid end group can be reacted with an excess of an epoxy compound such as a glycidyl bisphenol A and then subsequently polymerized with additional glycidyl bisphenol A to form an epoxy polymer. Naturally, other block polymers or copolymers can be reacted with the carboxylic end group or the other end groups generally denoted by E herein above.

The preparation of carboxyl terminated polymers CTP generally involves reacting the trithiocarbonate initiator with suitable monomers such as alkyl acrylates, using free radical initiators to obtain a CTA. The reaction can be a bulk polymerization, or preferably in the presence of a monomer or oligomer which not only can serve as a solvent, but later reacted with the formed polymer. As noted above, suitable acrylic or methacrylic monomers include alkyl alkacrylates wherein the alkyl is from 1 to about 18 carbon atoms and the alk group has from 1 to about 3 carbon atoms such as methyl methacrylate or more preferably an alkyl acrylate wherein the alkyl portion has from 1 to about 8 carbon atoms with ethylacrylate, butylacrylate, and ethyl-hexyl acrylate being highly preferred. The one or more acrylate monomers is incorporated into the backbone of the polymer adjacent to the trithiol group as shown in Formulas W and XXIV. Thus, the acrylate monomers will react and form acrylate repeat units on either side of the trithiol group of the trithiol carboxylate. The number of repeat units, that is “m” and “n” of the acrylate units, independently, is generally from about 5 to about 500 or about 1,000, and preferably from about 10 to about 20, or about 30, or about 50, or about 200.

The reaction conditions for forming the carboxyl terminated polymers of Formula W and XXIV are generally the same as set forth herein above. That is, a desired polymerization temperature is from about 25° C. to about 200° C., and will vary with the initiator. Desirable polymerization temperatures range from about 40° C. to about 125° C. with from about 50° C. to about 90° C. being preferred as in Examples 5 and 6. The initiators can be various peroxides or azo compounds as set forth hereinabove with AIBN and ADVA being highly preferred. While trithiocarbonate (TTC) can also be utilized as an initiator, it is not preferred. The amount of the initiator is generally small and can range from about 0.001 to about 20 and desirably from about 0.002 to about 5 parts by weight for every 100 parts by weight of the acrylate, or other monomers. With respect to the solvent, while it can be the same as set forth hereinabove, desirably it is an epoxy resin such as the reaction product of Bisphenol A and epichlorohydrin which is commercially available as Epon 828 from Resolution Performance Products as set forth herein below. A liquid epoxy resin is desirably utilized as a solvent since it will not react with the noted initiators such as AIBN or ADVA but will react in a subsequent step. A preferred form of a carboxyl terminated polymer containing acrylate repeat groups, CTA, which also acts as a toughener for thermosettable polymers, is set forth in Formula Y. 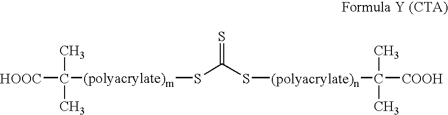
where m and n are as set forth above.

The number average molecular weight of each (polyacrylate), independently, is generally from about 1,000 to about 50,000 with from about 5,000 to about 20,000 or 25,000 being preferred.

In lieu of the (polyacrylate) in Formula Y, polymers derived from conjugated diene monomers, vinyl substituted aromatic monomers, or acrylonitrile can exist.

### EXAMPLES

The following examples serve to illustrate but not to limit the present invention.

Examples 1 through 4 generally relate to the preparation of s,s′-bis-(α,α′-disubstituted-α″-acetic acid)-trithiocarbonate and polymers thereof such as described by Formulas W and Y and to the preparation of CTA therefrom.

### Example 1

Synthesis of s,s′-bis-(α,α′-disubstituted-α″-acetic Acid)-trithiocarbonate, (R¹═R²═CH₃) 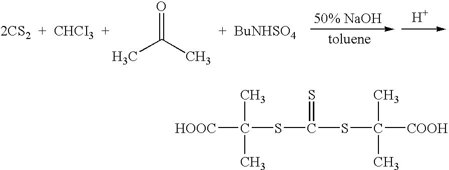
Procedure:

In a 500 ml jacketed flask equipped with a mechanical stirrer, a thermometer, a reflux condenser and an addition funnel added 22.9 grams of carbon disulfide, 2.0 gram of tetrabutylammonium bisulfate and 100 ml toluene. The solution was stirred at 20° C. under nitrogen and 168 grams of 50% sodium hydroxide solution was added dropwise to keep the temperature between 20-30° C. 30 min. after the addition, a solution of 43.6 grams of acetone and 89.6 grams of chloroform was added at 20-30° C. The reaction was then stirred at 15-20° C. overnight. 500 ml water was added to the mixture, the layers were separated. The organic layer was discarded and the aqueous layer was acidified with concentrated HCl to precipitate the product as yellow solid. 50 ml toluene was added to stir with the mixture. Filtered and rinsed the solid with toluene to collect 22.5 grams of product after drying in the air to constant weight.

### Example 2

Synthesis of s,s′-bis-(α,α′-disubstituted-α″-acetic Acid)-trithiocarbonates. (R¹═R²═CH₃)

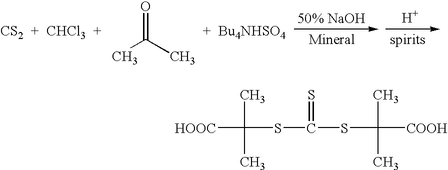

The procedure was essentially the same as in example 1, except that mineral spirits replaced toluene as solvent. 40.3 grams of product was obtained as yellow solid.

### Example 3

### Formation of CTA

Polymerization with s,s′-bis-(α,α′-disubstituted-α″-acetic Aid)-trithiocarbonates 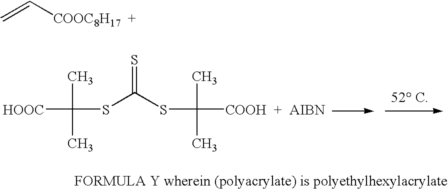
Procedure:

The novel tricarbonate (1.50 g, 5.3 mmole), 2-ethylhexylacrylate (25 g, 135.7 mmole), AIBN (0.05 g, 0.3 mmole) and acetone (25 ml) were mixed. 1 ml of undecane was added as internal standard. The reaction was stirred at 52° C. for 7 hours under nitrogen. The following table showed the conversion and the molecular weights of the resulting polymer.

| Sample | Time (mins.) | Mn | Mw | Conv. % |
|---|---|---|---|---|
| 1 | 45 | 669 | 724 | 3.5 |
| 2 | 120 | 1433 | 1590 | 25.8 |
| 3 | 240 | 3095 | 3621 | 79.8 |
| 4 | 300 | 3345 | 3898 | 87.9 |
| 5 | 420 | 3527 | 4136 | 93.9 |

The same reaction was repeated at 60° C. with similar results.

### Example 4

### Formation of CTA

Polymerization with s,s′-bis-(α,α′-disubstituted-α″-acetic Acid) Trithiocarbonates. 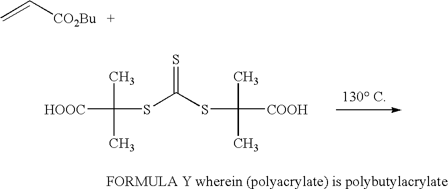
Procedure:

The trithiocarbonate was used as inifertor. Trithiocarbonate (1.0 g, 3.5 mmole), n-butylacrylate (20 g, 156.1 mmole) with 1 ml decane as internal standard were purged with nitrogen for 15 min., then polymerized at 130° C. under nitrogen for 6 hours. The following table showed the conversion and the molecular weights of the polymer.

| Sample | Time (mins.) | Mn | Mw | Conv. % |
|---|---|---|---|---|
| 1 | 60 | 1118 | 1242 | 16.0 |
| 2 | 120 | 1891 | 2199 | 32.5 |
| 3 | 240 | 2985 | 3337 | 52.5 |
| 4 | 360 | 3532 | 4066 | 65.7 |

### Preparation of Dithiocarbonates

### I. Dithiocarbonates

A further embodiment of the present invention relates to dithiocarbonate compounds, more specifically dithiocarbonates which have the general formula: 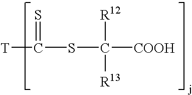
wherein j is 1 or 2, with the proviso that when j is 1, T is NR¹⁵R¹⁶); and when j is 2, T is a divalent radical having a nitrogen atom directly connected to each carbon atom of the two thiocarbonyl groups present;
wherein R¹² and R¹³, independently, is the same or different, is optionally substituted, and is a linear or branched alkyl having from 1 to about 6 or about 12 carbon atoms; or an aryl group having from 6 to about 18 carbon atoms, optionally containing heteroatoms;
wherein the R¹² and/or R¹³ substituents, independently, comprise an alkyl having from 1 to 6 carbon atoms; an aryl group; a halogen; a cyano group; an ether having a total of from 2 to about 20 carbon atoms; a nitro; or combinations thereof. R¹² and R¹³can also form or be a part of a substituted or unsubstituted cyclic ring having from 3 to about 12 total carbon atoms wherein the substituents are described above. R¹² and R¹³ are preferably, independently, methyl or phenyl groups;
wherein R¹⁵ and R¹⁶, independently, is the same or different, optionally is substituted, optionally contains heteroatoms; and is hydrogen; a linear or branched alkyl having from 1 to about 18 carbon atoms, an aryl group having from about 6 to about 18 carbon atoms optionally saturated or unsaturated; an arylalkyl having from about 7 to about 18 carbon atoms; an alkenealkyl having from 3 to about 18 carbon atoms; or derived from a polyalkylene glycol ether having from 3 to about 200 carbon atoms. R¹⁵ and R¹⁶ can also be derived from amines such as, but not limited to, piperazine, morpholine, pyrrolidine, piperidine, 4-alkyl amino-2,2,6,6-tetramethyl piperidine, 1-alkylaminoalkyl-3,3,5,5-tetramethyl-2-piperazinone, hexamethyleneimine, phenothiazine, iminodibenzyl, phenoxazine, N,N′-diphenyl-1,4-phenylenediamine, dicyclohexylamine and derivatives thereof. R¹⁵ and R¹⁶ can also form a substituted or unsubstituted cyclic ring, optionally containing heteroatoms, along with the nitrogen having a total of from 4 to about 12 carbon atoms, such as benzotriazole, tolyltriazole, imidazole, 2-oxazolidone, 4,4-dimethyloxazolidone and the like. The R¹⁵ and R¹⁶ substituents, independently, can be the same as described herein with respect to R¹⁴. R¹⁵ and R¹⁶ are preferably, independently, a phenyl group or an alkyl or substituted alkyl having from 1 to about 18 carbon atoms such as a methyl group, or R¹⁵ and R¹⁶, independently, are hexamethylene.

It is to be understood throughout the application formulas, reaction schemes, mechanisms, etc., and the specification that metals such as sodium or bases such as sodium hydroxide are referred to and the application of the present invention is not meant to be solely limited thereto. Other metals or bases such as, but not limited to, potassium and potassium hydroxide, respectively, are contemplated by the disclosure of the present invention.

When j is 1, T of above formula is ( NR¹⁵R¹⁶and the dithiocarbamate compound is a S-(α,α′-disubstituted-α″-acetic acid) dithiocarbamate generally having the following formula: 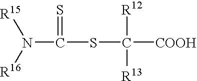
wherein R¹², R¹³, R¹⁵, and R¹⁶ are as defined hereinabove.

When j is 2, the dithiocarbamate compound is a bis-S-(α,α′-disubstituted-α″-acetic acid) dithiocarbamate having the following formula: 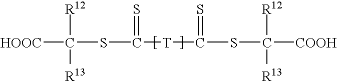
wherein R¹² and R¹³ are defined hereinabove; and
wherein T is a divalent bridging radical having a nitrogen atom directly connected to each of the thiocarbonyl groups present.

In one embodiment T is: 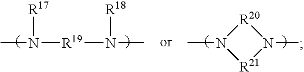
wherein R¹⁷ and R¹⁸, independently, is the same or different, is optionally substituted, and is hydrogen, a linear or branched alkyl having from 1 to about 18 carbon atoms, an aryl group having from about 6 to about 18 carbon atoms, an arylalkyl having from 7 to about 18 carbon atoms, an alkenealkyl having from 3 to about 18 carbon atoms, wherein the substitutents can be the same as described herein for R¹ and R²;
wherein R¹⁹ is optionally substituted, and is non-existent, or an alkylene group having from 1 to about 18 carbon atoms with about 1 to about 6 carbon atoms preferred, or derived from a polyalkylene glycol ether having from 3 to about 200 carbon atoms, wherein the substituents can be the same as described herein for R¹ and R² or are heteroatoms such as oxygen, nitrogen, sulfur or phosphorous; and
wherein R²⁰ and R²¹ independently, is the same or different, and is optionally substituted as described for R¹ and R², and is an alkylene group having from 1 to about 4 carbon atoms, with R²⁰ and R²¹ preferably having a collective total of 3 to 5 carbon atoms.

In further embodiments, T is: 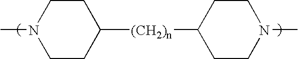
wherein n is 0 to about 18, with 0 to about 6 preferred; 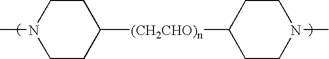
wherein n is 0 to about 18, with 0 to about 6 preferred;

Some specific non-limiting examples of T bridging radicals are: 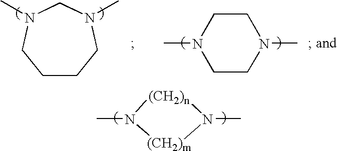
wherein n plus m=3 to 5;

The S-(α,α′-disubstituted-α″-acetic acid) or bis S-(α,α′-disubstituted-α″-acetic acid) dithiocarbamates are generally a reaction product of a metal salt of a dithiocarbamate, a haloform, and a ketone. A phase transfer catalyst, solvent, and a base such as sodium hydroxide or potassium hydroxide can also be utilized to form the S-(α,α′-disubstituted-α″-acetic acid) or bis S-(α,α′-disubstituted-α″-acetic acid) dithiocarbamates.

The metal salt of a dithiocarbamate is either prepared or purchased from a supplier such as Aldrich of Milwaukee, Wis. or Acros of Sommerville, N.J. Metal salts of dithiocarbamates are made in situ from amine, carbon disulfide, and a metal hydroxide as disclosed in the literature. Examples of metal salts of dithiocarbamates include sodium N,N-dimethyl dithiocarbamate and sodium N,N-diethyl-dithiocarbamate.

The S-(α,α′-disubstituted-α″-acetic acid) or bis S-(α,α′-disubstituted-α″-acetic acid) dithiocarbamate is formed by combining a metal salt of the dithiocarbamate with a haloform, a ketone, a base, optionally a solvent and a catalyst, in a reaction vessel preferably under an inert atmosphere. The base is preferably added to the other components over a period of time to maintain a preferred temperature range and avoid by-products. The reaction product is subsequently acidified, completing the reaction. The reaction product is isolated as a solid or liquid and is optionally purified.

The limiting agents of the reaction are usually the amine and carbon disulfide, or the metal salt of the dithiocarbamate when utilized. The haloform is utilized in the reaction in an amount from about 0 percent to about 500 percent molar excess, with about 50 percent to about 200 percent molar excess preferred. The ketone is utilized in the reaction in an amount from 0 percent to about 3000 percent molar excess, with about 100 percent to about 1000 percent molar excess preferred. The metal hydroxide when utilized, is present in an amount from 10 percent to 500 percent molar excess, with about 60 percent to 150 percent molar excess preferred.

The abbreviated reaction formula for the S-(α,α′-disubstituted-α″-acetic acid) dithiocarbamate of the present invention is generally as follows:

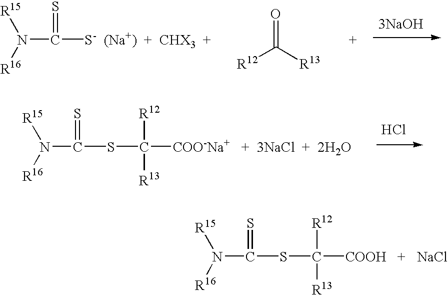

The abbreviated reaction formula for the bis S-(α,α′-disubstituted-α″-acetic acid) dithiocarbamate of the present invention is generally as follows:

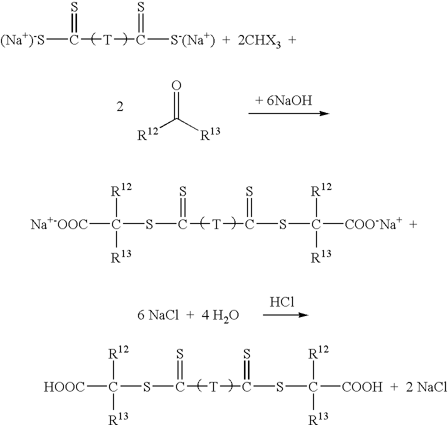

The reaction is carried out at a temperature sufficient to initiate and complete reaction of the reactants in order to produce the S-(α,α′-disubstituted-α″-acetic acid) or bis S-(α,α′-disubstituted-α″-acetic acid) dithiocarbamate compound in a desired time. The reaction can be carried out at any temperature within a wide range of from about the freezing point of the reaction mass to about the reflux temperature of the solvent. The reaction temperature is generally from about minus 15° C. to about 80° C., desirably from about 0° C. to about 50° C., and preferably from about 15° C. to about 35° C., with about 15° C. to about 25° C. being preferred. The reaction can be performed at atmospheric pressure. The reaction time depends on several factors, with the temperature being most influential. The reaction is generally complete within 20 hours and preferably within about 10 hours.

A catalyst, preferably a phase transfer catalyst, is generally utilized when the optional solvent is used in the reaction. Examples of preferable catalysts and solvents are listed hereinabove and incorporated by reference. Preferred phase transfer catalysts include tricaprylmethylammonium chloride (Aliquot 336), benzyltriethylammonium chloride, and tetrabutylammonium hydrogen sulfate. The amount of catalyst and solvents utilized in the reaction to form the S-(α,α′-disubstituted-α″-acetic acid) or bis S-(α,α′-disubstituted-α″-acetic acid) dithiocarbamate compound are generally the same as set forth above and herein incorporated by reference. When the ketone is also the solvent, the catalyst is optionally eliminated from the process.

The ketones, haloforms, bases, and acids utilized in the dithiocarbamate reaction can be the same as those listed above for the trithiocarbonate synthesis and amounts thereof are herein incorporated by reference. Alternatively, an α-trihalomethyl-α-alkanol can be utilized in place of the haloform and ketone in the amounts noted hereinabove for the trithiocarbonate synthesis.

It is believed that the reaction scheme for the formation of the S-(α,α′-disubstituted-α″-acetic acid) dithiocarbamate is as follows: 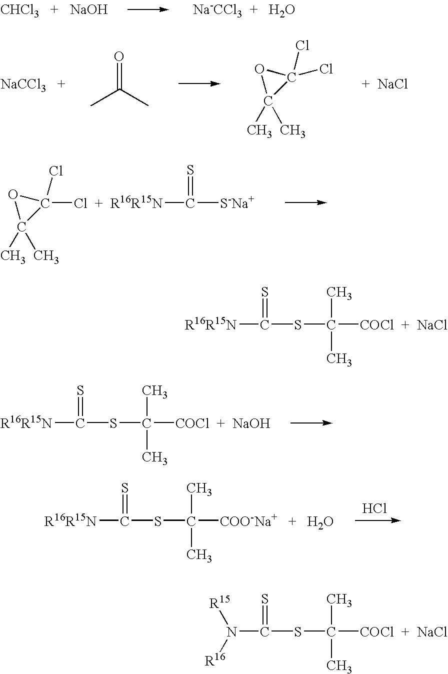
wherein R¹⁵ and R¹⁶ are defined hereinabove. The reaction scheme for the formation of the bis S-(α,α′-disubstituted-α″-acetic acid) dithiocarbonate is similar to the above reaction scheme and obvious to one of ordinary skill in the art. A phase transfer catalyst such as tetrabutylammoniumhydrogensulfate or octadecyltrimethylammoniumchloride (Aliquot 336) as mentioned above is utilized in a preferred embodiment.

The S-(α,α′-disubstituted-α″-acetic acid) or bis S-(α,α′-disubstituted-α″-acetic acid) dithiocarbamate compounds are utilized in essentially the same manner as the trithiocarbonate compounds mentioned hereinabove. That is, the S-(α,α′-disubstituted-α″-acetic acid) or bis S-(α,α′-disubstituted-α″-acetic acid) dithiocarbamate compounds in various embodiments are utilized as initiators to initiate or start the polymerization of a monomer, as a chain transfer agent which interrupts and terminates the growth of a polymer chain by formation of a new radical which can act as the nucleus for forming a new polymer chain, and/or as a terminator which are incorporated into a polymer as a dormant species. Preferably, the S-(α,α′-disubstituted-α″-acetic acid) or bis S-(α,α′-disubstituted-α″-acetic acid) dithiocarbamate compounds are utilized as chain transfer agents in free radical polymerizations having living characteristics to provide polymers of controlled molecular weight and low polydispersity.

### Dithiocarbamate (Co)Polymers (Living Polymerization)

To this end, the present invention also relates to both a process for forming polymers or copolymers derived from the dithiocarbamate compounds having the following general formulae: 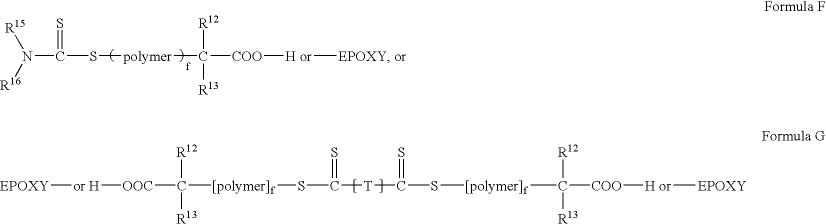
wherein R¹², R¹³, R¹⁵, R¹⁶ and T are defined hereinabove, wherein the polymer is derived from a monomer as described herein, such as but not limited to, a conjugated diene monomer, or a vinyl containing monomer, or combinations thereof, wherein each polymer repeat unit is the same or different, and wherein f is generally from 1 to about 10,000, and preferably from about 3 to about 5,000. Preferred polymers are derived from alkyl acrylate, vinyl acetate, acrylic acid, and styrene. Of course, it is to be understood that when f is 1, the polymer is a single reacted monomer unit.

The above dithiocarbamate polymers or copolymers can be prepared by bringing into contact with each other the monomer(s) which form(s) the (polymer) repeat units and the S-(α,α′-disubstituted-α″-acetic acid) or bis S-(α,α′-disubstituted-α″-acetic acid) dithiocarbamate compounds, and optionally, a) solvent and b) a radical polymerization initiator; in suitable amounts, as described herein.

It is believed the polymer forming mechanism for the S-(α,α′-disubstituted-α″-acetic acid) dithiocarbonate compound is as follows:

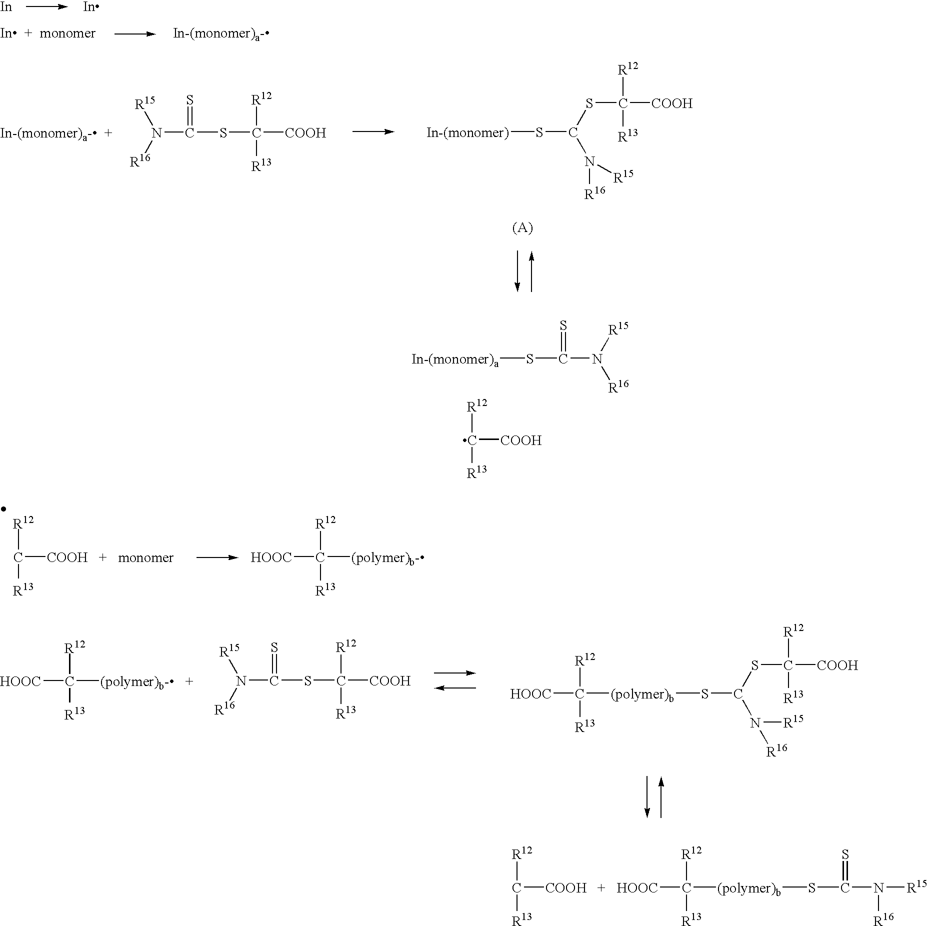

The mechanism for the bis S-(α,α′-disubstituted-α″-acetic acid) dithiocarbonate compound is similar to the above-noted mechanism and obvious to one of ordinary skill in the art.

As illustrated by the above reaction formulas, the monomers are polymerized into the dithiocarbamate compounds adjacent to the thiocarbonylthio linkage, between the single bonded sulfur atom and the tertiary carbon atom of the compound.

The dithiocarbamate compounds of the present invention are used to produce polymers which are substantially colorless. The polymers or copolymers of the dithiocarbamate compounds are hydrolytically stable because the electro-donating amino groups render the thiocarbonyl group less electrophilic. The polymers are also stable toward nucleophiles such as amines.

The reaction conditions are chosen as known to one ordinarily skilled in the art so that the temperature utilized will generate a radical in a controlled fashion with the temperature being generally from about room temperature to about 200° C. The reaction can be performed at temperatures lower than room temperature, but it is impractical to do so. The temperature often depends on the initiator chosen for the reaction, for example, when AIBN is utilized, the temperature generally is from about 40° C. to about 80° C., when azodicyanodivaleric acid is utilized, the temperature generally is from about 50° C. to about 90° C., when di-t-butylperoxide is utilized, the temperature generally is from about 110° C. to about 160° C., and when S-(α,α′-disubstituted-α″-acetic acid) or bis S-(α,α′-disubstituted-α″-acetic acid) dithiocarbamate is utilized, the temperature is generally from about 120° C. to about 200° C.

The low polydispersity polymers prepared as stated above by the free radical polymerization can contain reactive end groups from the monomers which are able to undergo further chemical transformation or reaction such as being joined with another polymer chain, such as to form copolymers for example. Therefore, any of the above listed monomers, i.e. conjugated dienes or vinyl containing monomers, are utilized to form copolymers utilizing the S-(α,α′-disubstituted-α″-acetic acid) or bis S-(α,α′-disubstituted-α″-acetic acid) dithiocarbamate compounds as chain transfer agent. Moreover, in one embodiment the polymers are crosslinked using a crosslinker during polymerization. Suitable crosslinkers include, but are not limited to, polyallyl pentaerythritol, polyallyl sucrose, trimethylol propane diacrylate, trimethylol propane triacrylate, glycerol triacrylate, methylene bis-acrylamide and ethylene-glycol diacrylate. Alternatively, the substituents may be non-reactive such as alkoxy, alkyl, or aryl. Reactive groups should be chosen such that there is no adverse reaction with the chain transfer agents under the conditions of the experiment.

The process of this invention is carried out in emulsion, solution or suspension in either a batch, semi-batch, continuous, or feed mode. Bulk polymerization (no solvent) is also achieved because propagation is slower. Otherwise-conventional procedures can be used to produce narrow polydispersity polymers. For lowest polydispersity polymers, the chain transfer agent is added before polymerization is commenced. The polydispersity of polymers or copolymers produced from the dithiocarbamates is generally less than about 3.0. For example, when carried out in batch mode in solution, the reactor is typically charged with chain transfer agent and monomer or medium plus monomer. The desired amount of initiator is then added to the mixture and the mixture is heated for a time which is dictated by the desired conversion and molecular weight. Polymers with broad, yet controlled, polydispersity or with multimodal molecular weight distribution can be produced by controlled addition of the chain transfer agent over the course of the polymerization process.

In the case of emulsion or suspension polymerization the medium will often be predominately water and the conventional stabilizers, dispersants and other additives can be present. For solution polymerization, the reaction medium can be chosen from a wide range of media to suit the monomer(s) being used.

As already stated, the use of feed polymerization conditions allows the use of chain transfer agents with lower transfer constants and allows the synthesis of block polymers that are not readily achieved using batch polymerization processes. If the polymerization is carried out as a feed system the reaction can be carried out as follows. The reactor is charged with the chosen medium, the chain transfer agent and optionally a portion of the monomer(s). The remaining monomer(s) is placed into a separate vessel. Initiator is dissolved or suspended in the reaction medium in still another separate vessel. The medium in the reactor is heated and stirred while the monomer+medium and initiator+medium are introduced over time, for example by a syringe pump or other pumping device. The rate and duration of feed is determined largely by the quantity of solution the desired monomer/chain transfer agent/initiator ratio and the rate of the polymerization. When the feed is complete, heating can be continued for an additional period.

Following completion of the polymerization, the polymer can be isolated by stripping off the medium and unreacted monomer(s) or by precipitation with a non-solvent. Alternatively, the polymer solution/emulsion can be used as such, if appropriate to its application. The applications for the S-(α,α′-disubstituted-α″-acetic acid) dithiocarbamate compounds include any of those listed hereinabove with regard to the trithiocarbonate compounds.

Derivatives of the dithiocarbamate polymers or copolymers can also be formed including esterification products from the alcohol and/or diol end groups present. Thioesters can be formed utilizing mercaptan, and amides can be formed from amines, etc. Ammonium salts can be formed from primary, secondary, and tertiary amines. Metal salts can be formed from alkaline or alkaline earth hydroxides, oxides and the like.

The invention has wide applicability in the field of free radical polymerization and can be used to produce polymers and compositions for coatings, including clear coats and base coat finishes for paints for automobiles and other vehicles or industrial, architectural or maintenance finishes for a wide variety of substrates. Such coatings can further include conventional additives such as pigments, durability agents, corrosion and oxidation inhibitors, rheology control agents, metallic flakes and other additives. Block, star, and branched polymers can be used as compatibilizers, thermoplastic elastomers, dispersing agents or rheology control agents. Additional applications for polymers of the invention are in the fields of imaging, electronics (e.g., photoresists), engineering plastics, adhesives, sealants, paper coatings and treatments, textile coatings and treatments, inks and overprint varnishes, and polymers in general.

### II. Alkoxy Dithiocarbonates

Yet another embodiment of the present invention relates to alkoxy dithiocarbonate compounds having the following formulae: 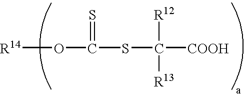
wherein R¹² and R¹³ are as defined hereinabove;

wherein R¹⁴ is optionally substituted, and can be a linear or branched alkyl having from 1 to about 12 carbon atoms; an aryl group, optionally saturated or unsaturated; an arylalkyl having from 7 to about 18 carbon atoms; an acyl group; an alkenealkyl having from 3 to about 18 carbon atoms; an alkene group; an alkylene group; an alkoxyalkyl; derived from a polyalkylene glycol; derived from a polyalkylene glycol monoalkyl ether having from 3 to 200 carbon atoms; derived from a polyalkylene glycol monoaryl ether having from 3 to 200 carbon atoms; a polyfluoroalkyl such as 2-trifluoroethyl; a phosphorous containing alkyl; or a substituted or unsubstituted aryl ring containing heteroatoms. Alkyl and alkylene groups from 1 to 6 carbon atoms are preferred;

wherein the R¹⁴ substituents comprise an alkyl having from 1 to 6 carbon atoms; an aryl; a halogen such as fluorine or chlorine; a cyano group; an amino group; an alkene group; an alkoxycarbonyl group; an aryloxycarbonyl group; a carboxy group; an acyloxy group; a carbamoyl group; an alkylcarbonyl group; an alkylarylcarbonyl group; an arylcarbonyl group; an arylalkylcarbonyl group; a phthalimido group; a maleimido group; a succinimido group; amidino group; guanidimo group; allyl group; epoxy group; alkoxy group; an alkali metal salt; a cationic substitutent such as a quaternary ammonium salt; a hydroxyl group; an ether having a total of from 2 to about 20 carbon atoms such as methoxy, or hexanoxy; a nitro; sulfur; phosphorous; a carboalkoxy group; a heterocyclic group containing one or more sulfur, oxygen or nitrogen atoms, or combinations thereof; and wherein “a” is 1 to about 4 with 1 or 2 preferred.

The compounds of the above formula are generally identified as O-alkyl-S-(α,α′-disubstituted-α″-acetic acid) xanthates. The O-alkyl-S-(α,α′-disubstituted-α″-acetic acid) xanthates are generated as the reaction product of an alkoxylate salt, carbon disulfide, a haloform, and a ketone. Alternatively, a metal salt of xanthate can be utilized in place of the alkoxylate salt and carbon disulfide.

The alkoxylate salt or carbon disulfide, or alternatively the metal salt of xanthate are typically the limiting agents for the reaction. The haloform is utilized in the reaction in an amount generally from 0 percent to about 500 percent molar excess, and preferably from about 50 to about 200 percent molar excess. The ketone is utilized in the reaction in an amount generally from 0 percent to about 3000 percent molar excess, and preferably from about 100 percent to about 1000 percent molar excess. The metal hydroxide when utilized, is present in an amount from 10 percent to 500 percent molar excess, with about 60 percent to 150 percent molar excess preferred.

The general reaction mechanism for forming the O-alkyl-S-(α,α′-disubstituted-α″-acetic acid) xanthates is as follows:

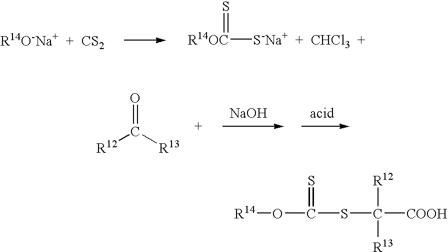

The preparation of the O-alkyl-S-(α,α′-disubstituted-α″-acetic acid) xanthates begins with the addition of a xanthate, i.e., a salt of xanthic acid to a reaction vessel, preferably equipped with an agitating device, thermometer, addition funnel, and a condenser. The xanthate can be prepared from an alkoxylate salt and carbon disulfide as known in the art.

For example, the sodium salt of O-ethyl xanthate, CH₃CH₂OC(S)S⁻Na⁺, can be prepared from sodium ethoxide and carbon disulfide in the presence of a solvent such as an acetone, and optionally a catalyst, such as Aliquot 336 or other catalyst stated herein or known in the art, in a reaction vessel, preferably at about 0° to about 25° C. The general reaction is: 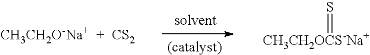
The metal salt of O-ethyl xanthate is also commercially available from sources such as Aldrich Chemical of Milwaukee, Wis.

In a further step, a ketone, a haloform, optionally a solvent, and a catalyst, all as described hereinabove, are added to the reaction vessel containing the xanthate metal salt. When the ketone is used as the solvent, the catalyst is optionally eliminated from the process. A strong base as noted hereinabove is added to the mixture, preferably over an extended period of time. The reaction components are preferably mixed throughout the reaction. The reaction product is subsequently acidified with an acid as noted hereinabove, completing the reaction and forming the O-alkyl-S-(α,α′-disubstituted-α″-acetic acid) xanthate. The reaction is conducted at a temperature generally from about 0° C. to about 80° C., and preferably from about 15° C. to about 50° C., with room temperature being preferred. The reaction can be performed at atmospheric pressure under an inert atmosphere. The reaction time generally depends on temperature, and generally is complete within 20 hours, and preferably within 10 hours. An α-trihalomethyl-α-alkanol can be utilized in place of a haloform and ketone, as noted hereinabove with regard to the trithiocarbonate compounds.

The O-alkyl-S-(α,α′-disubstituted-α″-acetic acid) xanthates can be utilized as an initiator to initiate or start the polymerization of a monomer, as a chain transfer agent which interrupts and terminates the growth of a polymer chain by formation of a new radical which can act as the nucleus for forming a new polymer chain, and/or as a terminator which are incorporated into a polymer as a dormant species. Preferably, the O-alkyl-S-(α,α′-disubstituted-α″-acetic acid) xanthates are utilized as chain transfer agents in free radical polymerizations having living characteristics to provide polymers of controlled molecular weight and low polydispersity.

### Xanthate (Co)Polymers (Living Copolymers)

Polymers or copolymers of the following formulas can be prepared from the O-alkyl-S-(α,α′-disubstituted-α″-acetic acid) xanthates: 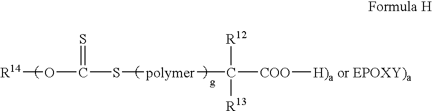
wherein a, R¹², R¹³, and R¹⁴ are as defined hereinabove, wherein the polymer is derived from a conjugated diene monomer, or a vinyl containing monomer, or combinations thereof, as defined hereinabove and incorporated by reference, and wherein each g repeat unit, independently, is the same or different and is generally from 1 to about 10,000, and preferably from about 5 to about 500. Preferred monomers are alkyl acrylates, acrylic acid, and styrene. Of course, it is to be understood that when g is 1, the polymer is a single reacted monomer unit.

The above polymers or copolymers can be prepared by bringing into contact with each other the monomer(s) which form O-alkyl-S-(α,α′-disubstituted-α″-acetic acid) xanthate compound, and optionally a) solvent, and b) a radical polymerization initiator; in suitable amounts, as described hereinabove.

It is believed the mechanism is as follows:

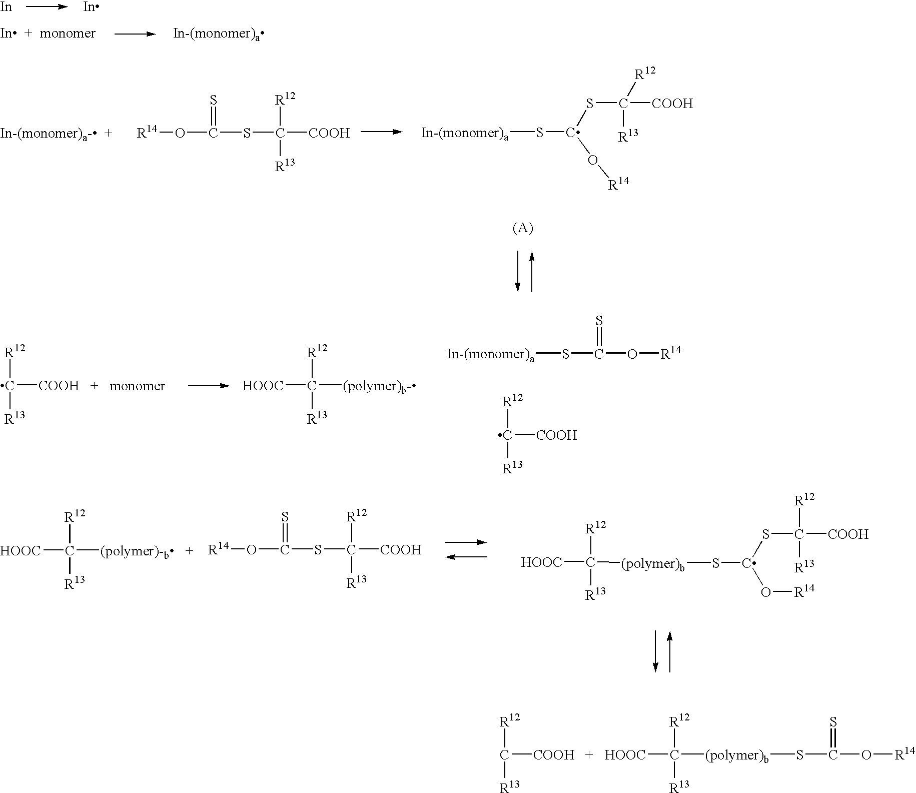

As illustrated by the above mechanism, the monomers are polymerized into the xanthate compounds adjacent to the thiocarbonylthio linkage, between the single bonded sulfur atom and the tertiary carbon atom of the compound.

The O-alkyl dithiocarbonate compounds of the present invention can be used to produce polymers which are substantially colorless. The polymers or copolymers of the O-alkyl dithiocarbanate compounds are more hydrolytically stable because the electro-donating amino groups render the thiocarbonyl group less electrophilic and the polymers are stable toward nucleophiles such as amines.

The reaction conditions are chosen as known to one skilled in the art so that the temperature utilized will generate a radical in a controlled fashion, wherein the temperature is generally from about room temperature to about 200° C. The reaction can be performed at temperatures lower than room temperature, but it is impractical to do so. The temperature often depends on the initiator chosen for the reaction, for example, when AIBN is utilized, the temperature generally is from about 40° C. to about 80° C., when azodicyanodivaleric acid is utilized, the temperature generally is from about 50° C. to about 90° C., when di-t-butylperoxide is utilized, the temperature generally is from about 110° C. to about 160° C., and when O-alkyl-S-(α,α′-disubstituted-α″-acetic acid) xanthate is utilized, the temperature is generally from about 80° C. to about 200° C.

As noted above with respect to the dithiocarbamate compounds, the polymers or copolymers prepared from the O-alkyl-S-(α,α′-disubstituted-α″-acetic acid) xanthate contain reactive end groups which are able to further undergo chemical transformation or reaction in order to be joined with another polymer chain, in order to form extended copolymers for example. The process of the invention can be carried out, for example, in emulsion solution or suspension in either a batch, semi-batch, continuous, bulk or feed mode.

Conventional procedures can be used to produce narrow polydispersity polymers. For lowest polydispersity polymers, the chain transfer agent is added before polymerization is commenced. The polydispersity of the xanthate polymers or copolymers is generally less than about 3.0. For example, when carried out in batch mode in solution, the reactor is typically charged with chain transfer agent and monomer or medium plus monomer. The desired amount of initiator is then added to the mixture and the mixture is heated for a time which is dictated by the desired conversion and molecular weight. Polymers with broad, yet controlled, polydispersity or with multimodal molecular weight distribution can be produced by controlled addition of the chain transfer agent over the course of the polymerization process.

In the case of emulsion or suspension polymerization the medium will often be predominately water and the conventional stabilizers, dispersants and other additives can be present. For solution polymerization, the reaction medium can be chosen from a wide range of media to suit the monomer(s) being used.

As already stated, the use of feed polymerization conditions allows the use of chain transfer agents with lower transfer constants and allows the synthesis of block polymers that are not readily achieved using batch polymerization processes. If the polymerization is carried out as a feed system the reaction can be carried out as follows. The reactor is charged with the chosen medium, the chain transfer agent and optionally a portion of the monomer(s). The remaining monomer(s) is placed into a separate vessel. Initiator is dissolved or suspended in the reaction medium in another separate vessel. The medium in the reactor is heated and stirred while the monomer+medium and initiator+medium are introduced over time, for example by a syringe pump or other pumping device. The rate and duration of feed is determined largely by the quantity of solution the desired monomer/chain transfer agent/initiator ratio and the rate of the polymerization. When the feed is complete, heating can be continued for an additional period.

Following completion of the polymerization, the polymer can be isolated by stripping off the medium and unreacted monomer(s) or by precipitation with a non-solvent. Alternatively, the polymer solution/emulsion can be used as such, if appropriate to its application. The applications for the O-alkyl-S-(α,α′-disubstituted-α″-acetic acid) xanthate dithiocarbonate compounds include any of those listed hereinabove with regard to the trithiocarbonate and dithiocarbamate compounds.

The dithiocarbonate compounds of the invention have wide applicability in the field of free radical polymerization and can be used as thickeners and to produce polymers and compositions for coatings, including clear coats and base coat finishes for paints for automobiles and other vehicles or industrial, architectural or maintenance finishes for a wide variety of substrates. Such coatings can further include pigments, durability agents, corrosion and oxidation inhibitors, rheology control agents, metallic flakes and other additives. Block and star, and branched polymers can be used as compatibilizers, thermoplastic elastomers, dispersing agents or rheology control agents. Additional applications for polymers of the invention are composites, potting resins, foams, laminate, in the fields of imaging, electronics (e.g., photoresists), engineering plastics, adhesives, sealants, paper coatings and treatments, textile coatings and treatments, inks and overprint varnishes, and polymers in general, and the like.

The present invention will be better understood by reference to the following examples which serve to illustrate, but not to limit, the preparation of dithio initiators and polymers therefrom.

### EXAMPLES

### Example 5

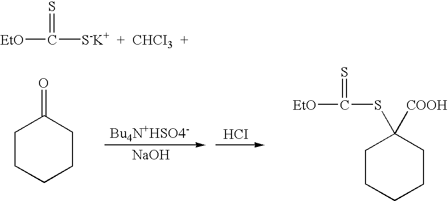 Procedure:

In a 300 ml jacketed flask equipped with a mechanical stirrer, thermometer, addition funnel and nitrogen-inlet tube (for inerting) 16.3 grams potassium O-ethylxanthate, 17.9 grams chloroform, 1.36 grams tetrabutylammonium hydrogen sulfate and 88.1 grams cyclohexanone were placed and cooled to between 15-20° C. 40 grams of sodium hydroxide beads were added in portions to keep the temperature below 25° C. After the addition, the reaction was stirred at about 20° C. for 12 hours. 100 ml of water was added and the aqueous layers were acidified with concentrated hydrochloric acid. 100 ml toluene was added to extract the product. After drying the toluene solution with magnesium sulfate, it was filtered and concentrated to afford 20 grams of yellow solid which was further purified by recrystallizing from hexanes.

### Example 6

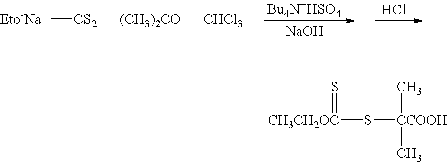

In this example, sodium O-ethylxanthate was formed in situ. 7.6 grams carbon disulfide, 1 gram tetrabutylammonium hydrogen sulfate and 58.1 grams acetone were stirred in a reaction vessel as equipped above in Example 5. 7.1 grams sodium ethoxide (96%, Aldrich) was added in portions at room temperature. 30 minutes after the addition, 17.9 grams chloroform was added followed by 20 grams sodium hydroxide beads in portions to keep the temperature below 25° C. Stirred at 15° C. for 12 hours. The mixture was filtered and rinsed thoroughly with acetone. The acetone solution was concentrated and dissolved in water. 20 ml concentrated HCl was added. The oil formed was extracted into two 50 ml portions of toluene, dried over magnesium sulfate, and concentrated into an oil. The oil was extracted with two 50 ml portions of boiling hexane. Beige-colored solid was produced from the solution.

### Example 7

Synthesis of S-(methyl, Methyl, Acetic Acid) Dithiocarbamate 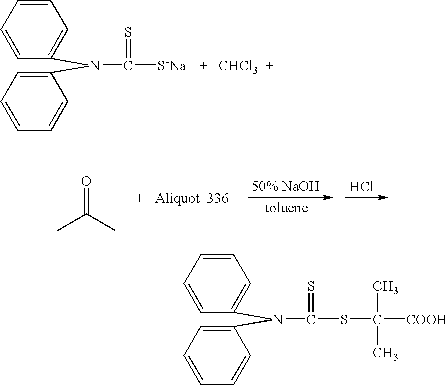
Procedure:

10.7 grams sodium N,N-diphenyldithiocarbamate, 7.2 grams chloroform, 4.6 grams acetone, 0.8 gram Aliquot 336 and 50 ml toluene were stirred at 15-20° C. under nitrogen while 16 grams 50% sodium hydroxide was added dropwise to keep the reaction temperature below 20° C. The reaction was stirred for 12 hours. Water was added to dissolve the solid. The layers were separated and the aqueous layer was acidified with concentrated hydrochloric acid. The solid was washed with water and recrystallized from toluene to afford light-yellow colored solid.

### Example 8

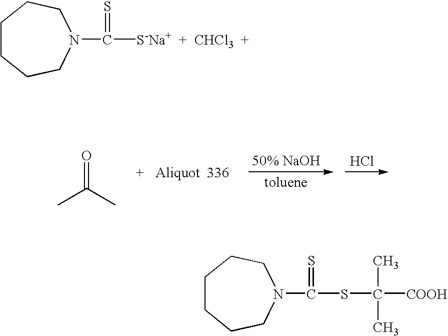 Procedure:

Sodium N,N-diphenyldithiocarbamate was replaced by sodium N,N-hexamethylenedithiocarbamate and the reaction was conducted as explained in Example 7. The product was a white solid.

### Example 9

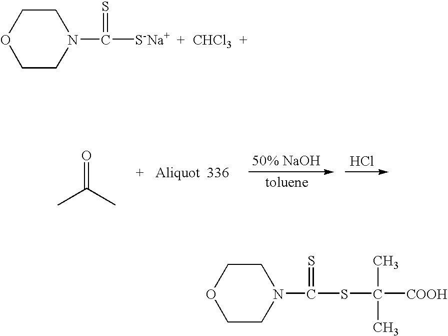 Procedure:

The sodium dithiocarbamate utilized in this example was sodium morpholinodithiocarbamate. The reaction was conducted as explained in Example 7. The product was afforded in good yield as white powders.

### Example 10

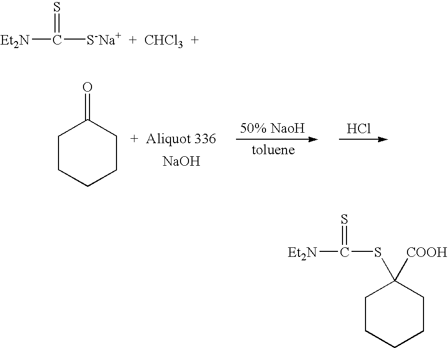 Procedure:

The sodium dithiocarbamate utilized in this example was sodium N,N-diethyl dithiocarbamate. The reaction was conducted as explained in Example 7 and acetone was replaced by cyclohexanone. The product was afforded in good yield as white powders.

### Example 11

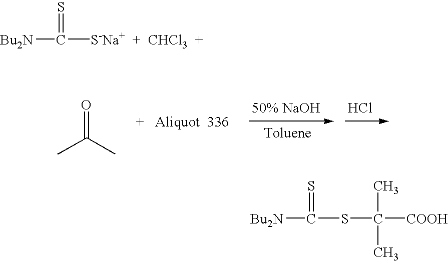 Procedure:

Sodium N,N-dibutyldithiocarbamate was utilized in this example. The reaction was conducted as described in Example 7. The product was isolated as white powder.

### Example 12

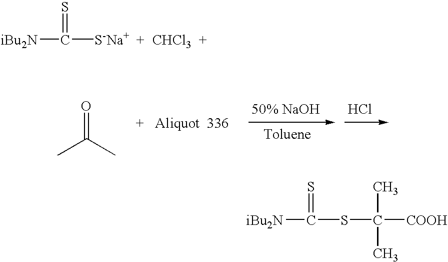 Procedure:

Sodium N,N-di-isobutyldithiocarbamate was utilized in this example. The reaction was conducted as described in Example 7. The product was isolated as yellow solid.

### Example 13

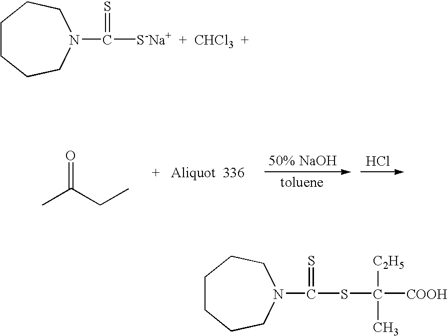 Procedure:

Sodium N,N-hexamethylene dithiocarbamate, 2-butanone was utilized in this example. The reaction was conducted as explained in Example 7 and was replaced by acetone. The product was afforded in good yield as white powder after recrystallization from hexane/toluene.

### Example 14

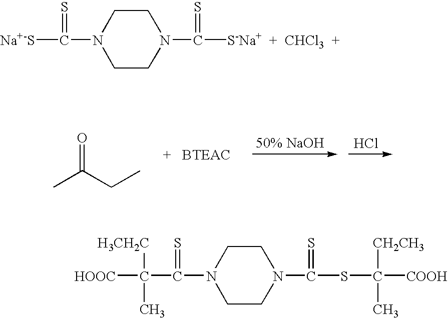 Procedure:

14.1 grams of S,S′-disodium salt of the piperazine bis-(dithiocarbamic acid), 100 ml 2-butanone, 17.9 grams chloroform and 1.13 grams benzyltriethylammonium chloride were mixed and stirred at 15-20° C. under nitrogen atmosphere. 40 grams 50% sodium hydroxide solution was added in portions to keep the reaction temperature under 20° C. After the addition, the reaction was allowed to stir at 20° C. for 12 hours. The mixture was filtered and the solid was rinsed with 2-butanone and then stirred with 100 ml water. Concentrated HCl was added until water turned acidic. The solid was collected and rinsed with water, to yield off-white colored powders. The powder was crystallized with methanol to afford white powder.

### Example 15

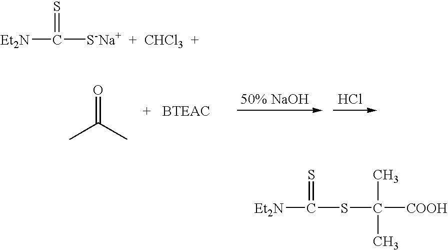

As in the above procedure of Example 14 the disodium salt of piperizine bis-(dithiocarbamic acid) was replaced with sodium diethyldithiocarbamate, and 2-butanone with acetone. The desired product was obtained as white powders in high yield.

### Example 16

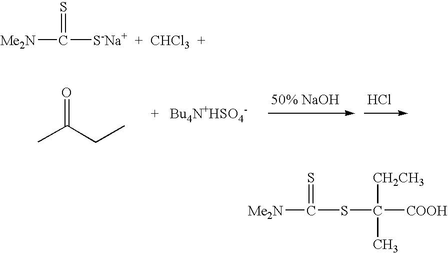

The procedure of Example 14 was utilized and the disodium salts of piperizine bis-(dithiocarbamic acid) was replaced by sodium dimethyldithiocarbamate, and BTEAC was replaced by tetrabutylammonium hydrogensulfate, the desired product was obtained as white powders.

### Example 17

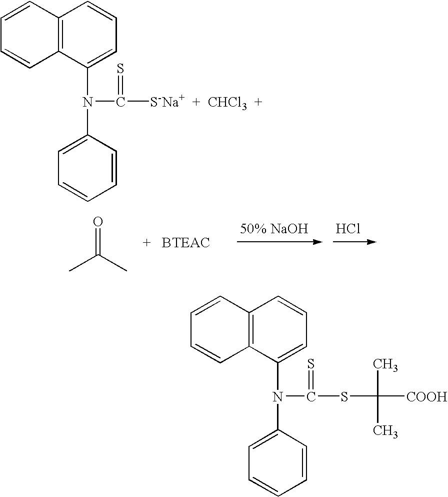

The reaction was performed as in Example 14, but the dithiocarbamate salt was sodium N-phenyl-N-1-naphthyl dithiocarbamate, and the ketone was acetone. The product was obtained as beige-colored powders after recrystallization from a mixture of toluene and heptane.

### Example 18

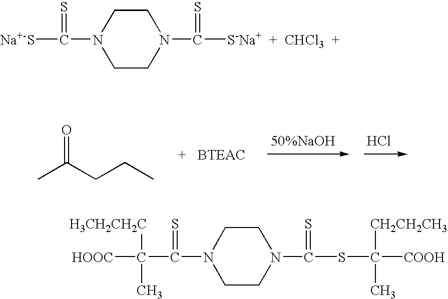

The reaction was performed in a similar manner as in Example 14, but 2-butanone was replaced by 2-pentanone, the product was white powders after recrystallization from hexanes.

### Example 19

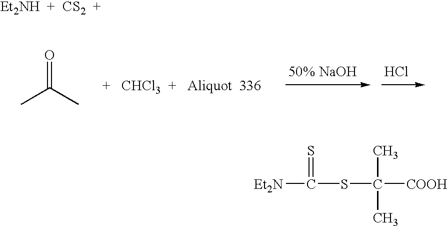 Procedure:

7.38 grams diethylamine and 80 ml acetone and 2.0 grams Aliquot 336 were mixed and stirred under nitrogen atmosphere at 15° C. 7.6 grams carbon disulfide in 20 ml acetone was added dropwise to keep the temperature below 20° C. 30 minutes after the addition, 8.8 grams 50% sodium hydroxide was added. 30 minutes later, 17.9 grams chloroform was added followed by 31.2 grams 50% sodium hydroxide. The reaction was allowed to stir at 15-20° C. for 12 hours. The mixture was concentrated and then dissolved in water. 15 ml concentrated HCl was added to precipitate a beige-colored solid which was washed thoroughly with water (20 grams). Recrystallization from toluene afforded white solid.

### Example 20

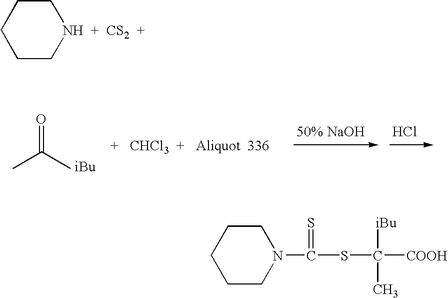 Procedure:

The diethylamine of the procedure of Example 19 was replaced by hexamethyleneimine and acetone was replaced by methyl isobutyl ketone. The product was recrystallized from hexane/toluene to afford white powders.

### Example 21

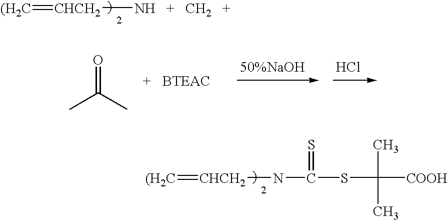

The diethylamine of the procedure of Example 19 was replaced by diallylamine and Aliquot® 336 was replaced by BTEAC. The product was white crystalline solid after recrystallization from hexane/toluene.

### Example 22

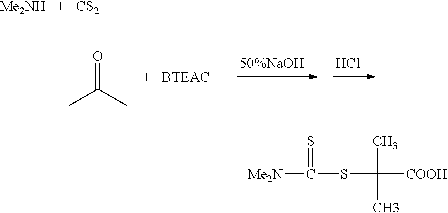

The diethylamine of the procedure of Example 19 was replaced by dimethyl-amine (40% in water). The product was white crystals after recrystallization from toluene.

### Example 23

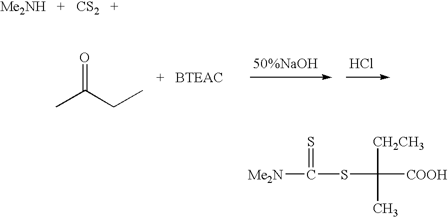

The acetone of the procedure of Example 20 was replaced by 2-butanone. The produce was a white solid after recrystallization from toluene.

### Example 24

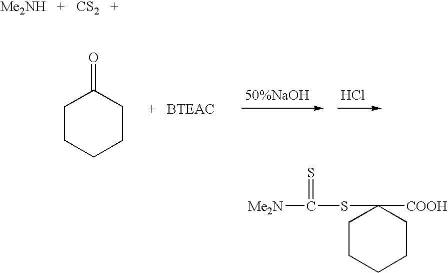

The acetone of the procedure of Example 19 was replaced by cyclohexanone. The product was white solid after recrystallization from toluene.

### Example 25

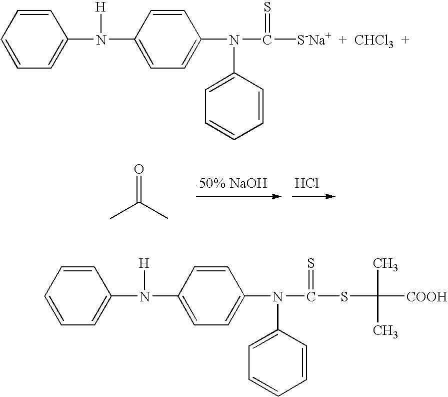

In this example, 22.8 grams of sodium N-phenyl-N-4-aminophenyl dithiocarbamate, 17.9 grams chloroform and 100 ml acetone were mixed and stirred at 15° C. under nitrogen. 40 grams 50% sodium hydroxide was added dropwise in to keep the temperature under 20° C. The reaction was allowed to stir overnight (approximately 12 hours) at 15° C. Solvent was removed in a rotary evaporator and the residue was dissolved in water. The aqueous solution was acidified with concentrated hydrochloric acid to collect a green-colored solid. The dried solid was recrystallized from toluene to afford grayish-colored solid. The structure was confirmed by H-NMR.

### Example 26

### Controlled Radical Polymerization with Novel Dithiocarbonate Derivatives

The theoretical number-averaged molecular (Mn)ₜₕₑₒ weight for each polymer or copolymer was calculated from the formula XII (a) assuming 100% conversion.

(Mn)ₑₓ is the Mn measured by GPC from polymerization products. In bulk polymerization, 20-25 grams of monomer, 0.01-0.05 grams of an initiator such as AIBN and the amount of the dithiocarbonate as needed to give desired Mn (calculated using formula XII(a)) are purged with nitrogen gas, then heated to temperature gradually. Sometimes air or water-cooling is necessary to keep the temperature under 83° C. The resulting polymers were subjected to MALDI mass spectrum measurement. The spectrum clearly showed the carboxyl-terminating group in every polymer chain.

Block copolymerization was performed by making the first polymer in bulk, then add the second monomer and same amount of initiator, then polymerizing in the same manner. Random copolymerization could have been performed if both monomers were added at the same time.

The results of the polymerizations and block polymerizations are listed in the following table.

Dithiocarbonate Polymers

| Dithiocarbonate | | | | | | | Time/ |
|---|---|---|---|---|---|---|---|
| Example | Monomer | Solvent | Temp. | (Mn)ₑₓ | (Mn)ₜₕₑₒ | PD | Hour |
| Control | Butyl acrylate | — | | >100,000 | | >3 | 1 |
| 12 | Butyl acrylate | MEK | 80 | 3777 | 5000 | 1.78 | 5 |
| 26 | Styrene | None-bulk polym. | 140 | 7830 | 5000 | 2.05 | 5 |
| 17 | Butyl acrylate | MEK | 80 | 1645 | 2000 | 2.07 | 5 |
| 14 | Butyl acrylate | MEK | 75 | 4656 | 5000 | 1.31 | 5 |
| 21 | Butyl acrylate | MEK | 80 | 3049 | 3000 | 1.32 | 6 |
| 19 | Butyl acrylate | MEK | 80 | 3683 | 3000 | 2.03 | 6 |
| 13 | Ethyl acrylate | None-bulk polym. | 65 | 5564 | 10000 | 1.83 | 5 |
| 29 | Vinyl acetate | None-bulk polym. | 70 | 4367 | 5000 | 1.47 | 5 |
| 15 | t-butylacrylamide | THF | 70 | 3622 | 5000 | 1.91 | 5 |
| 24 | Butyl acrylate | None-bulk polym. | 80 | 5093 | 5000 | 1.36 | 6.5 |
| 32 | Butyl acrylate | MEK | 80 | 2061 | 5000 | 1.61 | 2.5 |

Block Copolymers

| Dithiocarbonate | | | | | | | | |
|---|---|---|---|---|---|---|---|---|
| Example | Monomer-1 | (Mn)ₑₓ | (Mn)ₜₕₑₒ | PD | Monomer-2 | (Mn)ₑₓ | (Mn)ₜₕₑₒ | PD |
| 30 | Butyl acrylate | 1695 | 1798 | 1.92 | Vinyl acetate | 1873 | 2540 | 1.87 |
| 31 | Butyl acrylate | 1631 | 1798 | 2.23 | Vinyl acetate | 2014 | 2444 | 1.96 |

### Epoxidized Polymers

The polymers set forth hereinabove, whether they are derived from a trithiocarbonate initiator or a dithiocarbonate initiator, have carboxyl end groups and accordingly are referred to as carboxyl terminated polymers (CTP) or when the polymer is an acrylate, carboxyl terminated acrylates (CTA). Generally when derived from a trithiocarbonate initiator, the molecular weight distribution or polydispersity is from about 1.0 to about 1.29, typically about 1.1, whereas the polydispersity of a polymer derived from a dithiocarbonate initiator is generally from about 1.3 to about 2.2 and desirably from about 1.6 to about 1.8. The above carboxylic acid terminated polymers as set forth in Formulas W, Y, XXIV, XXXIII, F, G and H can be reacted with various epoxy compounds set forth hereinbelow to form polymers containing an epoxy end group. Such polymers are generally referred to as epoxy terminated polymers, i.e. ETP, and when the internal polymer is an acrylate, they are referred to as an epoxy terminated acrylate, i.e. ETA. Such ETP or ETA polymers can be utilized as effective tougheners in various base polymer systems to toughen the same. The amount of such tougheners is generally small but nevertheless impart the improved properties to the base polymers.

While the following description relates the addition of epoxy end groups to a polyacrylate as set forth in Formulas W and Y, it is to be understood that similar reaction conditions exist for polymers such as in Formulas F, G and H derived from dithio initiators as well as to polymers containing repeat groups derived from vinyl substituted aromatic monomers, from conjugated diene monomers, and from acrylonitrile monomers. Accordingly, these various monomers can be polymerized in the presence of a solvent. The utilization of a specific catalyst will induce epoxy termination of the acrylate, etc., polymer. Metal salts are generally utilized as catalysts, such as zinc chloride, zinc acetate, and other Lewis acids; or various phosphonium salts such as, tetrabutylphosphonium bromide, or a phosphine such as triphenylphosphine, which is preferred. Reaction temperatures can vary from about 25° C. to about 150° C., desirably from about 50° C. to about 130° C., with from about 80° C. to about 110° C. being preferred. The amount of the various catalysts is generally from about 0.001 to about 5 and desirably from about 0.005 to about 1 parts by weight for every 100 parts by weight of said carboxyl-terminated polymers. U.S. Pat. No. 4,530,962 is also hereby fully incorporated by reference with regard to reaction conditions for adding terminal epoxy groups to compounds of Formulas W and Y, as well as to Formulas F, G, and H (internal parenthesis), such as when containing internal polyacrylates.

The carboxyl or epoxy terminated Trithiocarbonate polymer toughener is generally described by Formula Z 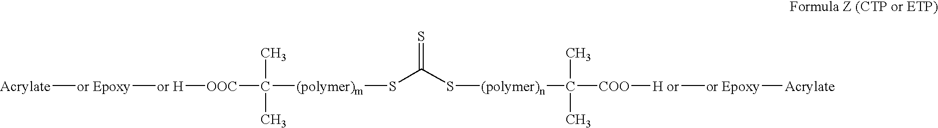
wherein m and n are as set forth above, and
wherein EPOXY is derived from an epoxy resin and generally has from about 1 to about 3 repeats units, desirably 3 repeat units or less, and preferably about 1 to about 2 units, with slightly more than a single epoxy group being highly preferred. That is, a plurality of polymers of Formula Z will exist wherein a majority of the polymer ends are terminated by a single epoxy group with some polymers being terminated with two or three epoxy groups. The average number of the epoxy groups is greater than one such as from about 1.1 to about 1.3 or about 1.4. The same is true with respect to Formulas F, G, and H (external parenthesis).

When forming the epoxy terminated polymers, such as ETP or ETA, a large mole excess of epoxy equivalents to carboxyl equivalents is employed, typically greater than 10 to 1, so that the equivalent amount of epoxy reacted is only from about 0.2% to about 20% and preferably from about 0.5% to about 5% of the total amount of the epoxy equivalents available for reaction with the carboxyl terminated polymer, i.e. CTP or CTA. In other words, essentially an epoxy resin system is formed wherein a minor amount thereof is the toughener, i.e. an epoxy terminate polymer, ETP or ETA.

If desired, the carboxyl groups of carboxyl end-functional polyacrylates, CTA, can be converted to many other functional groups such as vinyl, amine, primary and secondary hydroxyl by reacting the carboxyl groups with glycidyl methacrylate, poly-functional amines and ethylene or mono-functional epoxies.

The epoxy resins which are used to modify the CTP polymers, such as those set forth in Formulas W, XXIV, XXXIII, and Y, and also F, G, and H (internal parenthesis), in order to add epoxy end groups thereto are commercially available and known to the art and to the literature. Desirable epoxy resins include polyhydric phenol polyether alcohols; glycidyl ethers of novolac resins such as epoxylated phenol-formaldehyde novolac resin; glycidyl ethers of mononuclear di- and trihydric phenols; glycidyl ethers of bisphenols such as diglycidyl ether of tetrabromobisphenol A; glycidyl ethers of polynuclear phenols; epoxy resin from diphenolic acid; glycidyl ethers of aliphatic polyols such as bromine or chlorine-containing aliphatic diepoxy and polyepichlorohydrin; glycidyl esters such as epoxidized phenolphthalein or aliphatic diacid glycidyl esters or glycidyl acrylates having from 1 to 10 carbon atoms in the ester portion such as glycidyl methacrylate; glycidyl epoxies containing nitrogen such as glycidyl amides and amide-containing epoxies; glycidyl derivatives of cyanuric acid; glycidyl resins from melamines; glycidyl amines such as triglycidyl ether amine of p-aminophenol and bis(2,3-epoxypropyl)methylpropylammonium p-toluenesulfonate; and glycidyl triazines; thioglycidyl resins such as epoxidized bisulfide; silicon-glycidyl resins such as 1,4-bis[(2,3-epoxypropoxy)dimethylsilyl]; fluorine glycidyl resins; epoxy resins which are synthesized from monoepoxies other than epihalohydrins including epoxy resins from unsaturated monoepoxies such as polyallyl glycidyl ether and glycidyl sorbate dimer; epoxy resins from monoepoxy alcohols; epoxy resins from monoepoxies by ester interchange; epoxy resins from glycidaldehyde; polyglycidyl compounds containing unsaturation such as allyl-substituted diglycidyl ether of bisphenol A; epoxy resins which are synthesized from olefins and chloroacetyls such as butadiene dioxide, vinylcyclohexene dioxide, epoxidized polybutadiene, and bis(2,3-epoxy-cyclopentyl)ether; or epoxy-resin adducts of the above. A more comprehensive list of epoxy resins can be found in Handbook of Epoxy Resins, by Henry Lee and Kris Neville, McGraw-Hill, Inc., 1967, which is hereby incorporated by reference.

A highly preferred epoxy resin polymer for use in the present invention is diglycidyl ether of bisphenol A (DGEBA) which has the following structural formula: 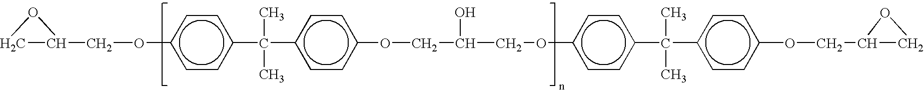
wherein n is an integer from 0 to about 18, desirably from 0 or about 0.1 to about 1.5, and preferably from about 0.1 to about 0.3 as when mixtures of different n are utilized. The weight average molecular weight of DGEBA is from about 340 to about 4,000, and preferably from about 340 to about 2,600.

Other preferred epoxy compounds which are utilized to react with the carboxyl end groups of the CTP include tetrabrominated bis-phenol A which has the formula 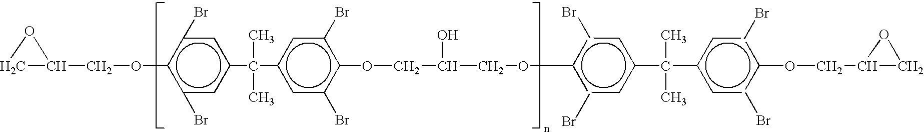
wherein n is as immediately above, i.e. from 0 to about 18, desirably from about 0 or about 0.1 to about 1.5 and preferably from 0.1 to about 0.3. The weight average molecular weight of the brominated bis-phenol A is from about 900 to about 2,000 and preferably from about 900 to about 1,300.

Another desired epoxy compound is a phenolic novolac epoxy having the formula 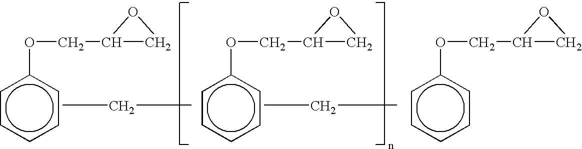
wherein each n, independently, is from about 0 to about 8 and desirably from about 0 or about 0.1 to about 5.

Still another suitable compound is tetraphenylolethane epoxy having the formula 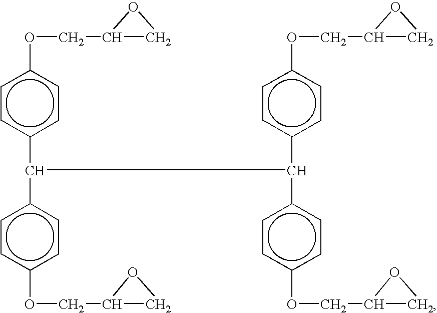
Other desired epoxy compounds which can be utilized to react with the carboxyl end group of the CTP include cresyl glycidyl ether, that is 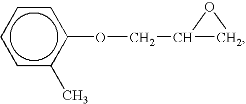
and cycloaliphatic epoxy

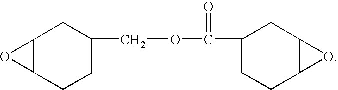

Epoxy terminated polymers such as those represented by Formula Z as well as Formulas F, G, and H (external parenthesis) serve as tougheners for thermoset resins including epoxy resins inasmuch as they are somewhat flexible, that is less brittle than conventional epoxy resins.

Once again the invention will be better understood by reference to the following examples which serve to illustrate, but not to limit the present invention.

### Preparation of Epoxy-Terminated Acrylates (ETA)

### Example ETA-1

In a neat system, utilizing a flask prepared for polymerization, 125 grams of butyl acrylate, 125 grams of ethyl acrylate, 0.05 grams of ADVA and 5.87 grams of trithiocarbonate were purged with nitrogen. Subsequently, a nitrogen needle was raised above the contents to provide a nitrogen blanket. Polymerization was allowed to occur at temperatures of from about 80° C. to about 90° C. for a total of approximately 10 hours to form CTA. Epoxy resin (Epon 828) was then added to the polymer (in a 60/40 weight ratio epoxy/polymer) with triphenylphosphine (0.01 wt %) at 95° C. for 1 to 3 hours, leading to the adduct formation.

In a similar manner various other epoxy-terminated acrylates (ETA) were made from butyl acrylate monomers, or a mixture of butyl acrylate and ethyl acrylate monomers in a weight ratio of about 30% to about 90% butyl acrylate based upon the total weight ratio of the butyl acrylate and ethyl acrylate monomers.

### Example ETA-2

In a 250 ml flask equipped for polymerization, 48 grams of butyl acrylate, 12 grams of ethyl acrylate, 0.1 gram of AIBN, and 1.01 grams of trithiocarbonate were purged with a needle and placed in the solution containing EPON 828 as a solvent for at least 15 minutes. The needle was then raised to provide a nitrogen blanket. Polymerization was subsequently conducted at a temperature of about 80° C. for 3 to 8 hours. Epoxy resin (Epon 828) was then added to the polymer (in a 60/40 weight ratio epoxy/polymer) with triphenylphosphine (0.01 wt %) at 95° C. for 1 to 3 hours, leading to the adduct formation. In a similar manner, other ETAs were made utilizing mixtures of butyl acrylate and ethyl acrylate wherein the amount of butyl acrylate range from about 30% to about 90% by weight.

The poly dispersity of such ETAs when made from trithiocarbonates is generally from about 1.0 to about 1.29 and more specifically about 1.1.

### Preparation of Vinyl-Terminated Polymer (VTP) or Acrylate—(VTA)

In addition to utilizing CTP, CTA, ETP, or ETA as tougheners per se, various vinyl-terminated polymers (VTP), such as various vinyl-terminated acrylates (VTA), can be utilized.

The VTP tougheners can be prepared according to two different routes.

In the GMA (glycidyl methacrylate) route, the polymer diacids such as CTA is reacted with an equivalent molar ratio of glycidyl methacrylate. The esterification is catalyzed by amines such as triethanolamine, benzyl dimethyl amine or TPP. Hydroquinone is used at 1000 ppm to prevent the methacrylate homopolymerization. All ingredients are added into a round bottom flask equipped with condenser and mixing. The reaction medium is heated at 90° C. for several hours. The progress of the reaction is followed by the disappearance of carboxylic acid function, measured through carboxylic acid titration. Typical conversion of CTA into VTA is about 70%.

In the Adduct route, the method includes first the formation of an epoxy adduct (using a lower excess of diepoxy, i.e. Epon 828, than is currently used), and then reacting the epoxy functionality with an equimolar amount of acrylic acid. A fifteen molar excess of epoxy to CTA is used. The CTA and Epon 828 and TPP are mixed at 95° C. until all epoxy groups are reacted (followed by acid titration). Then an equimolar ratio of acrylic acid is added until all epoxy groups are reacted (followed by acid titration). Typical conversion is about 100%.

### Base Polymer

As noted, the above toughener, be it carboxyl terminated or epoxy terminated, or optionally vinyl terminated, serves to toughen or flexiblize various polymers (base polymers) which are subsequently crosslinked to form a thermoset. Such thermosettable (base) polymers include epoxy resins, various polyurethanes, various polymers derived from diene monomers, various polyacrylates, various polyvinyl esters, various polyesters, or various cyanate esters, and the like.

In one embodiment, suitable thermosettable epoxy resins which can be utilized are known to the art and to the literature and include the same resins set forth herein immediately above with regard to epoxy resins which are utilized to end cap the toughener and are hereby fully incorporated by reference for sake of brevity. Such resins are generally epoxy compounds having no repeat units or very few repeat units as noted hereinabove such as up to 18 repeat units and preferably less than 2 or 3 repeat units. Examples of desired epoxy resins include the above noted tetrabrominated bis-phenol A, various phenolic Novolac epoxies such as those set forth hereinabove, various tetraphenylolethane epoxies such as those set forth hereinabove and the like. A highly preferred epoxy resin is the diglycidyl ether of bisphenol A which is also set forth hereinabove.

Generally the amount of toughener such as CTP, CTA, ETP, ETA, VTP, or VTA whether derived from a trithio initiator or a dithio initiator, is small based upon the amount of the base polymer to be subsequently crosslinked and thus is generally from about 1 to about 20, and desirably from about 2 or about 5 to about 10 or about 15 parts by weight per 100 parts by weight of the base polymer, e.g. the epoxy resin.

### Preparation of Vinyl Ester Resins (VE Resins) and Cure Thereof

Vinyl ester resins (VE Resins) are generally made by reacting a base polymer such as the above described blend of an epoxy resin and an epoxidized polymer of Formulas W and Y, as well as F, G or H (external parenthesis), (ETP or ETA) with at least one unsaturated acid in the presence of an esterification catalyst at elevated temperatures. The net result is the formation of an ester linkage with and between the epoxy resin and the epoxidized polymer and a terminal vinyl end group derived from the unsaturated acid. The VE Resins can then be subsequently cured by utilizing a catalyst in the presence of heat, and optionally but preferably in the presence of a diluent. A crosslinking agent is not utilized since the vinyl end groups of the VE Resins react with other vinyl terminated end groups, including any VTP or VTA tougheners since they contain a vinyl end group. Additional tougheners such as CTP, CTA, ETP, ETA, VTP, and VTA are desirably added to form a toughened, cured VE Resin.

### Unsaturated Monocarboxylic Acids

The VE Resins are formed utilizing unsaturated monocarboxylic acids containing from 3 to about 10 and preferably from 3 to about 4 carbon atoms and hydroxyalkyl acrylate or methacrylate half esters of dicarboxylic acids as set forth in U.S. Pat. No. 3,367,992, hereby fully incorporated by reference, wherein the hydroxyalkyl group preferably has from 2 to 6 carbon atoms. Examples of such acids include acrylic acid, methacrylic acid, crotonic acid, cinnamic acid, and the like with generally acrylic or methacrylic acid being preferred. The amount of acid is generally about one mole equivalent. Suitable mole equivalents include from about 0.85 to about 1.15 and preferably from about 0.95 to about 1.05 mole equivalents of acid based upon the total mole equivalents of vinyl ester resin which includes the epoxy resin, and the epoxy terminated polymer (ETP).

Generally esterification catalysts are utilized such as various phosphate and amine catalysts, with representative examples including tetraethylene ammonium bromide, triphenylphosphine (TPP), ethyl triphenylphosphonium iodide, various tertiary amines such as benzyldimethylamine, and the like with tetraethylene ammonium bromide being preferred. The amount of catalyst is very small such as from about 0.25 to about 1.0 percent and preferably from about 0.4 to about 0.6 percent by weight based upon the total weight of the epoxy blend of the polymers derived from a dithio or trithio initiator such as ETP, ETA, etc., and the one or more epoxy resins. Stabilizers are also utilized and include hydroquinone, methyhydroquinone, and the like, with hydroquinone being preferred. The reaction temperature is generally from about 90° C. to about 150° C. with from about 105° C. to about 135° C. being preferred.

The reaction of the unsaturated monocarboxylic acid with the one or more polymers and the one or more epoxy resins, etc., is an addition reaction and an ester group is formed containing a vinyl end group. Thus, when acrylic acid is utilized, the ETP or ETA, etc., as well as the epoxy resin has the vinyl ester end group, 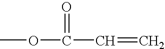
and when methacrylic acid is utilized the end group is

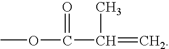

The following examples serve to illustrate the preparation of the VE Resin derived from CTA and epoxy resins.

### Example M

Carboxylated terminated acrylate polymers such as that set forth in Example 4 hereinabove, were added to a reactor in an amount of 7.5 parts by weight, CTA (0.008 equivalent), along with approximately 92.5 parts by weight of various epoxies (base polymers). The epoxy resin, Epon 828 (3.421 equivalent, 650 g), bisphenol A (0.285 equivalent), and a chain extender were used. The resins and TPP (triphenylphosphine) (0.1 g) were loaded into a 3 liter, 3-neck reactor equipped with a mechanical stirrer, a condenser and nitrogen purge. The reactor was purged with nitrogen and its content was heated to 120° C. for 3 hours to form ETA with the remainder being excess epoxy resin. The mixture was then cooled to 80° C. and flushed with air. Hydroquinone (0.6 g) was then added, followed by the addition of methacrylic acid (3.125 equivalent) and TEAB (triethyl ammonium bromide-catalysts)(4 g). The reactor was then sealed and the temperature was raised to 120° C. The reaction was continued until all carboxyl acid groups were reacted, or until a low equivalents per 100 parts by weight of resin (Ephr) value was obtained, as monitored by titration (Ephr<0.002). The reactor was cooled to 80° C. then styrene was slowly added to obtain a 50 weight percent dilution (ca. 1000 g). The end result was a VE Resin containing a mixture or blend of vinyl ester resin (epoxy) and vinyl ester terminated epoxy toughener diluted in styrene.

In a similar manner, several CTA polymers having different molecular weights and large excessive amounts of epoxy resin were reacted to form ETA, and excess epoxy, and subsequently the ETA and excess epoxy were reacted with methacrylic acid in a manner as described in Example M to form VE Resins as set forth in Example N.

### Example N

| | CTA incorporated into structure | | | |
|---|---|---|---|---|
| | | | | Level (phr) |
| | | | | of CTA Resin/ |
| Vinyl Ester | polyacrylate | | | 100 pts wt |
| Resin | type | Mₙ | M_{w} | Vinyl Ester Resin |
| VE5000 | BA 100 | 5000 | 5500 | 7.5 |
| VE9700 | BA 100 | 9700 | 11000 | 7.5 |
| VE14000 | BA 100 | 14000 | 15600 | 7.5 |
| VE19000 | BA 100 | 19000 | 20200 | 7.5 |
| VE22500 | BA 100 | 22500 | 25000 | 7.5 |

### Preparation of Crosslinked or Cured VE Resins

Inasmuch as the VE Resins have high viscosities, it is desirable that a miscible diluent be utilized to yield a processable blend. The solvent or diluent is desirably a hydrocarbon having from 5 to about 15 carbon atoms and preferably contains unsaturation so that it also serves as a monomer which can subsequently be polymerized into the composition upon cure (crosslinking) thereof. The amount of diluent is generally from about 20 to about 80 parts by weight, and preferably from about 30 to about 60 parts by weight per 100 parts by weight of the total amount of said vinyl ester resins. The diluent when polymerized, desirably has a high Tg similar to that of the VE Resin. Desirable polymerized diluents have a Tg of at least about 100° C. and desirably from about 110° C. to about 120° C. Suitable solvents include unsaturated organic solvents such as alkyl styrenes, α-methylstyrene, vinyl toluene, acrylic and methacrylic esters such as methyl methacrylate, etc., with styrene being preferred.

### Miscible Toughener Additive

In addition to the VE Resin blend, the diluent, and a catalyst, preferably a non-reactive toughener is added so that the subsequently formed or crosslinked (i.e. cured) vinyl ester resin composition contains small amounts of a toughener therein and has improved physical properties. In one embodiment, such tougheners do not contain unsaturated end groups and thus do not enter into the crosslinking reaction of the cure. Preferred tougheners are those set forth hereinabove such as by Formulas W, Y, Z, F, G and H and include CTP, or CTA, or ETP, or ETA, or combinations thereof. VTP or VTA can also be utilized, but since they have a vinyl end group, they will react into the crosslink system. An important aspect of the present invention is that such tougheners are miscible with the VE Resin blend, but upon cure (crosslinking) the tougheners (e.g. CTA, ETA, VTA) phase separate and generally form a separate domain. The amount of such tougheners is small as from about 2 to about 50 parts by weight and desirably from about 4 to about 10 or about 25 parts by weight based upon every 100 parts by weight of the VE Resins.

### Crosslinking

Post cure or crosslinking of the VE Resins with a diluent, or alternatively but preferably with a diluent and a miscible toughener, is carried out at elevated temperatures in the presence of a free radical catalyst, preferably a peroxide or a hydroperoxide catalyst. A distinct advantage of the present invention is that tougheners are utilized which are miscible with the various vinyl ester resins before cure of the same. Stable VE Resin compositions thus exist which can be stored for considerable amounts of time such as at least about 2 or 4 weeks, desirably at least about 2 or about 4 months, and preferably at least 6 months and longer such as even up to at least about 8 or about 10 months. In other words, the vinyl ester resins of the present invention containing a miscible toughener therein can be stored for at least several months (shelf life) and then formed into a desired shape and heated to form a cured or crosslinked article. Upon cure, a multiphase crosslinked composition exists, containing the added tougheners therein as a separate discontinuous phase within the generally continuous crosslinked vinyl ester and diluent phase. Shelf life is defined as no visible sign of polymer separation of the vinyl ester resin, diluent blend.

Suitable peroxide catalysts include methyl ethyl ketone peroxide, tert-butyl peroxide (TBP), cumene peroxide, acetyl peroxide, benzoyl peroxide (BPO), lauroyl peroxide, tert-butyl hydroperoxide, cumene hydroperoxide, azobisobutylronitrile, and tert-butyl perbenzoate, and the like with methyl ethyl ketone peroxide, benzoyl peroxide and cumene hydroperoxide being preferred. Metal promoters or accelerators optionally can be utilized and include salts such as cobalt, tin and lead salts of naphthenate or octoate. The total amount of catalyst and promoter is generally from about 0.1 to about 5 and desirably from about 0.5 to about 3 parts by weight per 100 parts by weight of the blend of vinyl ester resins. However, metal promoters are not recommended for acrylate based vinyl ester resin systems.

Suitable crosslinking or cure reaction temperatures are generally from about room temperature, e.g. 20° C. to about 160° C. and preferably from about 60° C. to about 150° C.

### Examples

### Cured VE Resins

The following examples relate to the above VE Resin systems crosslinked in the presence of a diluent and a catalyst wherein no additional tougheners were utilized during cure.

A series of plaques were prepared using neat vinyl ester toughener resins, vinyl terminated epoxy resins, styrene, and MEK peroxide according to the following recipe.

| | |
|---|---|
| VE Resin (≈50 wt. % styrene) | 100 |
| MEK (peroxide) | 4 |

The VE Resin was derived from a CTA reacted with a large excess of an epoxy resin as set forth in Example N. However, no additional impact modifier was added.

The plaques are cured for two hours at 60° C. and post-cured for one hour at about 120° C.

The mechanical and thermal properties were measured and compared to Derakane® 411 and Derakane® 8084. Derakane® 411 is a vinyl ester resin obtained by reacting a unsaturated acid such as acrylic acid or methacrylic acid with an epoxy such as Epon 828 having a number average molecular weight of approximately 380. Derakane® 8084 is the reaction product of a carboxyl terminated butadiene-acrylonitrile elastomer with an epoxy followed by subsequent reaction with an unsaturated acid such as acrylic acid or methacrylic acid. Such vinyl ester resins when utilized with a toughener such as (CTBN or ETBN, a carboxyl terminated or an epoxy terminated butadiene-acrylonitrile rubber toughener, are immiscible and cannot be stored generally any longer than 8 hours and desirably less than 4 hours and subsequently cured or crosslinked inasmuch as very poor physical properties are obtained.

In the following examples, the plane-strain fracture toughness is determined by measuring the stress intensity factor K_{1c} or stress around cracks with the compact tension test according to ASTM D5045-96. Fracture surface energy, G_{1c}, is then calculated according to the following formula:
G_{1c}=(1−ν²)·K_{1c}²/E

Where ν is the Poisson's ratio for the polymer and taken to be 0.35 and E is the flexural modulus. Flexural properties were determined using the three-point bend flexural test ASTM D790-95a. The glass transition temperature was measured by DSC using a heating rate of 10° C./min and from a temperature of −100° C. to 250° C. The obtained data are compiled in the following Table.

| | Commercial Vinyl | | | | | | |
|---|---|---|---|---|---|---|---|
| | ester resins | | CTA-modified VE | | | | |
| | Derakane ® | Derakane ® | Resins (Example N) | | | | |
| Vinyl ester resin | 411 | 8084 | VE5000 | VE9700 | VE14000 | VE19000 | VE22500 |
| Before curing | Clear | Clear | Clear | Clear | Clear | Clear | Clear |
| After curing | Clear | Clear | Clear | Clear | Clear | Clear | Clear |

Plastic flexural modulus

| | | | | | | | |
|---|---|---|---|---|---|---|---|
| Stress at yield (psi) | 10200 | 14400 | 11800 | 15200 | 15500 | 14200 | 14400 |
| S.D. | 5500 | 113 | 5790 | 1740 | 81 | 334 | 936 |
| Strain at yield (in/in) | 0.025 | 0.078 | 0.034 | 0.048 | 0.059 | 0.065 | 0.052 |
| S.D. | 0.013 | 0.019 | 0.024 | 0.016 | 0.01 | 0.004 | 0.007 |
| Modulus (psi) | 416000 | 351000 | 424000 | 407000 | 375000 | 351000 | 361000 |
| S.D. | 28500 | 1020 | 12400 | 4900 | 16200 | 9250 | 15600 |
| Energy to yield | 4.1 | 22.3 | 7.8 | 11.6 | 14.7 | 15.5 | 11.5 |
| point (lbf-in) | | | | | | | |
| S.D. | 3.5 | 7.5 | 9.8 | 6.6 | 4.1 | 1.7 | 2.9 |

Compact tension test

| | | | | | | | |
|---|---|---|---|---|---|---|---|
| K_{1c} (MPa · m^{0.5}) | 0.51 | 1.13 | 0.69 | 0.59 | 0.72 | 1.14 | 1.27 |
| S.D. | 0.01 | 0.09 | 0.08 | 0.03 | 0.07 | 0.11 | 0.18 |
| G_{1c} (J/m²) | 80 | 467 | 145 | 109 | 177 | 475 | 573 |
| S.D. | 3 | 82 | 37 | 12 | 35 | 96 | 174 |

DSC

| | | | | | | | |
|---|---|---|---|---|---|---|---|
| Tg (° C.) | 130 | 104 | 118 | 120 | 120 | 130 | 138 |

S.D. = Standard Deviation

As apparent from the above table, the vinyl ester resins of the present invention made from CTA polymer generally have equal or better properties than commercial vinyl ester resins such as Derakane® 411 or Derakane® 8084. For example, the modulus properties of the VE Resins of the present invention are generally harder than Derakane® 8084 but somewhat less than Derakane® 411. All of the vinyl ester resins had better compact tension properties than Derakane® 411 with the higher molecular weight VE Resins having better properties than Derakane® 8084. Similarly, all the VE Resins had higher fracture surface energy than Derakane® 411 with the higher molecular weight VE Resins having better properties than Derakane® 8084. With regard to Tg, all the VE Resins had higher values than Derakane® 8084.

### Examples

### VE Resins Containing Tougheners

The following examples serve to illustrate the present invention but do not limit the scope thereof.

In the following examples, when the polydispersity is about 1.1, the initiator was trithio carbonate, and when the polydispersity was about 1.7, the initiator was dithio carbonate. Generally most of the toughener systems of the present invention were miscible before cure as generally indicated by the clarity before cure being clear, or translucent. However, the Derakane examples were immiscible and required immediate reaction upon blending thereof.

A series of VE Resins was made containing different molecular weights as set forth in Example N as set forth in the following tables. These crosslinked VE Resins were made utilizing styrene as a diluent, MEK peroxide as a catalyst, the indicated VE Resins and the indicated additional miscible tougheners, e.g. CTA, ETA, etc.

| | | |
|---|---|---|
| Vinyl ester resin (VE9,700) and approximately | 100 | — |
| 50% styrene by weight | | |
| Vinyl ester (VE 14,000; VE 19,000; FE 22,500) | — | 100 |
| and ≈50% styrene | | |
| Additional toughener modifier (CTA, ETA, VTA | 10 | 10 |
| or ETBN) and ≈50% styrene | | |
| MEK (peroxide) -VE9,700 | 4 | 2 |

The VE 9,700 plaques were cured at 1 hour at 60° C. and post cured for 3 hours at 120° C. The VE14,000 plaques were cured at 2 hours at 120° C. and post cured for 1 hour at 160° C. The plaques for VE19,000 and VE22,500 were cured for 3 hours at 120° C. The mechanical and thermal properties are compared to Derakane® 8084 modified with ETBN 1300×40 and are compiled in the following Tables.

| VE Resin 9,700 | | | | | | | | | |
|---|---|---|---|---|---|---|---|---|---|
| Additional | | | | | | | | | |
| Toughener | | VTA | VTA | VTA | VTA | CTA | CTA | | Derakane ® |
| Initial CTA | | BA/AA | BA | BA | BA | BA | BA | ETBN | 8084 |
| Polymer | none | 97/3 | 100 | 100 | 100 | 100 | 100 | 1300 × 40 | — |
| CTA Mn | | 7200 | 9300 | 15800 | 19000 | 24200 | 36700 | | |
| CTA Mw | | 7800 | 10200 | 16000 | 20800 | 26000 | 40100 | | |
| Polydispersity | | 1.1 | 1.1 | 1.1 | 1.1 | 1.1 | 1.1 | | |
| Before curing | Clear | Clear | Clear | Transl* | Transl* | Transl. | Transl. | Op** | Clear |
| After curing | Clear | Transl* | Clear | Clear | Transl* | Clear | Op** | Op** | Clear |

Plastic flexural modulus

| | | | | | | | | | |
|---|---|---|---|---|---|---|---|---|---|
| Stress at yield | 15200 | 12300 | 15700 | 15700 | 13900 | 12100 | 12100 | 7410 | 14400 |
| (psi) | | | | | | | | | |
| S.D. | 1740 | 3780.0 | 978 | 200 | 1510 | 1230 | 665 | 1760 | 113 |
| Strain at yield | 0.048 | 0.039 | 0.054 | 0.065 | 0.050 | 0.049 | 0.058 | 0.027 | 0.078 |
| (in/in) | | | | | | | | | |
| S.D. | 0.016 | 0.023 | 0.011 | 0.005 | 0.017 | 0.016 | 0.014 | 0.008 | 0.019 |
| Modulus (psi) | 407000 | 398000 | 391000 | 370000 | 367000 | 327000 | 310000 | 299000 | 351000 |
| S.D. | 4960 | 16100 | 3340 | 2540 | 4910 | 1110 | 7210 | 8230 | 1020 |
| Energy to yield | 11.6 | 8.9 | 14.1 | 17.5 | 11.6 | 9.7 | 11.9 | 3 | 22.3 |
| point (lbf-in) | | | | | | | | | |
| S.D. | 6.6 | 9.1 | 4.7 | 2 | 6.6 | 5.4 | 4.5 | 1.7 | 7.5 |

Compact tension test

| | | | | | | | | | |
|---|---|---|---|---|---|---|---|---|---|
| K_{1c} (MPa · m^{0.5}) | 0.59 | 0.72 | 0.82 | 0.94 | 1.38 | 1.39 | 1.75 | 1.26 | 1.13 |
| S.D. | 0.03 | 0.12 | 0.11 | 0.09 | 0.07 | 0.05 | 0.06 | 0.13 | 0.09 |
| G_{1c} (J/m²) | 109 | 165 | 222 | 308 | 665 | 758 | 1267 | 681 | 467 |
| Std. Dev. | 12 | 60 | 63 | 62 | 67 | 55 | 88 | 148 | 82 |

DSC

| | | | | | | |
|---|---|---|---|---|---|---|
| Tg (° C.) | 120 | 122 | 122 | 119 | 121 | 104 |

*Transl = Translucent
**Op = Opaque
S.D. = Standard Deviation

| | VE Resin 9,700 | | | | | Derakane ® |
|---|---|---|---|---|---|---|
| | | ETA | VTA | ETA | | 8084 |
| Additional Toughener | | BA/EA | BA/EA | BA/EA | ETBN | — |
| Initial CTA Polymer | None | 50/50 | 50/50 | 50/50 | 1300 × 40 | — |
| CTA Mn | | 8700 | 15500 | 15300 | | |
| CTA Mw | | 15100 | 17000 | 25600 | | |
| Polydispersity | | 1.7 | 1.1 | 1.7 | | |
| Before curing | Clear | Clear | Clear | Clear | Op* | Clear |
| after curing | Clear | Clear | Clear | Clear | Op* | Clear |

Plastic flexural modulus

| | | | | | | |
|---|---|---|---|---|---|---|
| Stress at yield (psi) | 15200 | 15700 | 16300 | 15700 | 7410 | 14400 |
| S.D. | 1740 | 1280 | 132 | 500 | 1760 | 113 |
| Strain at yield (in/in) | 0.048 | 0.053 | 0.065 | 0.054 | 0.027 | 0.078 |
| S.D. | 0.016 | 0.013 | 0.002 | 0.003 | 0.008 | 0.019 |
| Modulus (psi) | 407000 | 395000 | 381000 | 385000 | 299000 | 351000 |
| S.D. | 4960 | 4670 | 4270 | 6950 | 8230 | 1020 |
| Energy to yield | 11.6 | 14 | 18.7 | 13.7 | 3 | 22.3 |
| point (lbf-in) | | | | | | |
| S.D. | 6.6 | 5.9 | 1.2 | 1.3 | 1.7 | 7.5 |

Compact tension test

| | | | | | | |
|---|---|---|---|---|---|---|
| K_{1c} (MPa · m^{0.5}) | 0.59 | 1.39 | 0.91 | 1.27 | 1.26 | 1.13 |
| S.D. | 0.03 | 0.05 | 0.07 | 0.11 | 0.13 | 0.09 |
| G_{1c} (J/m²) | 109 | 755 | 277 | 537 | 681 | 467 |
| S.D. | 12 | 55 | 44 | 94 | 148 | 82 |

DSC

| | | | | |
|---|---|---|---|---|
| Tg (° C.) | 120 | 107 | 104 | 104 |

*Op = Opaque
S.D. = Standard Deviation

As apparent from the above table, when high molecular weight CTA tougheners were utilized, good K_{1c} and G_{1c} properties were obtained which were much better than Derakane® 8084 which did not contain an additional toughener. Moreover, all the ETA and VTA toughened resins of the present invention were miscible before cure whereas ETBN toughened Derakane® 8084 was immiscible and had to be cured immediately upon reaction, i.e. it was not time stable.

| VE Resin 14,000 | | | | | | Derakane ® | Derakane ® |
|---|---|---|---|---|---|---|---|
| | CTA | CTA | CTA | CTA | | 8084 | 8084 |
| Additional Toughener | BA | BA | BA | BA/EA | | ETBN | — |
| Initial CTA Polymer | 100 | 100 | 100 | 90/10 | none | 1300 × 40 | — |
| CTA Mn | 4400 | 11000 | 11500 | 13200 | | | |
| CTA Mw | 9000 | 24600 | 20000 | 14900 | | | |
| Functionality | 1 | 1 | 2 | 2 | | | |
| Polydispersity | 1.7 | 1.7 | 1.7 | 1.1 | | | |
| Before curing | Clear | Transl* | Cloudy | Clear | Clear | Opaque | Clear |
| After curing | Transl* | Op** | Op** | Clear | Clear | Opaque | Clear |

Plastic flexural modulus

| | | | | | | | |
|---|---|---|---|---|---|---|---|
| Stress at yield (psi) | 13400 | 5000 | 12500 | 11700 | 15500 | 11000 | 14400 |
| S.D. | 202 | 502 | 94 | 602 | 81 | 265 | 113 |
| Strain at yield (in/in) | 0.069 | 0.034 | 0.054 | 0.039 | 0.059 | 0.078 | 0.078 |
| S.D. | 0.009 | 0.005 | 0.006 | 0.002 | 0.010 | 0.011 | 0.019 |
| Modulus (psi) | 338000 | 221000 | 314000 | 338000 | 375000 | 276000 | 351000 |
| S.D. | 7670 | 1000 | 3500 | 7810 | 16200 | 4280 | 1020 |
| Energy to yield | 16.4 | 2.7 | 10.8 | 6.4 | 14.7 | 17 | 22.3 |
| point (lbf-in) | | | | | | | |
| S.D. | 2.8 | 0.7 | 1.9 | 0.7 | 4.1 | 3.7 | 7.5 |

Compact tension test

| | | | | | | | |
|---|---|---|---|---|---|---|---|
| K_{1c} (MPa · m^{0.5}) | 1.74 | 1.50 | 2.01 | 1.48 | 0.72 | 2.1 | 1.13 |
| S.D. | 0.11 | 0.189 | 0.019 | 0.07 | 0.068 | 0.1 | 0.09 |
| G_{1c} (J/m²) | 1149 | 1306 | 1650 | 831 | 177 | 2069 | 467 |
| S.D. | 150 | 350 | 31 | 84 | 35 | 63 | 82 |

DSC

| | | | | | | | |
|---|---|---|---|---|---|---|---|
| Tg (° C.) | 103 | 123 | 122 | 113 | 120 | 114 | 104 |

*Transl = Translucent
**Op = Opaque
S.D. = Standard Deviation

| VE 14000 | | | | | | | Derakane ® | Derakane ® |
|---|---|---|---|---|---|---|---|---|
| | CTA | ETA | ETA | ETA | ETA | | 8084 | 8084 |
| Additional Toughener | BA/EA | BA/EA | BA/EA | BA/EA | BA/EA | | ETBN | — |
| Initial CTA Polymer | 50/50 | 50/50 | 50/50 | 50/50 | 40/60 | none | 1300 × 40 | — |
| CTA Mn | 4500 | 8700 | 13400 | 15600 | 15300 | | | |
| CTA Mw | 9500 | 15100 | 26000 | 17500 | 25600 | | | |
| Functionality | 1 | 2 | 2 | 2 | 2 | | | |
| Polydispersity | 1.7 | 1.7 | 1.7 | 1.1 | 1.7 | | | |
| Before curing | Clear | Clear | Clear | Clear | Clear | Clear | Op** | Clear |
| After curing | Transl* | Transl* | Transl* | Clear | Transl* | Clear | Op** | Clear |

Plastic flexural modulus

| | | | | | | | | |
|---|---|---|---|---|---|---|---|---|
| Stress at yield (psi) | 13400 | 11500 | 13700 | 11800 | 12600 | 15500 | 11000 | 14400 |
| S.D. | 202 | 2050 | 340365 | 188 | 820 | 81 | 265 | 113 |
| Strain at yield (in/in) | 0.069 | 0.041 | 0.045 | 0.048 | 0.05 | 0.059 | 0.078 | 0.078 |
| S.D. | 0.009 | 0.014 | 0.003 | 0.005 | 0.005 | 0.010 | 0.011 | 0.019 |
| Modulus (psi) | 338000 | 337000 | 311000 | 315000 | 332000 | 375000 | 276000 | 351000 |
| S.D. | 7670 | 7800 | 7720 | 7130 | 456 | 16200 | 4280 | 1020 |
| Energy to yield | 16.4 | 7.4 | 7.9 | 9.1 | 9.5 | 14.7 | 17 | 22.3 |
| point (lbf-in) | | | | | | | | |
| S.D. | 2.8 | 4.4 | 0.9 | 1.2 | 1.8 | 4.1 | 3.7 | 7.5 |

Compact tension test

| | | | | | | | | |
|---|---|---|---|---|---|---|---|---|
| K_{1c} (MPa · m^{0.5}) | 1.74 | 1.67 | 1.99 | 0.97 | 1.82 | 0.72 | 2.1 | 1.13 |
| S.D. | 0.11 | 0.038 | 0.11 | 0.09 | 0.024 | 0.068 | 0.1 | 0.09 |
| G_{1c} (J/m²) | 1149 | 1061 | 1633 | 379 | 1279 | 177 | 2069 | 467 |
| S.D. | 150 | 49 | 186 | 71 | 34 | 35 | 63 | 82 |

DSC

| | | | | | | | | |
|---|---|---|---|---|---|---|---|---|
| Tg (° C.) | 103 | 106 | 112 | 118 | 120 | 120 | 114 | 104 |

*Transl = Translucent
**Op = Opaque
S.D. = Standard Deviation

As apparent from the above tables, the higher molecular weight vinyl ester resins tended to give better properties. Overall, good modulus was obtained and the K_{1c} and G_{1c} properties were better than Derakane® 8084 containing no additional toughener. All of the CTA and ETA toughened vinyl ester resins were miscible before cure whereas Derakane® 8084 containing ETBN toughener was immiscible and had to be immediately cured in order to obtain favorable properties.

| | VE Resin 19,000 | | | | |
|---|---|---|---|---|---|
| Additional | CTA | CTA | CTA | VTA | CTA |
| Toughener | BA | BA | BA | BA | BA/EA |
| Initial CTA Polymer | 100 | 100 | 100 | 100 | 50/50 |
| CTA Mn | 4400 | 11000 | 11500 | 16800 | 4500 |
| CTA Mw | 9000 | 25000 | 20000 | 22000 | 9500 |
| Functionality | 1 | 1 | 2 | 2 | 1 |
| before curing | Clear | Cloudy | Transl* | Transl/ | Clear |
| | | | | Op** | |
| after curing | Op** | Op** | Op** | Transl* | Transl* |
| Plastic flexural modulus | | | | | |
| Stress at yield (psi) | 10600 | 10300 | 9790 | 9050 | 11100 |
| S.D. | 1500 | 386 | 797 | 336.0 | 32 |
| Strain at yield (in/in) | 0.056 | 0.052 | 0.048 | 0.071 | 0.070 |
| S.D. | 0.020 | 0.005 | 0.01 | 0.021 | 0.009 |
| Modulus (psi) | 266000 | 262000 | 252000 | 195000 | 267000 |
| S.D. | 9800 | 2930 | 5680 | 7980 | 5800 |
| Energy to yield | 10.1 | 8.9 | 7.5 | 10.9 | 14.3 |
| point (lbf-in) | | | | | |
| S.D. | 5.4 | 1.5 | 2.7 | 5.0 | 2.7 |
| Compact tension test | | | | | |
| K_{1c} (MPa · m^{0.5}) | 1.81 | 1.46 | 1.85 | 1.76 | 1.6 |
| S.D. | 0.032 | 0.020 | 0.04 | 0.18 | 0.13 |
| G_{1c} (J/m²) | 1579 | 1043 | 1742 | 2037 | 1230 |
| S.D. | 56 | 29 | 76 | 438 | 208 |
| DSC | | | | | |
| Tg (° C.) | 125 | 132 | 129 | 134 | 125 |
| | VE Resin 19,000 | | | Derakane ® | Derakane ® |
| Additional | ETA | ETA | ETA | 8084 | 8084 |
| Toughener | BA/EA | BA/EA | BA/EA | ETBN | — |
| Initial CTA Polymer | 50/50 | 50/50 | 40/60 | 1300 × 40 | — |
| CTA Mn | 8700 | 13400 | 15300 | | |
| CTA Mw | 15100 | 24100 | 25600 | | |
| Functionality | 2 | 2 | 2 | | |
| before curing | Clear | Clear | Clear | Op** | Clear |
| after curing | Transl* | Op**/ | Trans*/ | Op** | Clear |
| | | Transl* | Op** | | |
| Plastic flexural modulus | | | | | |
| Stress at yield (psi) | 11900 | 9830 | 10700 | 11000 | 14400 |
| S.D. | 430.0 | 192 | 247 | 265 | 113 |
| Strain at yield (in/in) | 0.064 | 0.069 | 0.063 | 0.078 | 0.078 |
| S.D. | 0.001 | 0.011 | 0.004 | 0.011 | 0.019 |
| Modulus (psi) | 281000 | 246000 | 254000 | 276000 | 351000 |
| S.D. | 7880 | 6040 | 7450 | 4280 | 1020 |
| Energy to yield | 13.3 | 12.1 | 11.8 | 17 | 22.3 |
| point (lbf-in) | | | | | |
| S.D. | 0.3 | 2.5 | 1.4 | 3.7 | 7.5 |
| Compact tension test | | | | | |
| K_{1c} (MPa · m^{0.5}) | 1.63 | 1.78 | 1.7 | 2.1 | 1.13 |
| S.D. | 0.06 | 0.007 | 0.03 | 0.1 | 0.09 |
| G_{1c} (J/m²) | 1213 | 1652 | 1459 | 2069 | 467 |
| S.D. | 91 | 13 | 52 | 63 | 82 |
| DSC | | | | | |
| Tg (° C.) | 115 | 121 | 117 | 114 | 104 |

*Transl = Translucent
**Op = Opaque
S.D. = Standard Deviation

All of the CTA, ETA toughened vinyl ester resins had better K_{1c} and G_{1c} properties than the non-reinforced Derakane® 8084. Moreover, the higher molecular weight tougheners had K_{1c} and G_{1c} properties approaching that of the reinforced Derakane®. Once again, a decided advantage of the present invention was that all of the toughened systems of the present invention were miscible whereas the toughened Derakane® was immiscible before cure.

| Additional | VE Resin 22,500 | | | | | | Derakane ® | Derakane ® |
|---|---|---|---|---|---|---|---|---|
| Toughener | CTA | CTA | ETA | CTA | VTA | | 8084 | 8084 |
| Initial CTA | BA | BA | BA/EA | BA | BA | | ETBN | — |
| Polymer | 100 | 100 | 90/10 | 100 | 100 | none | 1300 × 40 | — |
| CTA Mn | 7100 | 11500 | 13200 | 14500 | 16800 | | | |
| CTA Mw | 12000 | 20000 | 14900 | 15900 | 22000 | | | |
| polydispersity | 1.7 | 1.7 | 1.1 | 1.1 | 1.3 | | | |
| Before curing | Clear | Op** | Transl* | Transl* | Transl* | Clear | Op** | Clear |
| After curing | Transl*/ | Op** | Op** | Op** | Transl* | Clear | Op** | Clear |
| | Op** | | | | | | | |

Plastic flexural modulus

| | | | | | | | | |
|---|---|---|---|---|---|---|---|---|
| Stress at yield (psi) | 15400 | 7570 | 10600 | 11100 | 12500 | 14400 | 11000 | 14400 |
| S.D. | 222 | 1520 | 653 | 1630 | 162 | 936 | 265 | 113 |
| Strain at yield | 0.067 | 0.030 | 0.044 | 0.049 | 0.070 | 0.052 | 0.078 | 0.078 |
| (in/in) | | | | | | | | |
| S.D. | 0.006 | 0.007 | 0.005 | 0.018 | 0.007 | 0.007 | 0.011 | 0.019 |
| Modulus (psi) | 364000 | 286000 | 302000 | 309000 | 277000 | 361000 | 276000 | 351000 |
| S.D. | 3360 | 4430 | 3800 | 6740 | 1560 | 15600 | 4280 | 1020 |
| Energy to yield | 17.5 | 3.3 | 7.1 | 9.2 | 14.6 | 11.5 | 17 | 22.3 |
| point (lbf-in) | | | | | | | | |
| S.D. | 2.5 | 1.5 | 1.6 | 5.6 | 2.3 | 2.9 | 3.7 | 7.5 |

Compact tension test

| | | | | | | | | |
|---|---|---|---|---|---|---|---|---|
| K_{1c} (MPa · m^{0.5}) | 2 | 1.41 | 1.68 | 1.44 | 1.82 | 1.27 | 2.1 | 1.13 |
| S.D. | 0.06 | 0.13 | 0.07 | 0.06 | 0.07 | 0.18 | 0.1 | 0.09 |
| G_{1c} (J/m²) | 1409 | 891 | 1198 | 861 | 1533 | 573 | 2069 | 467 |
| S.D. | 86 | 172 | 105 | 73 | 120 | 174 | 63 | 82 |

DSC

| | | | | | | | | |
|---|---|---|---|---|---|---|---|---|
| Tg (° C.) | 121 | 132 | 115 | 135 | 129 | 138 | 114 | 104 |

*Transl = Translucent
**Op = Opaque
S.D. = Standard Deviation

| | VE Resin 22,500 | | | Derakane ® | Derakane ® |
|---|---|---|---|---|---|
| | ETA | ETA | | 8084 | 8084 |
| Additional Toughener | BA/EA | BA/EA | | ETBN | — |
| Initial CTA Composition | 50/50 | 40/60 | none | 1300 × 40 | — |
| CTA Mn | 8700 | 15300 | | | |
| CTA Mw | 15100 | 25600 | | | |
| Polydispersity | 1.7 | 1.7 | | | |
| before curing | Clear | Clear | Clear | Op** | Clear |
| after curing | Transl* | Op** | Clear | Op** | Clear |

Plastic flexural modulus

| | | | | | |
|---|---|---|---|---|---|
| Stress at yield (psi) | 16100 | 14300 | 14400 | 11000 | 14400 |
| S.D. | 398.0 | 274 | 936 | 265 | 113 |
| Strain at yield (in/in) | 0.065 | 0.069 | 0.052 | 0.078 | 0.078 |
| S.D. | 0.010 | 0.008 | 0.007 | 0.011 | 0.019 |
| Modulus (psi) | 381000 | 346000 | 361000 | 276000 | 351000 |
| S.D. | 1140 | 3820 | 15600 | 4280 | 1020 |
| Energy to yield | 17.0 | 17.1 | 11.5 | 17 | 22.3 |
| point (lbf-in) | | | | | |
| S.D. | 3.8 | 2.9 | 2.9 | 3.7 | 7.5 |

Compact tension test

| | | | | | |
|---|---|---|---|---|---|
| K_{1c} (MPa · m^{0.5}) | 1.59 | 1.77 | 1.27 | 2.1 | 1.13 |
| S.D. | 0.04 | 0.092 | 0.18 | 0.1 | 0.09 |
| G_{1c} (J/m²) | 851 | 1161 | 573 | 2069 | 467 |
| S.D. | 43 | 124 | 174 | 63 | 82 |

DSC

| | | | | | |
|---|---|---|---|---|---|
| Tg (° C.) | 117 | 119 | 138 | 114 | 104 |

S.D. = Standard Deviation

The toughened vinyl ester resins having a high number average molecular weight of approximately 22,500 had excellent properties. For example, all of the modulus values were higher than the non-toughened Derakane® 8084 commercial product. Moreover, the higher molecular weight tougheners had good K_{1c} and G_{1c} properties. Once again as a practical commercial bottom line, the CTA, ETA, and VTA toughened systems of the present invention were generally all miscible before cure as opposed to the immiscible toughened Derakane® 8084 system.

### Summary of Data

As apparent from the above data setting forth mechanical properties of the toughened and crosslinked VE Resins of the present invention, generally the higher molecular weight vinyl ester resins had better properties. While not set forth in the tables, it is noted that toughened Derakane® 8084 must be reacted within a matter of a couple hours after blending with a toughener since the same is immiscible and otherwise very poor properties would be obtained. A decided advantage of the present invention is that the above toughened vinyl ester resins containing tougheners had a shelf stability of at least three months.

### Utility

The above toughened crosslinked vinyl ester resins of the present invention are useful in applications wherever good modulus, good fracture resistance and high Tg properties are desired. Accordingly, they can be utilized in ballistic shields for armor vehicles, tanks, ships, and the like. Other uses included wherever toughened compositions are desired such as military and Aerospace composites utilizing carbon and glass fiber reinforcements. Inasmuch as the toughened crosslinked vinyl ester resins are epoxy based, they have good corrosion resistance such as with respect to acids, for example sulfuric acid, hydrochloric acid, and various organic acids, and accordingly can be utilized in containers, barriers, vessels, storage tanks for highly aggressive acids, and the like.

### Diene-Acrylonitrile Base Copolymers and Vinyl Esters Thereof

In a similar manner as set forth hereinabove, the present invention also relates to the use of CTP, CTA, ETP, ETA, VTP and VTA compounds, whether derived from dithio or trithio initiators, as tougheners in polymers such as those derived from the reaction of an epoxy resin and an unsaturated acid. Alternatively, and preferably, polymers are derived from a conjugated diene monomer having from 4 to 8 carbon atoms and acrylonitrile monomers or derivatives thereof to form diene-acrylonitrile copolymers. Such copolymers which contain carboxyl end groups are reacted with epoxy compounds in a manner set forth hereinabove and subsequently with an unsaturated monocarboxylic acid to produce a vinyl ester resin containing either an epoxy resin or a diene-acrylonitrile rubber therein.

More specifically, vinyl ester resins are generally prepared by using approximately equivalent amounts of an unsaturated monocarboxylic acid and a polyepoxide as set forth in U.S. Pat. No. 3,179,623, hereby fully incorporated by reference. Further aspects and details with regard to making vinyl ester resins from epoxidized copolymers of a butadiene and acrylonitrile can be found in U.S. Pat. No. 3,892,819 and Reissue Patent No. 31,310 to Najvar of Dow Chemical, hereby fully incorporated by reference; U.S. Pat. No. 5,198,510 to Siebert et al.; U.S. Pat. No. 5,140,068 to Siebert et al.; U.S. Pat. No. 5,157,077 to Siebert et al.; and U.S. Pat. No. 5,312,956 to Bertsch, assigned to The B.F. Goodrich Company, and hereby fully incorporated by reference.

Briefly, any of the known polyepoxides may be employed in the preparation of the vinyl ester resins of this invention. Useful polyepoxides are glycidyl polyethers of both polyhydric alcohols and polyhydric phenols, flame retardant epoxy resins based on tetrabromo bispheonol A, epoxy novolacs, epoxidized fatty acids or drying oil acids, epoxidized diolefins, epoxidized diunsaturated acid esters as well as epoxidized unsaturated polyesters, so long as they contain more than one oxirane group per molecule. The polyepoxides may be monomeric or polymeric.

Preferred polyepoxides are glycidyl polyethers of polyhydric alcohols or polyhydric phenols having equivalent weights per oxide group of about 150 to 1,500, preferably about 250 to 700 and more preferred about 400 to 600. Generally, as the epoxide equivalent weight decreases the amount of carboxy terminated rubber increases. The polyepoxides are characterized by the presence of more than one epoxide group per molecule.

Unsaturated monocarboxylic acids including acrylic acid, methacrylic acid, halogenated acrylic or methacrylic acids, cinnamic acid and the like and mixtures thereof, and hydroxyalkyl acrylate or methacrylate half esters of dicarboxylic acids as described in U.S. Pat. No. 3,367,992 wherein the hydroxyalkyl group preferably has from 2 to 6 carbon atoms. Said acid is generally reacted with the polyepoxide in the proportions of about 1 equivalent of acid per each equivalent of epoxide, but the proportions of equivalents may range from about 0.8/1 to about 1.2/1, respectively.

Improved impact resistance is obtained by replacing up to about 20 percent of the equivalents of unsaturated acid with an equivalent amount of a liquid carboxy terminated polydiene rubber. By liquid it is meant to include the low molecular weight polydienes of about 2000 to 20,000 molecular weight and preferably about 3,000 to 10,000. Of the combined acid equivalents employed in the process at least about 80% comprises said unsaturated acid and the balance between about 0.01 and 20 percent comprises said polydiene, provided that the polydiene rubber content of the vinyl ester resin is at least about 4 weight percent. By carboxy terminated is meant that the polydiene rubber is terminated at each end with an acid carboxy, —COOH, group.

The particular liquid carboxy terminated polydienes used in this invention may be prepared by any suitable means. One procedure involves solution polymerization of a conjugated diene monomer in the presence of an organo metal catalyst. The lithium catalysts and in particular the dilithium catalysts such as dilithiobutane, dilithium stilbene, dilithium napthalene and the like are preferred. By employing dilithium catalysts the polymer obtained is terminated at each end by a lithium atom. Treatment of said polymer with carbon dioxide replaces the lithium atoms with carboxy lithium salt groups. As a final step the polymer is treated with acid to convert the lithium salt to the free acid form. Carboxy terminated polymers of various conjugated dienes or mixtures of same may be prepared in this manner. The conjugated dienes may have from 4 to 12 carbon atoms and preferably from 4 to 8. Typical monomers include 1,3-butadiene, isoprene, piperylene, methylpentadiene, 3,4-dimethyl-1,3 hexadiene and the like.

Also included within the definition of polydiene rubbers are carboxy terminated liquid copolymers of a conjugated diene and a copolymerizable vinyl monomer. Suitable monomers include alkenyl aromatics such as styrene, vinyl toluene, α-methyl styrene etc.; nitriles such as acrylonitrile, methacrylonitrile, etc.; acrylate and methacrylate esters such as the methyl, ethyl, propyl, cyclohexyl etc. esters; heterocyclic nitrogen-containing monomers such as the various vinyl pyridine isomers, etc.; vinyl chloride, vinylidene chloride, methyl vinyl ether and the like. Said copolymers should contain at least 40 weight percent of diene and correspondingly from 0 to about 60 weight percent of at least one copolymerizable vinyl monomer different from said diene monomer.

Preferred copolymer polydienes are the liquid carboxy terminated acrylonitrile/butadiene copolymers and particularly preferred are those copolymers prepared from about 12% to about 25% acrylonitrile and about 88% to about 75% butadiene.

The preparation of carboxy terminated polydienes is well known. U.S. Pat. No. 3,135,716 is typical of the art describing a process for preparing terminally reactive polymers as well as the various reactions which may be employed to introduce different functional terminal groups. The disclosure of U.S. Pat. No. 3,242,129 is also typical of the art, especially the portions contained in columns 6-8 thereof. The above two patents are incorporated herein by reference.

The vinyl ester resins typically are prepared in the presence of catalysts such as the organophosphonium salts, tertiary amines such as 2,4,6-tri(dimethylaminomethyl) phenol [DMP-30] and the like. Various vinyl polymerization inhibitors such as hydroquinone or its methyl ether and the like may be present during the reaction or added after the resin forming reaction. If desired the reaction may be run in an inert solvent, preferably one which can be readily removed by evaporation etc. after the resin has been prepared. The carboxy terminated polydiene may be reacted with the polyepoxide first followed by addition and reaction of the unsaturated monocarboxylic acid or both acid reactants may be added and reacted with the polyepoxide at the same time.

The polydiene rubber modified vinyl ester resin produced herein typically contains terminal polymerizable groups and associated therewith a hydroxyalkylene group, e.g. —CH₂CH(OH)CH₂—, formed by the reaction of the acid carboxy group with the epoxide group. This hydroxyl group may be used for further modification, e.g. by a post-reaction with a dicarboxylic acid anhydride in proportions up to about 1 mole per equivalent of hydroxyl. A modification of this kind is disclosed in U.S. Pat. No. 3,564,074. Other materials which are reactive with hydroxyl groups, e.g. isocyanates, acyl halides, etc. may be used to modify the vinyl ester resin.

Both saturated and unsaturated anhydrides are useful in said post reaction. Suitable dicarboxylic acid anhydrides containing ethylenic unsaturation include maleic anhydride, the halogenated maleic anhydrides, citraconic anhydride, itaconic anhydride and the like and mixtures thereof. Saturated dicarboxylic acid anhydrides include phthalic anhydride, tetrabromophthalic anhydride, chlorendic anhydride, anhydrides of aliphatic unsaturated dicarboxylic acid and the like.

The rubber modified vinyl ester resins are higher molecular weight resins by virtue of chemically combining the carboxy terminated polydiene rubbers into the resin structure. Accordingly, many of the resins are suitable as powder coating materials. A mixture of the powdered resin with a peroxide or other catalyst may be readily cured at an elevated temperature. The pendant carboxyl groups are of importance in powder coatings since they can be reacted with metal oxides to make solid powdered even in the presence of liquid monomers.

The above rubber modified vinyl ester resins can be crosslinked in the presence of a diluent, as noted hereinabove, in the presence of a free radical catalyst such as a peroxide to form a crosslink polymer. Accordingly, the rubber modified vinyl ester resin can be combined with up to about 60 to about 70 weight percent of a reactive diluent monomer which is generally an organic solvent. The proportions will vary, somewhat depending on the monomer selected, other additives employed and other factors. A variety of copolymerizable monomers are disclosed in the vinyl ester patents previously referred to. Typical monomers are styrene, vinyl toluene, halogenated styrenes, alkyl substituted styrenes, alkyl substituted styrene, acrylic and methacrylic esters, hydroxyalkyl esters of acrylic and methacrylic acid, and the like. More usually the monomer content will range from about 30 to about 60 weight percent.

The choice of monomer is also based on whether the resin is to be cured by thermal and/or chemical means or by high energy radiation. With chemical catalysts (e.g. peroxides, persulfates, diazo compounds, etc.) and/or heat styrene is a common monomer because of its low cost and availability as well as the properties obtained. Suitable peroxide monomers are set forth hereinabove with regard to the above preparation of vinyl ester resins and the same, such as methylethyl ketone peroxide, etc., is preferably utilized. However, to minimize the radiation dosage needed to cure monomers other than aromatic monomers may be employed such as butyl acrylate and hydroxyalkyl acrylates.

As indicated, the rubber modified vinyl ester resin may be cured (thermoset) by various means. Cure accelerators such as the metal organic acid salts, e.g. cobalt naphthenate, or tertiary amines such as N,N-dimethyl toluidine are frequently used with chemical catalysts. Sensitizers or photoinitiators which reduce the radiation dosage may also be employed with radiation, especially with ultra violet light. Other materials may be added to the resin such as inert reinforcing fibers, e.g. glass, asbestos, carbon, etc.; inert fillers such as kaolin clay, CaCO₃ etc.; mold release agents, thickeners, other pigments, thermoplastic low-profile additives, density reducers such as glass or phenolic microballons, blown saran microspheres and the like.

The improved impact resistance of the rubber modified vinyl ester resins makes the resin especially useful in coatings and for molded articles. Of particular interest are molded parts such as motor housings for power mowers, boats and recreation products, automotive parts such as panels and housings, molded furniture containing blown saran microspheres where improved toughness and durability are required in medium density syntatic foams for chair legs and arms, doors, backup for acrylic faced bath tubs, lavatories, etc.

The above vinyl ester resins are generally available from Dow Chemical Company under the trade name Derakane® such as Derakane® 411 and Derakane® 8084.

The above vinyl ester resins of diene-acrylonitrile copolymers can be further toughened by adding the above noted dithio or trithio initiator tougheners therein, e.g. CTP, CTA, ETP, ETA, VTP, or VTA, or combinations thereof. The amount of such additives is generally from about 3 to about 30 and preferably from about 5 to about 15 parts by weight per 100 parts by weight of the one or more vinyl ester resins. The reaction conditions such as temperature for both the preparation of the vinyl ester butadiene-acrylonitrile copolymer resins as well as the cure thereof in the presence of a reactive monomer diluent are generally the same as set forth hereinabove and the same is hereby fully incorporated by reference. Moreover, other reaction conditions such as the amount of catalyst, and the like are also the same.

The invention will be better understood by the following examples which serve to illustrate but not to limit the invention.

Preparation of vinyl ester blends derived from reacting a polyepoxide having an average of more than one epoxide group per molecule with an unsaturated monocarboxylic acid and with carboxyl terminated polydiene rubbers are set forth in the examples of U.S. Pat. No. 3,892,819, and Reissue Patent 31,310, hereby fully incorporated by reference. CTP, ETP, and VTP Toughened Vinyl Ester Compositions Comprising Vinyl Ester Epoxies and Epoxidized Polydiene-Acrylonitrile Rubbers In the following examples, the above described tougheners of the present invention such as CTP, CTA, ETP, ETA, VTP and VTA, were added to commercial vinyl esters derived from reacting an epoxy resin with an unsaturated monoacid; or by reacting an epoxy terminated diene polymer such as a copolymer of butadiene and acrylonitrile with an unsaturated acid, commercially available, respectively, as Derakane® 411 and Derakane® 8084. These commercial compositions are known to the art and to the literature. With respect to each of the examples, a series of plaques were prepared based upon the recipes set forth below wherein small amounts of styrene were utilized as a diluent, MEK was a catalyst and often a promoter such as cobalt naphthenate was utilized. In all of the recipes, the various ingredients were mixed and formed into a plaque and then cured for approximately two hours at about 120° C.

CTA, ETA TOUGHENED DERAKANE ® 411

| | |
|---|---|
| Derakane ® 411-45 | 100 |
| ETA, CTA, or ETBN Toughener | 10 |
| with ≈50%. wt of styrene | |
| MEK (peroxide) | 2 |
| Cobalt Naphthenate | 0.05 |

Properties of the above cured compositions were as follows:

DERAKANE ® 411

| | ETA | ETA | ETA | CTA | ETA | | |
|---|---|---|---|---|---|---|---|
| Toughener | BA/EA | BA/EA | BA/EA | BA/EA | BA/EA | ETBN | |
| Initial CTA polymer | 50/50 | 50/50 | 50/50 | 50/50 | 50/50 | 1300 × 40 | none |
| CTA Mn | 15600 | 9500 | 8700 | 4500 | 13400 | | |
| CTA Mw | 17500 | 8500 | 15100 | 9500 | 24000 | | |
| functionality | 2.0 | 2.0 | 2.0 | 1.0 | 2 | | |
| Before curing | Opaque | opaque | opaque | opaque | Opaque | opaque | clear |
| after curing | Opaque | opaque | opaque | opaque | Opaque | opaque | clear |

Plastic flexural modulus

| | | | | | | | |
|---|---|---|---|---|---|---|---|
| Stress at yield (psi) | 11700 | 16300 | 15900 | 14700 | 14300 | 12500 | 20200 |
| S.D. | 4930 | 1500 | 555 | 718 | 1340 | 5020 | 275 |
| Strain at yield (in/in) | 0.034 | 0.052 | 0.054 | 0.058 | 0.043 | 0.046 | 0.072 |
| S.D. | 0.015 | 0.013 | 0.008 | 0.011 | 0.005 | 0.025 | 0.008 |
| Modulus (psi) | 379000 | 403000 | 384000 | 335000 | 372000 | 343000 | 434000 |
| S.D. | 6690 | 13000 | 10100 | 4670 | 3920 | 10800 | 3700 |
| Energy to yield | 6.6 | 13.6 | 13.3 | 14.6 | 9 | 10.8 | 25.4 |
| point (lbf-in) | | | | | | | |
| S.D. | 4.7 | 6 | 3.6 | 4.6 | 2.1 | 9 | 4.5 |

Compact tension test

| | | | | | | | |
|---|---|---|---|---|---|---|---|
| K_{1c} (MPa · m^{0.5}) | 0.84 | 0.87 | 0.88 | 0.85 | 0.91 | 0.85 | 0.7 |
| S.D. | 0.05 | 0.07 | 0.1 | 0.12 | 0.09 | 0.06 | 0.03 |
| G_{1c} (J/m²) | 239 | 241 | 259 | 277 | 285 | 270 | 145 |
| S.D. | 29 | 40 | 62 | 84 | 59 | 39 | 13 |

DSC

| | | | | | | | |
|---|---|---|---|---|---|---|---|
| Tg (° C.) | 110 | 107 | 107 | 122 | 110 | 122 | 121 |

S.D. = Standard Deviation

DERAKANE ® 411

| | CTA | CTA | CTA | CTA | | |
|---|---|---|---|---|---|---|
| Toughener | BA | BA | BA | BA | ETBN | |
| Initial CTA Polymer | 100 | 100 | 100 | 100 | 1300 × 40 | none |
| CTA Mn | 4400 | 11000 | 12000 | 11500 | | |
| CTA Mw | 9000 | 24600 | 24000 | 20000 | | |
| functionality | 1.0 | 1.0 | 2.0 | 2 | | |
| before curing | opaque | opaque | opaque | opaque | opaque | clear |
| after curing | opaque | opaque | opaque | opaque | opaque | clear |

Plastic flexural modulus

| | | | | | | |
|---|---|---|---|---|---|---|
| Stress at yield (psi) | 14500 | 12200 | 14500 | 13600 | 12500 | 20200 |
| S.D. | 3110 | 3100 | 1010 | 2410 | 5020 | 275 |
| Strain at yield (in/in) | 0.05 | 0.038 | 0.056 | 0.044 | 0.046 | 0.072 |
| S.D. | 0.021 | 0.013 | 0.014 | 0.014 | 0.025 | 0.008 |
| Modulus (psi) | 378000 | 363000 | 343000 | 355000 | 343000 | 434000 |
| S.D. | 6680 | 4080 | 9690 | 4580 | 10800 | 3700 |
| Energy to yield | 12.4 | 7.3 | 13.6 | 9.8 | 10.8 | 25.4 |
| point (lbf-in) | | | | | | |
| S.D. | 8.8 | 5.1 | 5.6 | 5.7 | 9 | 4.5 |

Compact tension test

| | | | | | | |
|---|---|---|---|---|---|---|
| K_{1c} (MPa · m^{0.5}) | 0.82 | 0.79 | 0.91 | 0.83 | 0.85 | 0.7 |
| S.D. | 0.08 | 0.08 | 0.06 | 0.04 | 0.06 | 0.03 |
| G_{1c} (J/m²) | 228 | 220 | 310 | 249 | 270 | 145 |
| S.D. | 47 | 47 | 42 | 25 | 39 | 13 |

DSC

| | | | | | | |
|---|---|---|---|---|---|---|
| Tg (° C.) | 124 | 124 | 123 | 122 | 122 | 121 |

S.D. = Standard Deviation

As apparent from the above table, utilizing tougheners of the present invention improved properties were obtained which were generally equal to or better than properties obtained with respect to utilizing ETBN (epoxy terminated butadiene-acrylonitrile copolymer).

ETA TOUGHENED DERAKANE ® 8084

| | |
|---|---|
| Derakane ® 8084 | 100 |
| ETA Toughener with ≈50 wt. % | 10 |
| of styrene | |
| BPO | 2.5 |
| Dimethylamine (DMA) | 0.1 |

Properties of the above cured compositions were as follows:

DERAKANE ® 8084

| Toughener | ETA | ETA | ETA | ETA | | |
|---|---|---|---|---|---|---|
| Initial CTA | BA/EA | BA/EA | BA/EA | BA/EA | ETBN | |
| Polymer | 50/50 | 40/60 | 50/50 | 50/50 | 1300 × 40 | none |
| CTA Mn | 15600 | 15300 | 9500 | 8700 | | |
| CTA Mw | 17500 | 25600 | 8500 | 15100 | | |
| Polydispersity | 1.1 | 1.7 | 1.1 | 1.7 | | |
| Catalyst-based | TTC | DTC | TTC | DTC | | |
| Before curing | transl | transl | transl | Transl | Transl | transl |
| after curing | transl/op | op. | transl. | Transl/op | op. | transl |

Plastic flexural modulus

| | | | | | | |
|---|---|---|---|---|---|---|
| Stress at yield | 13600 | 9820 | 11700 | 9830 | 6450 | 15400 |
| (psi) | | | | | | |
| S.D. | 53 | 120 | 29 | 116 | 600.0 | 35 |
| Strain at yield | 0.082 | 0.080 | 0.086 | 0.081 | 0.121 | 0.085 |
| (in/in) | | | | | | |
| S.D. | 0.0005 | 0.001 | 0.011 | 0.0145 | 0.008 | 0.009 |
| Modulus (psi) | 331000 | 260000 | 297000 | 263000 | 176000 | 366000 |
| S.D. | 3180 | 5910 | 7190 | 3010 | 8650 | 5570 |
| Energy to yield | 21.6 | 15.4 | 19.4 | 15 | 16.0 | 23.6 |
| point (lbf-in) | | | | | | |
| S.D. | 0.16 | 0.6 | 3.4 | 3.4 | 1.2 | 3.5 |

Compact tension test

| | | | | | | |
|---|---|---|---|---|---|---|
| K_{1c} (MPa · m^{0.5}) | 1.51 | 1.81 | 1.3 | 1.83 | 1.51 | 1.17 |
| S.D. | 0.1 | 0.070 | 0.03 | 0.11 | 0.25 | 0.06 |
| G_{1c} (J/m²) | 883 | 1616 | 730 | 1633 | 1661 | 480 |
| S.D. | 121 | 127 | 34 | 202 | 596 | 50 |

DSC

| | | | | | | |
|---|---|---|---|---|---|---|
| Tg (° C.) | 112 | 110 | 114 | 107 | 109 | 113 |

S.D. = Standard Deviation

As apparent from the above table, Derakane® toughened with tougheners of the present invention generally gave equivalent or better properties than Derakane® toughened with ETBN. However, in all of the examples, the toughener was not miscible with the Derakane®.

ETA, CTA TOUGHENED DERAKANE ® 8084

| | |
|---|---|
| Derakane ® 8084 | 100 |
| ETA, CTA Toughener with ≈50 | 10 |
| wt. % of styrene | |
| MEK (peroxide) | 2 |
| Co naphthenate | 0.1 |

Properties of the above cured compositions were as follows:

DERAKANE ® 8084

| | CTA | ETA | ETA | ETA | | |
|---|---|---|---|---|---|---|
| Toughener | BA | BA/EA | BA/EA | BA/EA | CTBN | |
| Initial CTA Polymer | 100 | 50/50 | 50/50 | 40/60 | 1300 × 8 | None |
| CTA Mn | 7100 | 13400 | 8700 | 15300 | | |
| CTA Mw | 12000 | 26000 | 15100 | 25600 | | |
| polydispersity | 1.7 | 1.9 | 1.7 | 1.7 | | |
| Before curing | Op | op | Transl. | Transl. | op | clear |
| After curing | Op | op | transl. | Op | op | clear |

Plastic flexural modulus

| | | | | | | |
|---|---|---|---|---|---|---|
| Stress at yield (psi) | 15100 | 15200 | 9600 | 9570 | 11100 | 17900 |
| S.D. | 235 | 22 | 160 | 400 | 414 | 246 |
| Strain at yield (in/in) | 0.074 | 0.069 | 0.066 | 0.032 | 0.058 | 0.064 |
| S.D. | 0.004 | 0.004 | 0.003 | 0.001 | 0.009 | 0.006 |
| Modulus (psi) | 352000 | 364000 | 266000 | 327000 | 285000 | 410000 |
| S.D. | 6190 | 6000 | 5570 | 5000 | 2240 | 4670 |
| Energy to yield | 20.1 | 17.8 | 11 | 3.9 | 10.9 | 20.1 |
| point (lbf-in) | | | | | | |
| S.D. | 1.9 | 1.8 | 0.9 | 0.2 | 2.5 | 3.3 |

Compact tension test

| | | | | | | |
|---|---|---|---|---|---|---|
| K_{1c} (MPa · m^{0.5}) | 1.61 | 1.80 | 2.01 | 1.70 | 2.03 | 0.91 |
| S.D. | 0.07 | 0.060 | 0.03 | 0.09 | 0.063 | 0.091 |
| G_{1c} (J/m²) | 944 | 1141 | 1948 | 1133 | 1854 | 256 |
| S.D. | 84 | 77 | 59 | 123 | 2 | 3 |

DSC

| | | | | | | |
|---|---|---|---|---|---|---|
| Tg (° C.) | 114 | 102 | 101 | 103 | 115 | 116 |

S.D. = Standard Deviation

As apparent from the above examples, Derakane® toughened with tougheners of the present invention gave slightly poorer or equal properties as Derakane® toughened with CTBN. However, in all examples the toughener were not miscible with Derakane®.

While in accordance with the patent statutes the best mode and preferred embodiment have been set forth, the scope of the invention is not limited thereto, but rather by the scope of the attached claims.

1. A vinyl ester toughener, comprising:
the reaction product of a toughener polymer or copolymer and an unsaturated monocarboxylic acid;
said unsaturated acid being a monoacid containing from 3 to about 10 carbon atoms;
said toughener polymer having the formula 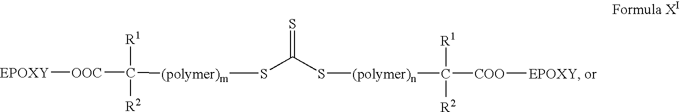
wherein R¹ and R², independently, are an alkyl having 1 to about 6 carbon atoms, an alkyl having from 1 to 6 carbons atoms and 1 or more substituents, at least one aryl, or at least one substituted aryl having from 1 to about 6 substituents on the aryl ring, and wherein said one or more substituents, independently, comprises an alkyl having from 1 to 6 carbon atoms, or an aryl, or a halogen group, or a cyano group, or an ether having a total of from 2 to about 20 carbon atoms, or a nitro group, or combinations thereof,
wherein m and n, independently, is a repeat unit of from about 5 to about 1,000; or
said toughener polymer or copolymer having the formula: 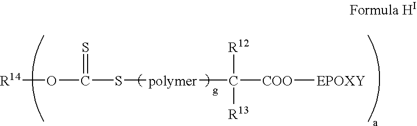
wherein R¹² and R¹³, independently, can be the same or different, can be a linear or branched alkyl having from 1 to about 12 carbon atoms; or an aryl group having from 6 to about 18 carbon atoms, optionally containing heteroatoms; or R¹² and R¹³ can form or be a part of a substituted or unsubstituted cyclic ring having from 3 to about 12 carbon atoms;
wherein R¹⁴ is optionally substituted, and can be a linear or branched alkyl having from 1 to about 12 carbon atoms, an aryl group optionally saturated or unsaturated; an arylalkyl having from about 7 to about 18 carbon atoms; an acyl group; an alkene group; an alkenealkyl having from 3 to about 18 carbon atoms; an alkylene group; an alkoxyalkyl; derived from a polyalkylene glycol; derived from a polyalkylene glycol monoalkyl ether having from about 3 to about 200 carbon atoms; derived from a polyalkylene glycol monoaryl ether having from about 3 to about 200 carbon atoms, a polyfluoroalkyl; a phosphorous containing alkyl; or a substituted or unsubstituted aryl ring containing heteroatoms;
wherein said (polymer) is derived from at least one conjugated diene monomer, or a vinyl containing monomer or combinations thereof, with the proviso that each polymer repeat unit can be the same or different;
wherein said g is from about 1 to about 10,000; and
wherein said “a” is 1 to about 4; or
said toughener polymer or copolymer being a dithiocarbamate having the formula: 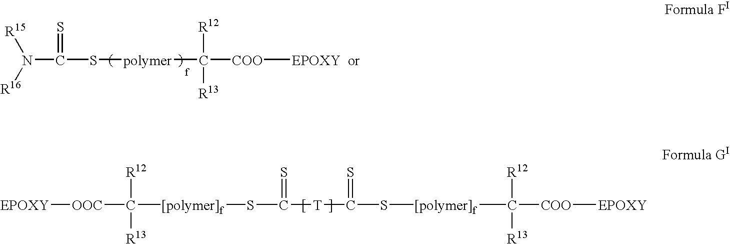
wherein each R¹² and R¹³, independently, is the same or different, is optionally substituted, and is a linear or branched alkyl having from 1 to about 12 carbon atoms; or an aryl group having from 6 to about 18 carbon atoms, optionally containing heteroatoms; or R¹² and R¹³ can form and be part of a substituted or unsubstituted cyclic ring having from 3 to about 12 carbon atoms;
wherein R¹⁵ and R¹⁶, independently, is the same or different, optionally substituted, optionally contains heteroatoms, and is hydrogen; or a linear or branched alkyl having from 1 to about 18 carbons; or an aryl group having from 6 to about 18 carbon atoms, optionally saturated or unsaturated; or an arylalkyl having from 7 to about 18 carbons; or an alkenealkyl having from 3 to about 18 carbon atoms; or derived from polyalkylene glycol ether; or derived from an amine; or R¹⁵ and R¹⁶ are in the form of a substituted or unsubstituted cyclic ring with the nitrogen atom having a total of 4 to about 12 carbon atoms;
wherein T is a divalent radical having a nitrogen atom directly connected to each carbon atom of the two thiocarbonyl groups;
wherein said (polymer) repeat units are derived from at least one conjugated diene monomer, or a vinyl containing monomer, or combinations thereof, with the proviso that each repeat unit can be the same or different; and
wherein the number of said repeat units f, independently, is from 1 to about 10,000.

2. A vinyl ester toughener according to claim 1, wherein said Formula X′ (polymer), independently, comprises a polyacrylate or polymethacrylate derived from an alkyl acrylate or alkyl methacrylate monomer wherein said alkyl has from 1 to about 18 carbon atoms, a polymer derived from a vinyl substituted aromatic monomer containing from 8 to about 12 carbon atoms, a polymer derived from a conjugated diene monomer containing from 4 to about 12 carbon atoms, a polymer derived from acrylonitrile, or combinations thereof, or
wherein said Formula H′ conjugated diene monomer has from 4 to 12 carbon atoms, and wherein said vinyl containing monomer has the formula: 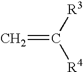
wherein R³ comprises hydrogen, halogen, C₁-C₄ alkyl, or substituted C₁-C₄ alkyl wherein said substituents, independently, comprise one or more hydroxy, alkoxy, aryloxy(OR⁵), carboxy, acyloxy, aroyloxy(O₂CR⁵), alkoxy-carbonyl(CO₂R⁵), or aryloxy-carbonyl; N-pyrrolidonyl;
wherein R⁴ comprises hydrogen, R⁵, CO₂H, CO₂R⁵, COR⁵, CN, CONH₂, CONHR⁵, O₂CR⁵, OR⁵ or halogen; and
wherein R⁵ comprises C₁-C₁₈ alkyl, substituted C₁-C₁₈ alkyl, C₂-C₁₈ alkenyl, aryl, heterocyclyl, aralkyl, or alkaryl, and wherein said substituents, independently, comprise one or more epoxy, hydroxy, alkoxy, acyl, acyloxy, carboxy, (and salts), sulfonic acid (and salts), alkoxy- or aryloxy-carbonyl, dicyanato, cyano, silyl, halo or dialkylamino, and
wherein g is from about 3 to about 5,000; or
wherein in said Formula F^{I} and G^{I} toughener polymer or copolymer f is from about 3 to about 5,000;
wherein T is: 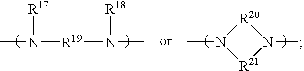
wherein R¹⁷ and R¹⁸, independently, is the same or different, is optionally substituted, and is hydrogen; or a linear or branched alkyl having from 1 to about 18 carbon atoms; or an aryl group having from about 6 to about 18 carbon atoms; or an arylalkyl having from 7 to about 18 carbon atoms; or a alkenealkyl having from 3 to about 18 carbon atoms; wherein R¹⁹ is optionally substituted, or is non-existent; or an alkylene group having from 1 to about 18 carbon atoms; or derived from a polyalkylene glycol either having from 3 to about 200 carbon atoms; wherein R²⁰ and R²¹, independently, is the same or different, and is optionally substituted, and is an alkylene group having from 1 to about 4 carbon atoms, or
wherein T is: 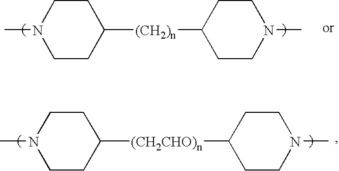
wherein n is 0 to about 18.

3. A vinyl ester toughener according to claim 2, wherein each said EPOXY, independently, is derived from a: polyhydric phenol polyether alcohol; glycidyl ether of a novolac resin; phenolic novolac epoxy, tetraphenylolethane epoxy, glycidyl ether of mononuclear di- and trihydric phenol; glycidyl ether of bisphenol; glycidyl ether of polynuclear phenol; epoxy resin derived from diphenolic acid; glycidyl ether of aliphatic polyol; glycidyl ester; glycidyl epoxy containing nitrogen; glycidyl derivative of cyanuric acid; glycidyl resin derived from melamine; glycidyl amine; thioglycidyl resin; silicon-glycidyl resin; fluorine glycidyl resin; epoxy resin which is synthesized from monoepoxy other than epihalohydrin including an epoxy resin derived from unsaturated monoepoxy; epoxy resin derived from monoepoxy alcohol; epoxy resin derived from monoepoxy by ester interchange; epoxy resin derived from glycidaldehyde; polyglycidyl compound containing unsaturation; epoxy resin which is synthesized from olefin and chloroacetyl; or an-epoxy-resin adduct of the above, or combinations thereof;
wherein m and n of Formula X^{I}, independently, is from about 7 to about 150, and wherein said unsaturated acid is acrylic acid, methacrylic acid, crotonic acid, cinnamic acid, or combinations thereof.

4. A vinyl ester toughener according to claim 3, wherein said Formula X^{I} (polymer) is said polyacrylate and said polyacrylate is derived from ethyl acrylate, butyl acrylate, or ethyl-hexyl acrylate, or combinations thereof; wherein R¹ and R² are methyl; and
wherein said unsaturated acid is acrylic acid or methacrylic acid; and
wherein the amount of said acid is from about 0.85 to about 1.15 mole equivalents based upon the total mole equivalents of said toughener polymer, or
wherein, independently, each said polymer repeat unit of Formula HI is derived from alkyl acrylate, vinyl acetate, acrylic acid, styrene, N-vinyl pyrrolidone, or a combination thereof, or
wherein R¹² and R¹³, independently, are an alkyl having from 1 to about 4 carbon atoms, or are part of a cyclic ring, and
wherein “a” is 2, and wherein R¹² and R¹³, independently, are a phenyl group or alkyl group having 1 to about 10 carbon atoms, or R¹² and R¹³ are part of a cyclic ring; or
wherein, independently, in Formulas F^{I} or G^{I}, said conjugated diene monomer has from 4 to 12 carbon atoms, and wherein said vinyl containing monomer has the formula: 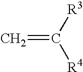
wherein R³ comprises hydrogen, halogen, C₁-C₄ alkyl, or substituted C₁-C₄ alkyl wherein said substituents, independently, comprise one or more hydroxy, alkoxy, aryloxy(OR⁵), carboxy, metal carboxylate (COOM) with M being sodium, potassium, calcium, zinc or an ammonium salt, acyloxy, aroyloxy(O₂CR⁵), alkoxy-carbonyl(CO₂R⁵), aryloxy-carbonyl; or N-pyrrolidonyl;
wherein R⁴ comprises hydrogen, R⁵, CO₂H, CO₂R⁵, COR⁵, CN, CONH₂, CONHR⁵, O₂CR⁵, OR⁵ or halogen; and
wherein R⁵ comprises C₁-C₁₈ alkyl, substituted C₂-C₁₈ alkyl, C₂-C₁₈ alkenyl, aryl, heterocyclyl, aralkyl, or alkaryl, and
wherein said substituents, independently, comprise one or more epoxy, hydroxy, alkoxy, acyl, acyloxy, carboxy, carboxy salts, sulfonic acid, sulfonic salts, alkoxy- or aryloxy-carbonyl, dicyanato, cyano, silyl, halo or dialkylamino.

5. A vinyl ester toughener according to claim 4, wherein in Formula X^{I}, m and n, independently, are from about 10 to about 200,
wherein each said EPOXY in Formula X^{I}, F^{I}, G^{I}, and H^{I}, independently, is derived from 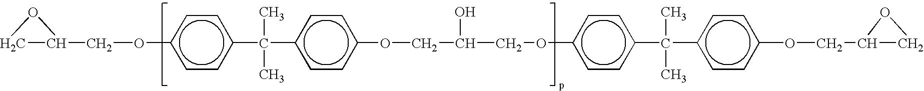
wherein p is from 0.1 to about 1.5, and
wherein the number of said terminal EPOXY groups is from about 1 to about 2.

6. A vinyl ester toughener according to claim 5, wherein in said Formulas F^{I}, G^{I}, and H^{I} said (polymer) is a polyacrylate, independently, derived from ethyl acrylate, butyl acrylate, or combinations thereof.

7. A vinyl ester toughener according to claim 1, including an esterification catalyst, and wherein said reaction occurs at a temperature of from about 90° C. to about 150° C.

8. A vinyl ester toughener according to claim 3, including an esterification catalyst, and wherein said reaction occurs at a temperature of from about 90° C. to about 150° C.

9. A vinyl ester toughener according to claim 5, including an esterification catalyst, and
wherein the reaction occurs at a temperature of from about 105° C. to about 135° C.

10. A blend of vinyl ester resins, comprising:
a vinyl ester toughener of claim 1, and a vinyl ester epoxy,
said vinyl ester epoxy being the reaction product of at least one epoxy resin and a monounsaturated carboxylic acid having from 3 to about 10 carbon atoms.

11. A blend of vinyl ester resins, comprising:
a vinyl ester toughener of claim 2, and a vinyl ester epoxy;
said vinyl ester epoxy being the reaction product of at least one epoxy resin and a monounsaturated carboxylic acid having from 3 to about 10 carbon atoms;
wherein said epoxy resin is derived from a: polyhydric phenol polyether alcohol; glycidyl ether of a novolac resin; phenolic novolac epoxy, tetraphenylolethane epoxy, glycidyl ether of mononuclear di- and trihydric phenol; glycidyl ether of bisphenol; glycidyl ether of polynuclear phenol; epoxy resin derived from diphenolic acid; glycidyl ether of aliphatic polyol; glycidyl ester; glycidyl epoxy containing nitrogen; glycidyl derivative of cyanuric acid; glycidyl resin derived from melamine; glycidyl amine; thioglycidyl resin; silicon-glycidyl resin; fluorine glycidyl resin; epoxy resin which is synthesized from monoepoxy other than epihalohydrin including an epoxy resin derived from unsaturated monoepoxy; epoxy resin derived from monoepoxy alcohol; epoxy resin derived from monoepoxy by ester interchange; epoxy resin derived from glycidaldehyde; polyglycidyl compound containing unsaturation; epoxy resin which is synthesized from olefin and chloroacetyl; or an epoxy-resin adduct of the above, or combinations thereof;
wherein m and n of Formula X^{I}, independently, is from about 7 to about 150.

12. A blend of vinyl ester resins, comprising:
a vinyl ester toughener of claim 4, and a vinyl ester epoxy;
said vinyl ester epoxy being the reaction product of at least one epoxy resin and a monounsaturated carboxylic acid wherein said monounsaturated carboxylic acid is acrylic acid, methacrylic acid, crotonic acid, cinnamic acid, or combinations thereof;
wherein the amount of said vinyl ester toughener is from about 1 to about 20 parts by weight per 100 parts by weight of said vinyl ester epoxy;
and wherein each said epoxy resin, independently, is 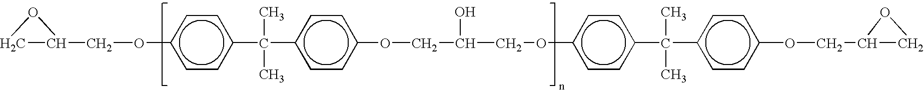
wherein n is an integer from 0 or from about 0.1 to about 18, or; 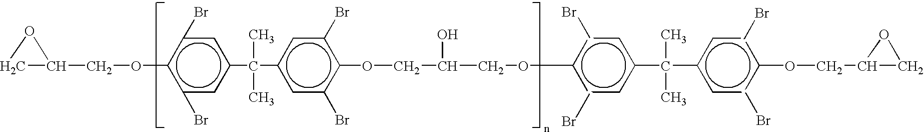
wherein n is from 0 or about 0.1 to about 18, or 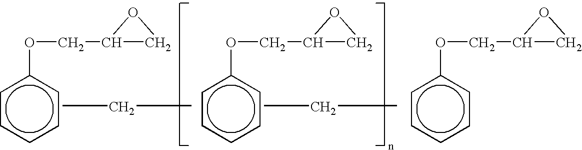
wherein n is from about 0 or about 0.1 to about 8; or 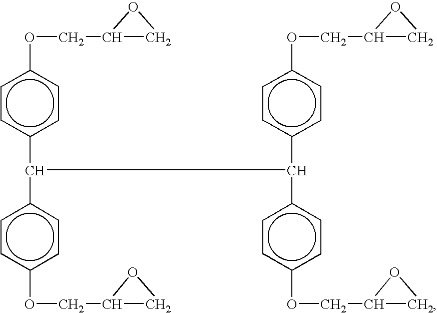
or combinations thereof.

13. A blend of vinyl ester resins, comprising:
a vinyl ester toughener of claim 5, and a vinyl ester epoxy;
said vinyl ester epoxy being the reaction product of at least one epoxy resin and a monounsaturated carboxylic acid wherein said monounsaturated carboxylic acid is acrylic acid, methacrylic acid, crotonic acid, cinnamic acid, or combinations thereof;
wherein the amount of said vinyl ester toughener is from about 1 to about 20 parts by weight per 100 parts by weight of said vinyl ester epoxy;
and wherein each said epoxy resin, independently, is 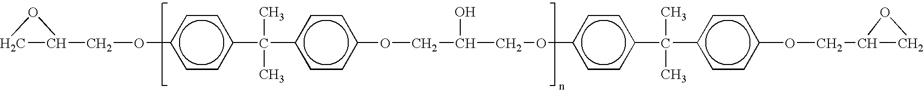
wherein n is an integer from 0 or about 0.1 to about 1.5.

14. A blend of vinyl ester resins, comprising:
a vinyl ester toughener of claim 6, and a vinyl ester epoxy;
said vinyl ester epoxy being the reaction product of at least one epoxy resin and a monounsaturated carboxylic acid wherein said monounsaturated carboxylic acid is acrylic acid, methacrylic acid, crotonic acid, cinnamic acid, or combinations thereof;
wherein the amount of said vinyl ester toughener is from about 2 to about 15 parts by weight per 100 parts by weight of said vinyl ester epoxy;
and wherein each said epoxy resin, independently, is 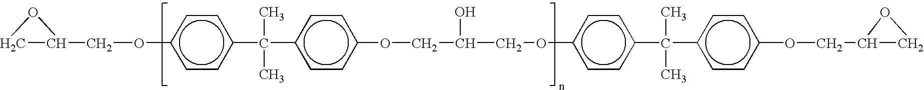
wherein n is an integer from 0 or about 0.1 to about 1.5.

15. A blend of vinyl ester resins, comprising:
a vinyl ester toughener of claim 8, and a vinyl ester epoxy;
said vinyl ester epoxy being the reaction product of at least one epoxy resin and a monounsaturated carboxylic acid wherein said monounsaturated carboxylic acid is acrylic acid, methacrylic acid, crotonic acid, cinnamic acid, or combinations thereof;
wherein the amount of said vinyl ester toughener is from about 2 to about 15 parts by weight per 100 parts by weight of said vinyl ester epoxy;
and wherein said each epoxy resin, independently, is 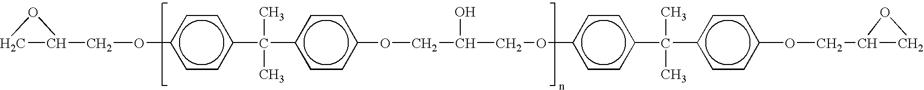
wherein n is an integer from 0 or about 0.1 to about 1.5.

16. The crosslinked composition of claim 10, including a diluent therein, and optionally including a toughener which is miscible before cure;
said diluent comprising an unsaturated organic solvent.

17. The crosslinked composition of claim 12, including a diluent, and including a toughener which is miscible before cure;
wherein the amount of said miscible toughener is from about 2 to about 50 parts by weight per 100 parts by weight of said vinyl ester resins said diluent comprising an unsaturated organic solvent having from 5 to about 15 carbon atoms;
wherein said miscible toughener has the formula 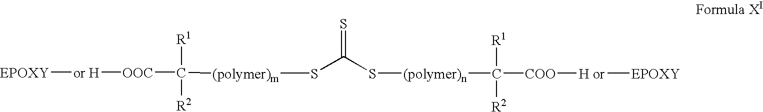
wherein R¹ and R², independently, are an alkyl having 1 to about 6 carbon atoms, an alkyl having from 1 to 6 carbons atoms and 1 or more substituents, at least one aryl, or at least one substituted aryl having from 1 to about 6 substituents on the aryl ring, and wherein said one or more substituents, independently, comprises an alkyl having from 1 to 6 carbon atoms, or an aryl, or a halogen group, or a cyano group, or an ether having a total of from 2 to about 20 carbon atoms, or a nitro group, or combinations thereof,
wherein m and n, independently, is from about 5 to about 1,000,
wherein each said (polymer), independently, comprises a polyacrylate or a polymethacrylate derived from an alkyl acrylate or alkyl methacrylate monomer wherein said alkyl has from 1 to about 18 carbon atoms, a polymer derived from a vinyl substituted aromatic monomer containing from 8 to about 12 carbon atoms, a polymer derived from a conjugated diene monomer containing from 4 to about 12 carbon atoms, a polymer derived from acrylonitrile, or combinations thereof; or
a toughener polymer or copolymer having the formula 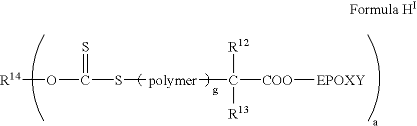
wherein R¹² and R¹³, independently, can be the same or different, can be a linear or branched alkyl having from 1 to about 12 carbon atoms; or an aryl group having from 6 to about 18 carbon atoms, optionally containing heteroatoms; or R¹² and R¹³ can form or be a part of a substituted or unsubstituted cyclic ring having from 3 to about 12 carbon atoms;
wherein R¹⁴ is optionally substituted, and can be a linear or branched alkyl having from 1 to about 12 carbon atoms, an aryl group optionally saturated or unsaturated; an arylalkyl having from about 7 to about 18 carbon atoms; an acyl group; an alkene group; an alkenealkyl having from 3 to about 18 carbon atoms; an alkylene group; an alkoxyalkyl; derived from a polyalkylene glycol; derived from a polyalkylene glycol monoalkyl ether having from about 3 to about 200 carbon atoms; derived from a polyalkylene glycol monoaryl ether having from about 3 to about 200 carbon atoms, a polyfluoroalkyl; a phosphorous containing alkyl; or a substituted or unsubstituted aryl ring containing heteroatoms;
wherein the (polymer) is derived from at least one conjugated diene monomer, or a vinyl containing monomer or combinations thereof, with the proviso that each polymer repeat unit can be the same or different;
wherein said g is from about 1 to about 10,000; and
wherein said “a” is 1 to about 4; or
said toughener polymer or copolymer being a dithiocarbamate having the formula: 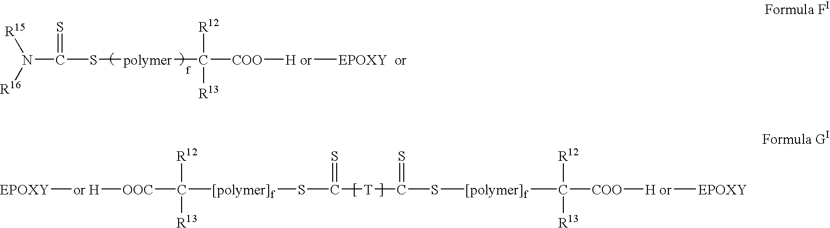
wherein each R¹² and R¹³, independently, is the same or different, is optionally substituted, and is a linear or branched alkyl having from 1 to about 12 carbon atoms; or an aryl group having from 6 to about 18 carbon atoms, optionally containing heteroatoms; or R¹² and R¹³ can form and be part of a substituted or unsubstituted cyclic ring having from 3 to about 12 carbon atoms;
wherein R¹⁵ and R¹⁶, independently, is the same or different, optionally substituted, optionally contains heteroatoms, and is hydrogen; or a linear or branched alkyl having from 1 to about 18 carbons; or an aryl group having from 6 to about 18 carbon atoms, optionally saturated or unsaturated; or an arylalkyl having from 7 to about 18 carbons; or an alkenealkyl having from 3 to about 18 carbon atoms; or derived from polyalkylene glycol ether; or derived from an amine; or R¹⁵ and R¹⁶ are in the form of a substituted or unsubstituted cyclic ring with the nitrogen atom having a total of 4 to about 12 carbon atoms;
wherein T is a divalent radical having a nitrogen atom directly connected to each carbon atom of the two thiocarbonyl groups;
wherein said (polymer) repeat units are derived from at least one conjugated diene monomer, or a vinyl containing monomer, or combinations thereof, with the proviso that each repeat unit can be the same or different; and
wherein the number of said repeat units f, independently, is from 1 to about 10,000.

18. The crosslinked composition of claim 14, including a diluent therein and including a toughener which is miscible before cure;
said diluent comprising an unsaturated organic solvent having from 5 to about 15 carbon atoms,
wherein said miscible toughener has the formula 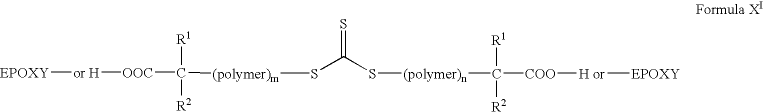
wherein R¹ and R², independently, are an alkyl having 1 to about 6 carbon atoms, an alkyl having from 1 to 6 carbons atoms and 1 or more substituents, at least one aryl, or at least one substituted aryl having from 1 to about 6 substituents on the aryl ring, and wherein said one or more substituents, independently, comprises an alkyl having from 1 to 6 carbon atoms, or an aryl, or a halogen group, or a cyano group, or an ether having a total of from 2 to about 20 carbon atoms, or a nitro group, or combinations thereof,
wherein m and n, independently, is from about 5 to about 500,
wherein each said (polymer), independently, comprises a polyacrylate or a polymethacrylate derived from an alkyl acrylate or alkyl methacrylate monomer wherein said alkyl is ethyl, butyl, or combinations thereof; or
a toughener polymer or copolymer having the formula 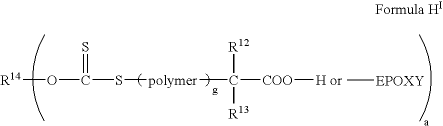
wherein R¹² and R¹³, independently, can be the same or different, can be a linear or branched alkyl having from 1 to about 12 carbon atoms; or an aryl group having from 6 to about 18 carbon atoms, optionally containing heteroatoms; or R¹² and R¹³ can form or be a part of a substituted or unsubstituted cyclic ring having from 3 to about 12 carbon atoms;
wherein R¹⁴ is optionally substituted, and can be a linear or branched alkyl having from 1 to about 12 carbon atoms, an aryl group optionally saturated or unsaturated; an arylalkyl having from about 7 to about 18 carbon atoms; an acyl group; an alkene group; an alkenealkyl having from 3 to about 18 carbon atoms; an alkylene group; an alkoxyalkyl; derived from a polyalkylene glycol; derived from a polyalkylene glycol monoalkyl ether having from about 3 to about 200 carbon atoms; derived from a polyalkylene glycol monoaryl ether having from about 3 to about 200 carbon atoms, a polyfluoroalkyl; a phosphorous containing alkyl; or a substituted or unsubstituted aryl ring containing heteroatoms;
wherein said g is from about 1 to about 10,000; and
wherein said “a” is 1 to about 4; or
said toughener polymer or copolymer being a a dithiocarbamate having the formula: 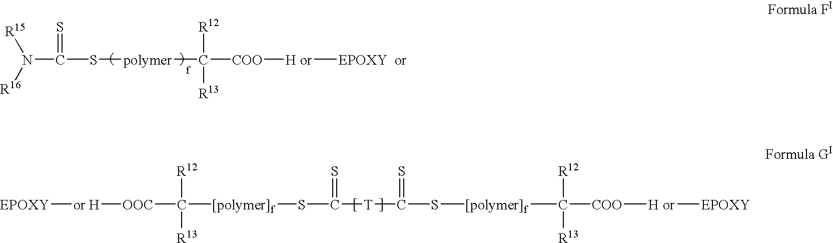
wherein each R¹² and R¹³, independently, is the same or different, is optionally substituted, and is a linear or branched alkyl having from 1 to about 12 carbon atoms; or an aryl group having from 6 to about 18 carbon atoms, optionally containing heteroatoms; or R¹² and R¹³ can form and be part of a substituted or unsubstituted cyclic ring having from 3 to about 12 carbon atoms;
wherein R¹⁵ and R¹⁶, independently, is the same or different, optionally substituted, optionally contains heteroatoms, and is hydrogen; or a linear or branched alkyl having from 1 to about 18 carbons; or an aryl group having from 6 to about 18 carbon atoms, optionally saturated or unsaturated; or an arylalkyl having from 7 to about 18 carbons; or an alkenealkyl having from 3 to about 18 carbon atoms; or derived from polyalkylene glycol ether; or derived from an amine; or R¹⁵ and R¹⁶ are in the form of a substituted or unsubstituted cyclic ring with the nitrogen atom having a total of 4 to about 12 carbon atoms;
wherein T is a divalent radical having a nitrogen atom directly connected to each carbon atom of the two thiocarbonyl groups;
wherein the number of said repeat units f, independently, is from 1 to about 10,000;
wherein said (polymer) of said Formulas H^{I}, F^{I} and G^{I}, independently, is a polyacrylate derived from an alkyl acrylate or alkyl methacrylate monomer wherein said alkyl is ethyl acrylate, butyl acrylate, or ethyl-hexyl acrylate, or combinations thereof; and
wherein said EPOXY of said miscible toughener of said Formulas H^{I}, F^{I} and G^{I}, independently, is derived from a: polyhydric phenol polyether alcohol; glycidyl ether of a novolac resin; phenolic novolac epoxy, tetraphenylolethane epoxy, glycidyl ether of mononuclear di- and trihydric phenol; glycidyl ether of bisphenol; glycidyl ether of polynuclear phenol; epoxy resin derived from diphenolic acid; glycidyl ether of aliphatic polyol; glycidyl ester; glycidyl epoxy containing nitrogen; glycidyl derivative of cyanuric acid; glycidyl resin derived from melamine; glycidyl amine; thioglycidyl resin; silicon-glycidyl resin; fluorine glycidyl resin; epoxy resin which is synthesized from monoepoxy other than epihalohydrin including an epoxy resin derived from unsaturated monoepoxy; epoxy resin derived from monoepoxy alcohol; epoxy resin derived from monoepoxy by ester interchange; epoxy resin derived from glycidaldehyde; polyglycidyl compound containing unsaturation; epoxy resin which is synthesized from olefin and chloroacetyl; or an epoxy-resin adduct of the above, or combinations thereof;
wherein said unsaturated acid is acrylic acid, methacrylic acid, crotonic acid, cinnamic acid, or combinations thereof;
wherein the amount of said miscible toughener is from about 2 to about 25 parts by weight per 100 parts by weight of said vinyl ester resins; and
wherein said miscible tougher exists as a discontinuous phase within said crosslinked composition.

19. The crosslinked composition of claim 16, including a diluent therein and including a toughener which is miscible before cure;
said diluent comprising styrene, α-methylstyrene, or methacrylate, or an acrylate, or combinations thereof;
wherein said miscible toughener has the formula 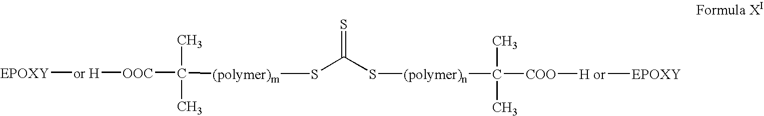
wherein m and n, independently, is from about 5 to about 200,
wherein each said (polymer), independently, comprises a polyacrylate or a polymethacrylate derived from an alkyl acrylate or alkyl methacrylate monomer wherein said alkyl is ethyl, butyl, or combinations thereof; or
a toughener polymer or copolymer having the formula 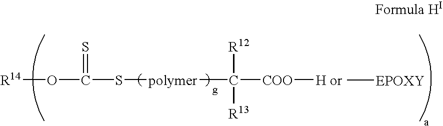
wherein R¹² and R¹³, independently, can be the same or different, can be a linear or branched alkyl having from 1 to about 12 carbon atoms; or an aryl group having from 6 to about 18 carbon atoms, optionally containing heteroatoms; or R¹² and R¹³ can form or be a part of a substituted or unsubstituted cyclic ring having from 3 to about 12 carbon atoms;
wherein R¹⁴ is optionally substituted, and can be a linear or branched alkyl having from 1 to about 12 carbon atoms, an aryl group optionally saturated or unsaturated; an arylalkyl having from about 7 to about 18 carbon atoms; an acyl group; an alkene group; an alkenealkyl having from 3 to about 18 carbon atoms; an alkylene group; an alkoxyalkyl; derived from a polyalkylene glycol; derived from a polyalkylene glycol monoalkyl ether having from about 3 to about 200 carbon atoms; derived from a polyalkylene glycol monoaryl ether having from about 3 to about 200 carbon atoms, a polyfluoroalkyl; a phosphorous containing alkyl; or a substituted or unsubstituted aryl ring containing heteroatoms;
wherein said g is from about 1 to about 10,000; and
wherein said “a” is 1 to about 4;
wherein, independently, each said (polymer) repeat unit of Formula H^{I} is derived from an alkyl acrylate, vinyl acetate, acrylic acid, styrene, N-vinyl pyrrolidone, or a combination thereof, or
said toughener polymer or copolymer being a dithiocarbamate having the formula: 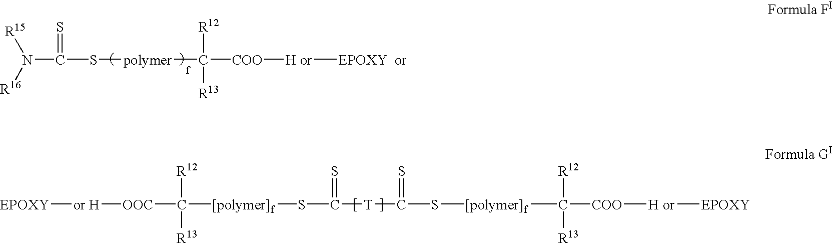
wherein each R¹² and R¹³, independently, is the same or different, is optionally substituted, and is a linear or branched alkyl having from 1 to about 12 carbon atoms; or an aryl group having from 6 to about 18 carbon atoms, optionally containing heteroatoms; or R¹² and R¹³ can form and be part of a substituted or unsubstituted cyclic ring having from 3 to about 12 carbon atoms;
wherein R¹⁵ and R¹⁶, independently, is the same or different, optionally substituted, optionally contains heteroatoms, and is hydrogen; or a linear or branched alkyl having from 1 to about 18 carbons; or an aryl group having from 6 to about 18 carbon atoms, optionally saturated or unsaturated; or an arylalkyl having from 7 to about 18 carbons; or an alkenealkyl having from 3 to about 18 carbon atoms; or derived from polyalkylene glycol ether; or derived from an amine; or R¹⁵ and R¹⁶are in the form of a substituted or unsubstituted cyclic ring with the nitrogen atom having a total of 4 to about 12 carbon atoms;
wherein T is a divalent radical having a nitrogen atom directly connected to each carbon atom of the two thiocarbonyl groups;
wherein the number of said repeat units, independently, is from about 3 to about 5,000;
wherein, independently, each said (polymer) repeat unit of Formulas F^{I} and G^{I} is derived from an alkyl acrylate, vinyl acetate, acrylic acid, styrene, N-vinyl pyrrolidone, or a combination thereof; and
wherein the amount of said miscible toughener is from about 4 to about 10 parts by weight per 100 parts by weight of said vinyl ester resins;
wherein said unsaturated acid is acrylic acid, methacrylic acid, cinnamic acid, crotonic acid, or combinations thereof;
wherein each said EPOXY, independently, of said miscible toughener is 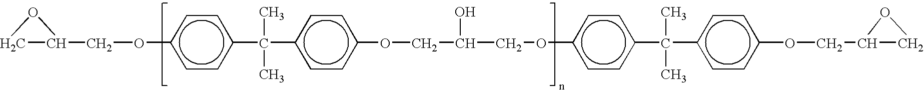
wherein n is an integer from 0 or about 0.1 to about 18, or; 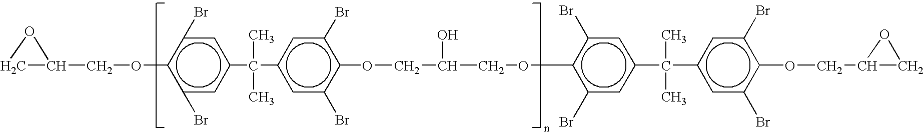
wherein n is from 0 or 0.1 to about 18, or 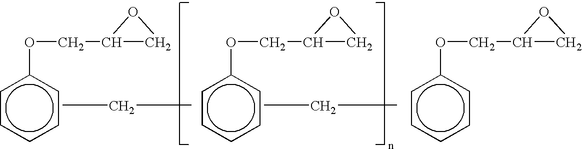
wherein n is from about 0.0 to about 8; or 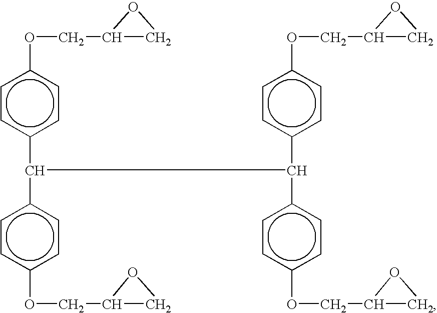
or combinations thereof; and
wherein said miscible toughener exists as a discontinuous phase in said crosslinked composition.

20. The composition of claim 16, which has a shelf stability life of at least two months before cure.

21. The composition of claim 17, which has a shelf stability life of at least two months before cure.

22. The composition of claim 17, which has a shelf stability life of at least four months before cure.

23. The composition of claim 18, which has a shelf stability life of at least four months before cure.

24. The composition of claim 18, which has a self stability life of at least six months before cure.

25. The composition of claim 19, which as a self stability life of at least six months before cure.

26. A composition comprising:
a blend of a thermosettable resin and a toughener polymer or copolymer;
said thermosettable resin being the reaction product of a polyepoxide having an average of more than one epoxide group per molecule with an unsaturated monocarboxylic acid, or an epoxidized polydiene rubber polymer or copolymer with an unsaturated monocarboxylic acid,
said toughener polymer having the formula 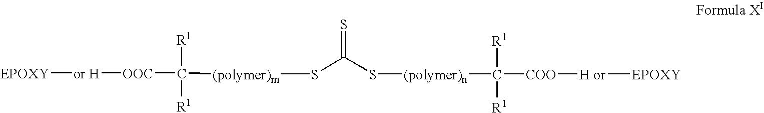
wherein R¹ and R², independently, are an alkyl having 1 to about 6 carbon atoms, an alkyl having from 1 to 6 carbons atoms and 1 or more substituents, at least one aryl, or at least one substituted aryl having from 1 to about 6 substituents on the aryl ring, and wherein said one or more substituents, independently, comprises an alkyl having from 1 to 6 carbon atoms, or an aryl, or a halogen group, or a cyano group, or an ether having a total of from 2 to about 20 carbon atoms, or a nitro group, or combinations thereof,
wherein m and n, independently, is a repeat unit of from about 5 to about 1,000;
wherein each said (polymer), independently, comprises a polyacrylate or polymethacrylate derived from an alkyl acrylate or alkyl methacrylate monomer wherein said alkyl has from 1 to about 18 carbon atoms, a polymer derived from a vinyl substituted aromatic monomer containing from 8 to about 12 carbon atoms, a polymer derived from a conjugated diene monomer containing from 4 to about 12 carbon atoms, a polymer derived from acrylonitrile, or combinations thereof, or
said toughener polymer having the formula 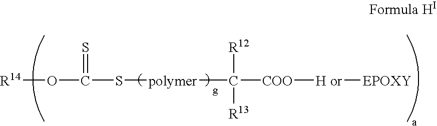
wherein R¹² and R¹³, independently, can be the same or different, can be a linear or branched alkyl having from 1 to about 12 carbon atoms; or an aryl group having from 6 to about 18 carbon atoms, optionally containing heteroatoms; or R¹² and R¹³ can form or be a part of a substituted or unsubstituted cyclic ring having from 3 to about 12 carbon atoms;
wherein R¹⁴ is optionally substituted, and can be a linear or branched alkyl having from 1 to about 12 carbon atoms, an aryl group optionally saturated or unsaturated; an arylalkyl having from about 7 to about 18 carbon atoms; an acyl group; an alkene group; an alkenealkyl having from 3 to about 18 carbon atoms; an alkylene group; an alkoxyalkyl; derived from a polyalkylene glycol; derived from a polyalkylene glycol monoalkyl ether having from about 3 to about 200 carbon atoms; derived from a polyalkylene glycol monoaryl ether having from about 3 to about 200 carbon atoms, a polyfluoroalkyl; a phosphorous containing alkyl; or a substituted or unsubstituted aryl ring containing heteroatoms;
wherein said (polymer) is derived from at least one conjugated diene monomer, or a vinyl containing monomer or combinations thereof, with the proviso that each polymer repeat unit can be the same or different;
wherein said g is from about 1 to about 10,000; and
wherein said “a” is 1 to about 4; or said toughener polymer or copolymer being a dithiocarbamate having the formula: 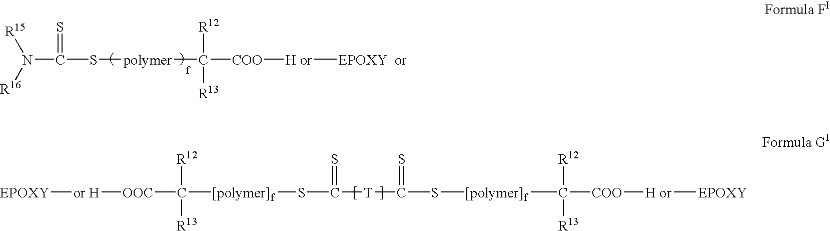
wherein each R¹² and R¹³, independently, is the same or different, is optionally substituted, and is a linear or branched alkyl having from 1 to about 12 carbon atoms; or an aryl group having from 6 to about 18 carbon atoms, optionally containing heteroatoms; or R¹² and R¹³ can form and be part of a substituted or unsubstituted cyclic ring having from 3 to about 12 carbon atoms;
wherein R¹⁵ and R¹⁶, independently, is the same or different, optionally substituted, optionally contains heteroatoms, and is hydrogen; or a linear or branched alkyl having from 1 to about 18 carbons; or an aryl group having from 6 to about 18 carbon atoms, optionally saturated or unsaturated; or an arylalkyl having from 7 to about 18 carbons; or an alkenealkyl having from 3 to about 18 carbon atoms; or derived from polyalkylene glycol ether; or derived from an amine; or R¹⁵ and R¹⁶ are in the form of a substituted or unsubstituted cyclic ring with the nitrogen atom having a total of 4 to about 12 carbon atoms;
wherein T is a divalent radical having a nitrogen atom directly connected to each carbon atom of the two thiocarbonyl groups;
wherein said (polymer) repeat units are derived from at least one conjugated diene monomer, or a vinyl containing monomer, or combinations thereof, with the proviso that each repeat unit can be the same or different; and
wherein the number of said repeat units f, independently, is from 1 to about 10,000.

27. A composition according to claim 26,
wherein in said thermosettable resin said polydiene rubber polymer is derived from a conjugated diene monomer having from 4 to about 12 carbon atoms, and wherein said polydiene rubber copolymer is derived from a conjugated diene having from 4 to 12 carbon atoms and acrylonitrile,
wherein said Formula H^{I} conjugated diene monomer has from 4 to 12 carbon atoms, and wherein said vinyl containing monomer has the formula: 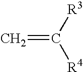
wherein R³ comprises hydrogen, halogen, C₁-C₄ alkyl, or substituted C₁-C₄ alkyl wherein said substituents, independently, comprise one or more hydroxy, alkoxy, aryloxy(OR⁵), carboxy, acyloxy, aroyloxy(O₂CR⁵), alkoxy-carbonyl(CO₂R⁵), or aryloxy-carbonyl; N-pyrrolidonyl;
wherein R⁴ comprises hydrogen, R⁵, CO₂H, CO₂R⁵, COR⁵, CN, CONH₂, CONHR⁵, O₂CR⁵, OR⁵ or halogen; and
wherein R⁵ comprises C₁-C₁₈ alkyl, substituted C₁-C₁₈ alkyl, C₂-C₁₈ alkenyl, aryl, heterocyclyl, aralkyl, or alkaryl, and wherein said substituents, independently, comprise one or more epoxy, hydroxy, alkoxy, acyl, acyloxy, carboxy, (and salts), sulfonic acid (and salts), alkoxy- or aryloxy-carbonyl, dicyanato, cyano, silyl, halo or dialkylamino, and
wherein g is from about 3 to about 5,000; or
wherein in said Formula F^{I} and G^{I}, toughener polymer or copolymer f is from about 3 to about 5,000;
wherein T is: 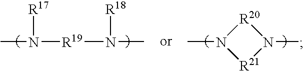
wherein R¹⁷ and R¹⁸, independently, is the same or different, is optionally substituted, and is hydrogen; or a linear or branched alkyl having from 1 to about 18 carbon atoms; or an aryl group having from about 6 to about 18 carbon atoms; or an arylalkyl having from 7 to about 18 carbon atoms; or a alkenealkyl having from 3 to about 18 carbon atoms; wherein R¹⁹ is optionally substituted, or is non-existent; or an alkylene group having from 1 to about 18 carbon atoms; or derived from a polyalkylene glycol either having from 3 to about 200 carbon atoms; wherein R²⁰ and R²¹, independently, is the same or different, and is optionally substituted, and is an alkylene group having from 1 to about 4 carbon atoms, or
wherein T is: 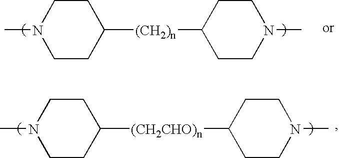
wherein n is 0 to about 18.

28. A composition according to claim 27, wherein in said thermosettable resin said diene rubber polymer or copolymer, independently, is derived from butadiene, isoprene, piperylene, methyl pentadiene, or dimethyl-hexyladiene, or combinations thereof, and wherein each said monounsaturated acid, independently, is acrylic acid, methacrylic acid, crotonic acid, cinnamic acid or combinations thereof; and
wherein each said EPOXY, independently, of said toughener is derived from a: polyhydric phenol polyether alcohol; glycidyl ether of a novolac resin; phenolic novolac epoxy, tetraphenylolethane epoxy, glycidyl ether of mononuclear di- and trihydric phenol; glycidyl ether of bisphenol; glycidyl ether of polynuclear phenol; epoxy resin derived from diphenolic acid; glycidyl ether of aliphatic polyol; glycidyl ester; glycidyl epoxy containing nitrogen; glycidyl derivative of cyanuric acid; glycidyl resin derived from melamine; glycidyl amine; thioglycidyl resin; silicon-glycidyl resin; fluorine glycidyl resin; epoxy resin which is synthesized from monoepoxy other than epihalohydrin including an epoxy resin derived from unsaturated monoepoxy; epoxy resin derived from monoepoxy alcohol; epoxy resin derived from monoepoxy by ester interchange; epoxy resin derived from glycidaldehyde; polyglycidyl compound containing unsaturation; epoxy resin which is synthesized from olefin and chloroacetyl; or an epoxy-resin adduct of the above, or combinations thereof;
and wherein m and n, independently, of Formula X^{I} is from about 70 to about 150, and wherein R¹ and R² are methyl.

29. A composition according to claim 28,
wherein in said thermosettable resin said diene polymer is derived from butadiene and said diene copolymer is derived from butadiene and acrylonitrile, wherein each said unsaturated acid, independently, is acrylic acid or methacrylic acid,
wherein each said (polymer), independently, of Formula X^{I} is said polyacrylate and said polyacrylate is derived from ethyl acrylate, butyl acrylate, or ethyl-hexyl acrylate, or combinations thereof;
wherein, independently, each said polymer repeat unit, independently, of Formula H^{I} is derived from alkyl acrylate, vinyl acetate, acrylic acid, styrene, N-vinyl pyrrolidone, or a combination thereof, or
wherein R¹² and R¹³, independently, are an alkyl having from 1 to about 4 carbon atoms, or are part of a cyclic ring, and
wherein “a” is 2, and wherein R¹² and R¹³, independently, are a phenyl group or alkyl group having 1 to about 10 carbon atoms, or R¹² and R¹³ are part of a cyclic ring; or
wherein, independently, each said polymer of Formulas F^{I} or G^{I} is derived from an alkyl acrylate, vinyl acetate, acrylic acid, styrene, N-vinyl pyrrolidone, or a combination thereof.

30. A composition according to claim 29, wherein said polyepoxy of said thermosettable resin is said glycidyl polyether of a polyhydric alcohol or a polyhydric phenol having an equivalent weight per epoxide group of from about 150 to about 1,500;
and wherein each said EPOXY, independently, of said toughener is derived from 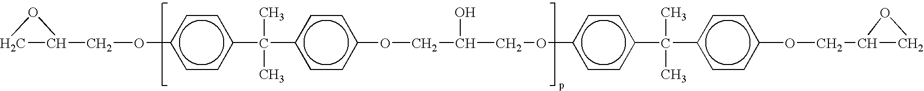
wherein p is from 0.1 to about 1.5, and
wherein the number of said terminal EPOXY groups is from about 1 to about 2.

31. A composition according to claim 26, including a diluent, and wherein said diluent is an organic solvent.

32. A composition according to claim 28, including a diluent, and wherein said diluent is an organic solvent.

33. A composition according to claim 30, including a diluent, and wherein said diluent is styrene, vinyl toluene, acrylic or methacrylic ester.

34. The composition of claim 26, which is crosslinked.

35. The composition of claim 31, which is crosslinked.

36. The composition of claim 32, which is crosslinked.

37. The composition of claim 33, which is crosslinked.
